(19) United States
(12) Patent Application Publication
(10) Pub. No.: US 2020/0283702 A1
(43) Pub. Date: Sep. 10, 2020

(54) CLEANING COMPOSITIONS CONTAINING DISPERSINS I

(71) Applicant: Henkel AG & Co. KGaA, Duesseldorf (DE)

(72) Inventors: Susanne WIELAND, Dormagen/Zons (DE); Stefan KARSTEN, Gummersbach (DE); Thomas WEBER, Weimar (Lahn) (DE); Regina STEHR, Neuss (DE); Marianne SCHMELING, Korschenbroich (DE); Michael DREJA, Neuss (DE); Mirko WEIDE, Duesseldorf (DE); Christian OEHLENSCHLAEGER, Valby (DK); Dorotea Raventos SEGURA, Rungsted (DK); Rebecca VEJBORG, Alleroed (DK); Henrik GEERTZ-HANSEN, Copenhagen (DK); Lilian BALTSEN, Bagsvaerd (DK); Jesper SALOMON, Holte (DK)

(21) Appl. No.: 16/760,444

(22) PCT Filed: Oct. 31, 2018
(86) PCT No.: PCT/EP2018/079836

§ 371 Date: Apr. 30, 2020

(30) Foreign Application Priority Data
Nov. 1, 2017 (DE) 10 2017 125 558.3

(51) Int. Cl. C11D 3/386; C11D 3/12; C11D 3/36; C11D 3/08; C11D 3/395; C11D 7/50; C11D 17/04; C11D 3/00; C11D 3/37; C11D 3/50; C11D 3/30; C11D 3/20; C11D 1/94; C11D 3/48; C11D 11/00; C11D 3/33; C11D 3/38; C11D 3/22

(52) U.S. Cl. CPC C11D 3/38636; C11D 3/225; C11D 3/361; C11D 3/08; C11D 3/3951; C11D 7/5004; C11D 17/041; C11D 3/0005; C11D 3/001; C11D 3/373; C11D 3/50; C11D 3/3723; C11D 3/30; C11D 3/2082; C11D 1/94; C11D 3/48; C11D 11/0023; C11D 3/33; C11D 3/3757; C11D 3/381; C11D 11/0017; C11D 3/128

(57) ABSTRACT

Cleaning compositions may include polypeptides having hexosaminidase activity. The cleaning compositions may include a polypeptide having one or more of the motif(s) GXDE (SEQ ID NO 27), [EQ][NRSHA][YVFL][AGSTC][IVLF][EAQYN][SN] (SEQ ID NO: 28), HFHIGG (SEQ ID NO: 29), FLHLHF (SEQ ID NO: 30) or DHENYA (SEQ ID NO: 31), or combinations thereof. The cleaning compositions may be or include laundry detergents, fabric finishers, acidic cleaning agents, neutral cleaning agents, alkaline cleaning agents, hand dishwashing agents, automatic dishwasher compositions, or combinations thereof.

### CROSS-REFERENCE TO RELATED APPLICATIONS

The present application is a national stage entry according to 35 U.S.C. § 371 of PCT application No.: PCT/EP2018/079836 filed on Oct. 31, 2018; which claims priority to German Patent Application Serial No.: 10 2017 125 558.3, which was filed on Nov. 1, 2017; which are incorporated herein by reference in their entirety and for all purposes.

### REFERENCE TO A SEQUENCE LISTING SUBMITTED VIA EFS-WEB

The content of the ASCII text file of the sequence listing named “P77367US_seq_ST25”, which is 97 kb in size was created on Oct. 29, 2018 and electronically submitted via EFS-Web herewith the application is incorporated by reference in its entirety.

### TECHNICAL FIELD

The present disclosure relates to specific cleaning compositions comprising polypeptides having hexosaminidase activity. The disclosure further relates to the use of said compositions as well as methods of using said compositions.

### BACKGROUND

Polypeptides having hexosaminidase activity include Dispersins such as Dispersin B (DspB) which is β-N-acetylglucosamininidases belonging to the Glycoside Hydrolase 20 family. Dispersins are produced by the periodontal pathogen, Aggregatibacter actinomycetemcomitans, a Gram-negative oral bacterium. Dispersin B is a β-hexosaminidase that specifically hydrolyzes β-1,6-glycosidic linkages of acetylglucosamine polymers found in biofilm. Dispersin B contains three highly conserved acidic residues: an aspartic acid at residue 183 (D183), a glutamic acid at residue 184 (E184), and a glutamic acid at residue 332 (E332). Biofilm have been found attached to various surfaces including medical devices such as implants. WO04061117 A2 (Kane Biotech INC) describes use of compositions comprising DspB for reducing biofilm caused by poly-N-acetylglucosamine-producing bacteria and Kane et al. describe the use of compositions comprising DspB for reduction of biofilm on medical devises and for wound care. Biofilm may also be present on laundry items, such as fabrics, other hard surfaces, such as dish wash utensils, dish washers and washing machines where they may cause malodor, which is difficult to remove even after wash. Biofilm may also make laundry items sticky and soil may adhere to the sticky areas. The present disclosure provides compositions which comprise suitable enzymes as described herein for use in detergents and for deep cleaning in laundry and cleaning processes.

### SUMMARY

The present disclosure relates to cleaning compositions comprising one or more polypeptide(s) defined herein, uses and methods of use thereof, in particular as defined in the appended claims. The polypeptides used in the compositions have hexosaminidase activityand, as a result thereof, have beneficial properties such as deep cleaning effects. The polypeptides used belong to the DspB clade, which are sequences homologous to DspB.

The cleaning composition that contains the polypeptides defined herein
(a) is a solid, such as granular, laundry detergent composition and further comprises
   (a1) at least one zeolite builder, such as in an amount of 10 to 50 wt.-%, or 20-30 wt.-%;
   (a2) at least one phosphonate builder, such as in an amount of 0.1 to 5 wt.-%, or 0.4 to 1.5 wt.-%;
   (a3) at least one further enzyme, such as a cellulase, such as in an amount of active enzyme of 100 to 5000 ppb or from 1000 to 2000 ppb; and
   (a4) at least one polymer, such as a polyvinylpyrrolidon polymer, such as in an amount of 0.01 to 1 wt.-%, or from 0.1 to 0.3 wt.-%; or
(b) is a solid laundry detergent composition and further comprises
   (b1) at least one silicate builder, such as in an amount of 2 to 20 wt.-%, or from 5-10 wt.-%;
   (b2) optionally carboxymethylcellulose, such as in an amount of 0.1 to 10 wt.-%, or from 0.1 to 4 wt.-%;
   (b3) at least one further enzyme, such as a cellulase, such as in an amount of active enzyme of 0.1 to 100 ppm, or from 0.1 to 10 ppm;
   (b4) optionally at least one soil release polymer, such as a polyvinylpyrrolidon polymer, in an amount of 0.1 to 3 wt.-%, or from 0.1 to 1.0 wt.-%; and
   (b5) at least one bleaching system, comprising a bleaching agent, a bleach activator and a bleach catalyst, such as in an amount of 0.1 to 50 wt.-%, or from 0.1 to 30 wt.-%; or
(c) is liquid laundry detergent composition and further comprises
   (c1) at least one surfactant, such as nonionic surfactant, such as in an amount of 1 to 20 wt.-%, or from 3 to 15 wt.-%;
   (c2) optionally at least one phosphonate builder, such as in an amount of 0.1 to 3 wt.-%, or from 0.25 to 1.5 wt.-%
   (c3) optionally at least at least one further enzyme, such as a cellulase, such as in an amount of enzyme composition of 0.001 to 1 wt.-%, or from 0.001 to 0.6 wt.-%; and
   (c4) optionally at least one organic solvent, such as glycerol, such as in an amount of 0.1 to 10 wt.-%, or from 0.1 to 5 wt.-%; or
(d) is a liquid laundry detergent in unit dose form, such as a pouch comprising a water-soluble film, and further comprises
   (d1) water in an amount of up to 20 wt.-%, such as 5 to 15 wt.-%;
   (d2) optionally at least one bittering agent, such as Benzyldiethyl(2.6-xylylcarbamoyl)-nmethylammoniumbenzoate, such as in an amount of 0.00001 to 0.04 wt.-%;
   (d3) optionally at least one optical brightener, such as in an amount of 0.01 to 2 wt.-%, or from 0.01 to 1 wt.-%; and
   (d4) optionally at least one polymer, such as in an amount of 0.01 to 7 wt.-%, or from 0.1 to 5 wt.-%; or
(e) is a fabric finisher and further comprises
   (e1) at least one softening silicone, such as an amino-functionalized silicone, such as in an amount of 0.1 to 10 wt.-%, or from 0.1 to 2 wt.-%;
   (e2) at least one perfume, such as at least partially encapsulated in microcapsules, or at least partially encapsulated in melamine-formaldehyde microcapsules, such as in an amount of 0.01 to 3 wt.-%, or 0.1 to 1 wt.-%;
   (e3) optionally polyquaternium 10 in an amount of 0.1 to 20 wt.-%, such as 0.1 to 13 wt.-%;
   (e4) optionally polyquaternium 37 in an amount of 0.1 to 20 wt.-%, such as 0.1 to 13 wt.-%;
   (e5) optionally a plant-based esterquat, such as a canola- or palm-based esterquat, in an amount of 0.1 to 20 wt.-%, such as 0.1 to 13 wt.-%; and
   (e6) optionally adipic acid, in an amount of 0.1 to 20 wt.-%, such as 0.1 to 13 wt.-%; or
(f) is an acidic cleaning agent, such as having a pH less than 6, and further comprises
   (f1) plant-based or bio-based surfactants, such as each in an amount of 0.1 to 5, or each in an amount of 0.1 to 2 wt.-%;
   (f2) at least one acidic biocide, such as selected from acids, or HCl and formic acid; and
   (f3) at least one soil release, water repellant or water spreading polymer, such as in an amount of 0.01 to 3 wt.-%, or from 0.01 to 0.5 wt.-%; or
(g) is a neutral cleaning agent, such as having a pH between 6.0 and 7.5, and further comprises
   (g1) plant-based or bio-based surfactants, such as each in an amount of 0.1 to 5, or each in an amount of 0.1 to 2 wt.-%;
   (g2) at least one biocide, such as selected from quaternary ammonium compounds and alcohols; and
   (g3) at least one soil release, water repellant or water spreading polymer, such as in an amount of 0.01 to 3 wt.-%, or from 0.01 to 0.5 wt.-%; or
(h) is an alkaline cleaning agent, such as having a pH of more than 7.5, and further comprises
   (h1) plant-based or bio-based surfactants, such as each in an amount of 0.1 to 5, or each in an amount of 0.1 to 2 wt.-%; or
(i) is a hand dishwashing agent, such as liquid hand dishwashing agent, and further comprises
   (i1) at least one anionic surfactant, such as in an amount of 0.1 to 40 wt.-%, or from 5 to 30 wt.-%;
   (i2) at least one amphoteric surfactant, such as betain, such as in an amount of 0.1 to 25 wt.-%, or from 1 to 15 wt.-%;
   (i3) at least one nonionic surfactant, such as in an amount of 0.1 to 25 wt.-%, or from 2 to 10 wt.-%;
   (i4) at least one further enzyme, such as selected from proteases, amylases and combinations thereof, such as in an amount of enzyme composition of up to 1 wt.-%, or up to 0.6 wt.-%; or
(j) is an automatic dishwashing composition and further comprises
   (j1) at least one builder selected from citrate, aminocarboxylates and combinations thereof, such as in an amount of 5 to 30 wt.-%, or from 10 to 20 wt.-%;
   (j2) at least one phosphonate builder, such as in an amount of 0.1 to 5 wt.-%, or from 0.4 to 1.5 wt.-%;
   (j3) at least one nonionic surfactant, such as in an amount of 0.1 to 10 wt.-%, or 1 to 5 wt.-%;
   (j4) at least one bleaching system, comprising a bleaching agent, a bleach activator and a bleach catalyst, such as in an amount of 0.1 to 50 wt.-%, or from 0.1 to 30 wt.-%; and
   (j5) at least one polymer selected from sulfopolymers, cationic polymers and polyacrylates, such as in an amount of 0.01 to 15 wt.-%, or from 2 to 10 wt.-%; or
(k) further comprises
   (k1) at least one sulfopolymer, such as in an amount of 1 to 15, or from 2 to 10 wt.-% and is a dishwashing, or an automatic dishwashing composition; or
(l) further comprises at least one adjunct ingredient selected from probiotics, such as microbes, spores or combinations thereof; or
(m) is in unit dose form and comprises at least 2, such as 2, 3, 4 or 5 separate compartments; or
(n) is a phosphate-free composition.
   When in the following reference is made to “compositions of the invention” or “compositions as described herein”, the above-specified compositions (a)-(n) are meant. Furthermore, if not indicated otherwise, all references to percentages in relation to the disclosed compositions relate to wt % relative to the total weight of the respective composition. It is understood that when reference is made to compositions that contain a polypeptide as defined herein, the respective composition contains at least one of said polypeptides but can also comprise two or more of them.
   In various embodiments, the polypeptides having hexosaminidase activity can be selected from the group consisting of:
   (a) a polypeptide having at least 80% sequence identity to the mature polypeptide of SEQ ID NO: 2, 4, 6, 8, 10, 12 or 16;
   (b) a variant of the mature polypeptide of SEQ ID NO: 2, 4, 6, 8, 10, 12 or 16 comprising a substitution, deletion, and/or insertion at one or more (e.g., several) positions; and
   (c) a fragment of the polypeptide of (a) or (b) that has hexosaminidase activity.

Compositions, as defined above, may include polypeptides comprising a catalytic domain belonging to the Glycoside Hydrolase family 20 (GH20, www.cazy.org) and having at least 60% sequence identity to amino acids 23 to 381 of SEQ ID NO: 2; at least 60% sequence identity to amino acids 27 to 368 of SEQ ID NO: 4; at least 60% sequence identity to amino acids 27 to 378 of SEQ ID NO: 6; at least 60% sequence identity to amino acids 27 to 378 of SEQ ID NO: 8; at least 60% sequence identity to amino acids 27 to 378 of SEQ ID NO: 10; at least 60% sequence identity to amino acids 23 to 381 of SEQ ID NO: 12; at least 60% sequence identity to amino acids 23 to 381 of SEQ ID NO: 14 or at least 60% sequence identity to amino acids 27 to 377 of SEQ ID NO: 16.

The present composition also relates to cleaning methods using the compositions and to the use in cleaning processes.

The composition further relates to a cleaning or laundering method for cleaning or laundering an item comprising the steps of:

a. exposing an item to a wash liquor comprising a cleaning composition; b. Optionally completing at least one wash cycle; and c. Optionally rinsing the item, wherein the item is a textile or a hard surface.

The composition further relates to a cleaning composition comprising at least 0.0001 ppm polypeptide having hexosaminidase activity, wherein the polypeptide comprises one or more of the motif(s) GXDE (SEQ ID NO 27), [EQ][NRSHA][YVFL][AGSTC][IVLF][EAQYN][SN] (SEQ ID NO: 28), HFHIGG (SEQ ID NO: 29), FLHLHF(SEQ ID NO: 30) or DHENYA (SEQ ID NO: 31) as defined in the appended claims, use of the composition for deep-cleaning of an item, wherein the item is a textile or hard surface and a method for cleaning an item comprising the steps of:
a. Exposing an item to a wash liquor comprising a a detergent composition;
b. Optionally completing at least one wash/cleaning cycle; and
c. Optionally rinsing the item, wherein the item is a textile or a hard surface.
   A composition as defined herein may be used in a cleaning process, such as laundry and/or dish wash, for deep cleaning of an item, wherein the item is a textile or hard surface and use of said composition
(i) for preventing, reducing or removing stickiness of the item;
(ii) for pretreating stains on the item;
(iii) for preventing, reducing or removing redeposition of soil during a wash cycle;
(iv) for preventing, reducing or removing adherence of soil to the item;
(v) for maintaining or improving whiteness of the item; or
(vi) for preventing, reducing or removal malodor from the item, wherein the item is a textile.

### BRIEF DESCRIPTION OF THE FIGURES

In the following, the various embodiments described herein are explained in more detail in conjunction with the associated figures.

FIG. 1 Phylogenic tree showing the DspB clade

FIG. 2 shown an alignment of the polypeptides disclosed herein

FIG. 3 shows a phylogenetic tree of the HFH clade

### OVERVIEW OF SEQUENCES OF DSPB CLADE

SEQ ID NO: 1 is the DNA encoding the full-length polypeptide from Aggregatibacter actinomycetemcomitans
SEQ ID NO: 2 is the polypeptide derived from SEQ ID NO 1
SEQ ID NO: 3 is the DNA encoding the full-length polypeptide from SP Haemophilus sputorum
SEQ ID NO: 4 is the polypeptide derived from SEQ ID NO 3
SEQ ID NO: 5 is the DNA encoding the full-length polypeptide from Actinobacillus suis
SEQ ID NO: 6 is the polypeptide derived from SEQ ID NO 5
SEQ ID NO: 7 is the DNA encoding the full-length polypeptide from Actinobacillus capsulatus
SEQ ID NO: 8 is the polypeptide derived from SEQ ID NO 7
SEQ ID NO: 9 is the DNA encoding the full-length polypeptide from Actinobacillus equuli
SEQ ID NO: 10 is the polypeptide derived from SEQ ID NO 9
SEQ ID NO: 11 is the DNA encoding the full-length polypeptide from Aggregatibacter actinomycetemcomitans
SEQ ID NO: 12 is the polypeptide derived from SEQ ID NO 11
SEQ ID NO: 13 is the DNA encoding the full-length polypeptide from Aggregatibacter actinomycetemcomitans
SEQ ID NO: 14 is the polypeptide derived from SEQ ID NO 13
SEQ ID NO: 15 is the DNA encoding the full-length polypeptide from Actinobacillus pleuropneumoniae
SEQ ID NO: 16 is the polypeptide derived from SEQ ID NO 15
SEQ ID NO: 17 is the mature polypeptide of SEQ ID NO 2
SEQ ID NO: 18 is the mature polypeptide of SEQ ID NO 4
SEQ ID NO: 19 is the mature polypeptide of SEQ ID NO 6
SEQ ID NO: 20 is the mature polypeptide of SEQ ID NO 8
SEQ ID NO: 21 is the mature polypeptide of SEQ ID NO 10
SEQ ID NO: 22 is the mature polypeptide of SEQ ID NO 12
SEQ ID NO: 23 is the mature polypeptide of SEQ ID NO 14
SEQ ID NO: 24 is the mature polypeptide of SEQ ID NO 16
SEQ ID NO: 25 is the Bacillus clausii secretion signal
SEQ ID NO: 26 is a His-tag sequence

### SEQ ID NO: 27 GXDE

### SEQ ID NO: 28 [EQ][NRSHA][YVFL][AGSTC][IVLF][EAQYN][SN]

### SEQ ID NO: 29 HFHIGG

### SEQ ID NO: 30 FLHLHF

### SEQ ID NO: 31 DHENYA

### Definitions

Dispersin: The term “dispersin” and the abbreviation “Dsp” means a polypeptide having hexosaminidase activity, EC 3.2.1.—that catalyzes the hydrolysis of β-1,6-glycosidic linkages of N-acetyl-glucosamine polymers found e.g. in biofilm.

Hexosaminidase: The term “hexosaminidases” means a polypeptide having hexosaminidase activity (hexosaminidases), and includes EC 3.2.1.e.g. that catalyzes the hydrolysis of of N-acetyl-D-hexosamine or N-acetyl-glucosamine polymers found e.g. in biofilm. The term includes dispersins and includes polypeptides having N-acetylglucosaminidase activity and B-N-acetylglucosamininidase activity. The term “polypeptide having hexosaminidase activity” may be used interchangeably with the term hexosaminidases and similar the term “polypeptide having β-N-acetylglucosaminidase activity” may be used interchangeably with the term β-N-acetylglucosamininidases. For the purposes herein, hexosaminidase activity is determined according to the procedure described in Assay 1. In one aspect, the polypeptides used in the composition have at least 20%, e.g., at least 40%, at least 50%, at least 60%, at least 70%, at least 80%, at least 90%, at least 95%, or at least 100% of the hexosaminidase activity of the mature polypeptide of SEQ ID NO: 2. In one aspect, the polypeptides used in the compositions have at least 20%, e.g., at least 40%, at least 50%, at least 60%, at least 70%, at least 80%, at least 90%, at least 95%, or at least 100% of the hexosaminidase activity of the mature polypeptide of SEQ ID NO: 4. In one aspect, the polypeptides used in the compositions have at least 20%, e.g., at least 40%, at least 50%, at least 60%, at least 70%, at least 80%, at least 90%, at least 95%, or at least 100% of the hexosaminidase activity of the mature polypeptide of SEQ ID NO: 6. In one aspect, the polypeptides used in the compositions have at least 20%, e.g., at least 40%, at least 50%, at least 60%, at least 70%, at least 80%, at least 90%, at least 95%, or at least 100% of the hexosaminidase activity of the mature polypeptide of SEQ ID NO: 8. In one aspect, the polypeptides used in the compositions have at least 20%, e.g., at least 40%, at least 50%, at least 60%, at least 70%, at least 80%, at least 90%, at least 95%, or at least 100% of the hexosaminidase activity of the mature polypeptide of SEQ ID NO: 10. In one aspect, the polypeptides used in the compositions have at least 20%, e.g., at least 40%, at least 50%, at least 60%, at least 70%, at least 80%, at least 90%, at least 95%, or at least 100% of the hexosaminidase activity of the mature polypeptide of SEQ ID NO: 12. In one aspect, the polypeptides used in the compositions have at least 20%, e.g., at least 40%, at least 50%, at least 60%, at least 70%, at least 80%, at least 90%, at least 95%, or at least 100% of the hexosaminidase activity of the mature polypeptide of SEQ ID NO: 14. In one aspect, the polypeptides used in the compositions have at least 20%, e.g., at least 40%, at least 50%, at least 60%, at least 70%, at least 80%, at least 90%, at least 95%, or at least 100% of the hexosaminidase activity of the mature polypeptide of SEQ ID NO: 16.

Allelic variant: The term “allelic variant” means any of two or more alternative forms of a gene occupying the same chromosomal locus. Allelic variation arises naturally through mutation, and may result in polymorphism within populations. Gene mutations can be silent (no change in the encoded polypeptide) or may encode polypeptides having altered amino acid sequences. An allelic variant of a polypeptide is a polypeptide encoded by an allelic variant of a gene.

Biofilm: A biofilm may be produced by any group of microorganisms in which cells stick to each other or stick to a surface, such as a textile, dishware or hard surface or another kind of surface. These adherent cells are frequently embedded within a self-produced matrix of extracellular polymeric substance (EPS). Biofilm EPS is a polymeric conglomeration generally composed of extracellular DNA, proteins, and polysaccharides. Biofilms may form on living or non-living surfaces. The microbial cells growing in a biofilm are physiologically distinct from planktonic cells of the same organism, which, by contrast, are single-cells that may float or swim in a liquid medium. Bacteria living in a biofilm usually have significantly different properties from planktonic bacteria of the same species, as the dense and protected environment of the film allows them to cooperate and interact in various ways. One benefit of this environment for the microorganisms is increased resistance to detergents and antibiotics, as the dense extracellular matrix and the outer layer of cells protect the interior of the community. On laundry and hard surfaces biofilm producing bacteria can be found among the following species: Acinetobacter sp., Aeromicrobium sp., Brevundimonas sp., Microbacterium sp Micrococcus luteus, Pseudomonas sp., Streptococcus sp., Streptococcus dysgalactiae, Staphylococcus epidermidis, Staphylococcus aureus, Staphylococcus pneumoniae, Stenotrophomonas sp., Enterobacter sp., Xanthomonas sp., Yersinia sp., Klebsiella sp., Burkholderia sp., Stenotrophomonas sp., Variovorax sp., Escherichia sp., Ralstonia sp., Achromobacter sp., Luteibacter sp., Citrobacter sp., Xanthomonadaceae sp., Halomonas sp., Bordetella sp., Lysobacter sp., Serratia sp., Escherichia sp., Aggregatibacter sp., Listeria monocytogenes, Clostridium difficile, Mycobacterium sp., Neisseria gonorrheae, H. influenzae, Haemophilus ducreyi, Helicobacterpylori, Campylobacterjejuni and Enterococcusfaecalis as well as the fungi Candida albicans, Aspergillus flavus, Fusarium solani, and Cryptococcus neoformans. In one aspect, the biofilm component e.g. poly-N-acetylglucosamine comprising strain is Brevundimonas sp. In one aspect, the biofilm component e.g. poly-N-acetylglucosamine comprising strain is Pseudomonas alcaliphila or Pseudomonas fluorescens. In one aspect, the biofilm component e.g. poly-N-acetylglucosamine comprising strain is Staphylococcus aureus.

Catalytic domain: The term “catalytic domain” means the region of an enzyme containing the catalytic machinery of the enzyme.

cDNA: The term “cDNA” means a DNA molecule that can be prepared by reverse transcription from a mature, spliced, mRNA molecule obtained from a eukaryotic or prokaryotic cell. cDNA lacks intron sequences that may be present in the corresponding genomic DNA. The initial, primary RNA transcript is a precursor to mRNA that is processed through a series of steps, including splicing, before appearing as mature spliced mRNA.

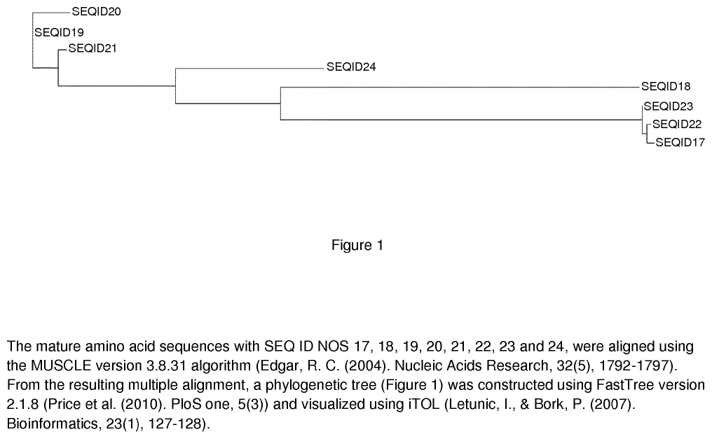

Clade: a group of polypeptides clustered together on the basis of homologous features traced to a common ancestor. Polypeptide clades can be visualized as phylogenetic trees and a clade is a group of polypeptides that consists of a common ancestor and all its lineal descendants (FIG. 1). The polypeptides all belong to the DspB clade, which is illustrated as a phylogenetic tree in FIG. 1. The clade of DspB or the DspB clade is a group of enzymes all related to the same ancestor and share common properties. Polypeptides forming a group within the clade (a subclade) of the phylogenetic tree can also share common properties and are more closely related than other polypeptides in the clade.

Coding sequence: The term “coding sequence” means a polynucleotide, which directly specifies the amino acid sequence of a polypeptide. The boundaries of the coding sequence are generally determined by an open reading frame, which begins with a start codon such as ATG, GTG, or TTG and ends with a stop codon such as TAA, TAG, or TGA. The coding sequence may be a genomic DNA, cDNA, synthetic DNA, or a combination thereof.

Control sequences: The term “control sequences” means nucleic acid sequences necessary for expression of a polynucleotide encoding a mature polypeptide. Each control sequence may be native (i.e., from the same gene) or foreign (i.e., from a different gene) to the polynucleotide encoding the polypeptide or native or foreign to each other. Such control sequences include, but are not limited to, a leader, polyadenylation sequence, propeptide sequence, promoter, signal peptide sequence, and transcription terminator. At a minimum, the control sequences include a promoter, and transcriptional and translational stop signals. The control sequences may be provided with linkers for the purpose of introducing specific restriction sites facilitating ligation of the control sequences with the coding region of the polynucleotide encoding a polypeptide.

Deep cleaning: By the term “deep cleaning” is meant reduction or removal of components of biofilm, such as EPS or parts hereof, polysaccharides, poly-N-acetylglucosamine (PNAG), proteins, DNA, soil or other components present in the biofilm.

Detergent (e.g. cleaning) adjunct ingredient: The detergent adjunct ingredient is different to the hexosaminidase. The precise nature of these additional adjunct components, and levels of incorporation thereof, will depend on the physical form of the composition and the nature of the operation for which it is to be used. Suitable adjunct materials include, but are not limited to the components described below such as surfactants, builders, flocculating aid, chelating agents, dye transfer inhibitors, enzymes, enzyme stabilizers, enzyme inhibitors, catalytic materials, bleach activators, hydrogen peroxide, sources of hydrogen peroxide, preformed peracids, polymeric agents, clay soil removal/anti-redeposition agents, brighteners, suds suppressors, dyes, perfumes, structure elasticizing agents, fabric softeners, carriers, hydrotropes, builders and co-builders, fabric huing agents, anti-foaming agents, dispersants, processing aids, bittering agents, and/or pigments. Cleaning and/or Detergent Composition: The terms “cleaning composition” and “detergent composition” are used interchangeably herein and refer to compositions that find use in the removal of undesired compounds from items to be cleaned, such as textiles or hard surfaces. The detergent composition may be used to e.g. clean textiles for both household cleaning and industrial cleaning. The terms encompass any materials/compounds selected for the particular type of cleaning composition desired and the form of the product (e.g., liquid, gel, powder, granulate, paste, or spray compositions) and includes, but is not limited to, detergent compositions (e.g., liquid and/or solid laundry detergents and fine fabric detergents; fabric fresheners; fabric softeners (fabric finishers); and textile and laundry pre-spotters/pretreatment). In addition, the term also includes hand and automatic dishwashing detergents and cleaning detergents for hard surfaces. In addition to containing the enzyme as defined herein, the detergent formulation may contain one or more additional enzymes (such as proteases, amylases, lipases, cutinases, cellulases, endoglucanases, xyloglucanases, pectinases, pectin lyases, xanthanases, peroxidases, haloperoxygenases, catalases and mannanases, or any mixture thereof), and/or detergent adjunct ingredients such as surfactants, builders, chelators or chelating agents, bleach system or bleach components, polymers, fabric conditioners, foam boosters, suds suppressors, dyes, perfume, tannish inhibitors, optical brighteners, bactericides, fungicides, soil suspending agents, anti-corrosion agents, enzyme inhibitors or stabilizers, enzyme activators, transferase(s), hydrolytic enzymes, oxido reductases, bluing agents and fluorescent dyes, antioxidants, and solubilizers.

Enzyme Detergency benefit: The term “enzyme detergency benefit” is defined herein as the advantageous effect an enzyme may add to a detergent compared to the same detergent without the enzyme. Important detergency benefits which can be provided by enzymes are stain removal with no or very little visible soils after washing and/or cleaning, prevention or reduction of redeposition of soils released in the washing process (an effect that also is termed anti-redeposition), restoring fully or partly the whiteness of textiles which originally were white but after repeated use and wash have obtained a greyish or yellowish appearance (an effect that also is termed whitening). Textile care benefits, which are not directly related to catalytic stain removal or prevention of redeposition of soils, are also important for enzyme detergency benefits. Examples of such textile care benefits are prevention or reduction of dye transfer from one fabric to another fabric or another part of the same fabric (an effect that is also termed dye transfer inhibition or anti-backstaining), removal of protruding or broken fibers from a fabric surface to decrease pilling tendencies or remove already existing pills or fuzz (an effect that also is termed anti-pilling), improvement of the fabric-softness, colour clarification of the fabric and removal of particulate soils which are trapped in the fibers of the fabric or garment. Enzymatic bleaching is a further enzyme detergency benefit where the catalytic activity generally is used to catalyze the formation of bleaching components such as hydrogen peroxide or other peroxides.

Expression: The term “expression” includes any step involved in the production of a polypeptide including, but not limited to, transcription, post-transcriptional modification, translation, post-translational modification, and secretion.

Expression vector: The term “expression vector” means a linear or circular DNA molecule that comprises a polynucleotide encoding a polypeptide and is operably linked to control sequences that provide for its expression.

Fragment: The term “fragment” means a polypeptide or a catalytic domain having one or more (e.g., several) amino acids absent from the amino and/or carboxyl terminus of a mature polypeptide or domain; wherein the fragment has hexosaminidase activity. In one aspect, a fragment contains at least 304 amino acid residues (e.g., amino acids 47 to 350 of SEQ ID NO: 2), at least 310 amino acid residues (e.g., amino acids 44 to 353 of SEQ ID NO: 2), or at least 316 amino acid residues (e.g., amino acids 41 to 356 of SEQ ID NO: 2). In one aspect, a fragment contains at least 300 amino acid residues (e.g., amino acids 1 to 300 of SEQ ID NO: 2), at least 340 amino acid residues (e.g., amino acids 1 to 340 of SEQ ID NO: 2), or at least 350 amino acid residues (e.g., amino acids 1 to 350 of SEQ ID NO: 2). In one aspect, a fragment contains at least 300 amino acid residues (e.g., amino acids 1 to 300 of SEQ ID NO: 4), at least 320 amino acid residues (e.g., amino acids 1 to 320 of SEQ ID NO: 4), or at least 340 amino acid residues (e.g., amino acids 1 to 340 of SEQ ID NO: 4). In one aspect, a fragment contains at least 300 amino acid residues (e.g., amino acids 1 to 300 of SEQ ID NO: 6), at least 340 amino acid residues (e.g., amino acids 1 to 340 of SEQ ID NO: 6), or at least 350 amino acid residues (e.g., amino acids 1 to 350 of SEQ ID NO: 6). In one aspect, a fragment contains at least 300 amino acid residues (e.g., amino acids 1 to 300 of SEQ ID NO: 8), at least 340 amino acid residues (e.g., amino acids 1 to 340 of SEQ ID NO: 8), or at least 350 amino acid residues (e.g., amino acids 1 to 350 of SEQ ID NO: 8). In one aspect, a fragment contains at least 300 amino acid residues (e.g., amino acids 1 to 300 of SEQ ID NO: 10), at least 340 amino acid residues (e.g., amino acids 1 to 340 of SEQ ID NO: 10), or at least 350 amino acid residues (e.g., amino acids 1 to 350 of SEQ ID NO: 10). In one aspect, a fragment contains at least 300 amino acid residues (e.g., amino acids 1 to 300 of SEQ ID NO: 12), at least 340 amino acid residues (e.g., amino acids 1 to 340 of SEQ ID NO: 12), or at least 350 amino acid residues (e.g., amino acids 1 to 350 of SEQ ID NO: 12). In one aspect, a fragment contains at least 300 amino acid residues (e.g., amino acids 1 to 300 of SEQ ID NO: 14), at least 340 amino acid residues (e.g., amino acids 1 to 340 of SEQ ID NO: 14), or at least 350 amino acid residues (e.g., amino acids 1 to 350 of SEQ ID NO: 14). In one aspect, a fragment contains at least 300 amino acid residues (e.g., amino acids 1 to 300 of SEQ ID NO: 16), at least 340 amino acid residues (e.g., amino acids 1 to 340 of SEQ ID NO: 16), or at least 340 amino acid residues (e.g., amino acids 1 to 340 of SEQ ID NO: 16).

Host cell: The term “host cell” means any cell type that is susceptible to transformation, transfection, transduction, or the like with a nucleic acid construct or expression vector comprising a polynucleotide. The term “host cell” encompasses any progeny of a parent cell that is not identical to the parent cell due to mutations that occur during replication.

Isolated: The term “isolated” means a substance in a form or environment that does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., recombinant production in a host cell; multiple copies of a gene encoding the substance; and use of a stronger promoter than the promoter naturally associated with the gene encoding the substance). An isolated substance may be present in a fermentation broth sample; e.g. a host cell may be genetically modified to express the polypeptide. The fermentation broth from that host cell will comprise the isolated polypeptide.

Improved wash performance: The term “improved wash performance” is defined herein as an enzyme displaying an increased wash performance in a detergent composition relative to the wash performance of same detergent composition without the enzyme e.g. by increased stain removal or less re-deposition. The term “improved wash performance” includes wash performance in laundry.

Laundering: The term “laundering” relates to both household laundering and industrial laundering and means the process of treating textiles with a solution containing a cleaning or detergent composition. The laundering process can for example be carried out using e.g. a household or an industrial washing machine or can be carried out by hand.

Malodor: By the term “malodor” is meant an odor which is not desired on clean items. The cleaned item should smell fresh and clean without malodors adhered to the item. One example of malodor is compounds with an unpleasant smell, which may be produced by microorganisms. Another example is unpleasant smells can be sweat or body odor adhered to an item which has been in contact with human or animal. Another example of malodor can be the odor from spices, which sticks to items for example curry or other exotic spices which smells strongly.

Mature polypeptide: The term “mature polypeptide” means a polypeptide in its final form following translation and any post-translational modifications, such as N-terminal processing, C-terminal truncation, glycosylation, phosphorylation, etc. In some aspects, the mature polypeptide is amino acids 1 to 359 of SEQ ID NO: 2 and amino acids −1 to −22 of SEQ ID NO: 2 are a signal peptide. In some aspects, the mature polypeptide is the amino acid sequence having SEQ ID NO 17. In some aspects, the mature polypeptide is amino acids 1 to 346 of SEQ ID NO: 4 and amino acids −1 to −22 of SEQ ID NO: 4 are a signal peptide. In some aspects, the mature polypeptide is the amino acid sequence having SEQ ID NO 18. In some aspects, the mature polypeptide is amino acids 1 to 352 of SEQ ID NO: 6 and amino acids −1 to −26 of SEQ ID NO: 6 are a signal peptide. In some aspects, the mature polypeptide is the amino acid sequence having SEQ ID NO 19. In some aspects, the mature polypeptide is amino acids 1 to 352 of SEQ ID NO: 8 and amino acids −1 to −26 of SEQ ID NO: 8 are a signal peptide. In some aspects, the mature polypeptide is the amino acid sequence having SEQ ID NO 20. In some aspects, the mature polypeptide is amino acids 1 to 352 of SEQ ID NO: 10 and amino acids −1 to −26 of SEQ ID NO: 10 are a signal peptide. In some aspects, the mature polypeptide is the amino acid sequence having SEQ ID NO 21. In some aspects, the mature polypeptide is amino acids 1 to 359 of SEQ ID NO: 12 and amino acids −1 to −22 of SEQ ID NO: 12 are a signal peptide. In some aspects, the mature polypeptide is the amino acid sequence having SEQ ID NO 22. In some aspects, the mature polypeptide is amino acids 1 to 359 of SEQ ID NO: 14 and amino acids −1 to −22 of SEQ ID NO: 14 are a signal peptide. In some aspects, the mature polypeptide is the amino acid sequence having SEQ ID NO 23. In some aspects, the mature polypeptide is amino acids 1 to 351 of SEQ ID NO: 16 and amino acids −1 to −26 of SEQ ID NO: 16 are a signal peptide. In some aspects, the mature polypeptide is the amino acid sequence having SEQ ID NO 24.

It is known in the art that a host cell may produce a mixture of two of more different mature polypeptides (i.e., with a different C-terminal and/or N-terminal amino acid) expressed by the same polynucleotide. It is also known in the art that different host cells process polypeptides differently, and thus, one host cell expressing a polynucleotide may produce a different mature polypeptide (e.g., having a different C-terminal and/or N-terminal amino acid) as compared to another host cell expressing the same polynucleotide.

Mature polypeptide coding sequence: The term “mature polypeptide coding sequence” means a polynucleotide that encodes a mature polypeptide having hexosaminidase activity. In one aspect, the mature polypeptide coding sequence is nucleotides 67 to 1143 of SEQ ID NO: 1 and nucleotides 1 to 66 of SEQ ID NO: 1 encodes a signal peptide. In one aspect, the mature polypeptide coding sequence is nucleotides 67 to 1104 of SEQ ID NO: 3 and nucleotides 1 to 66 of SEQ ID NO: 3 encode a signal peptide. In one aspect, the mature polypeptide coding sequence is nucleotides 79 to 1134 of SEQ ID NO: 5 and nucleotides 1 to 78 of SEQ ID NO: 5 encode a signal peptide. In one aspect, the mature polypeptide coding sequence is nucleotides 79 to 1134 of SEQ ID NO: 7 and nucleotides 1 to 78 of SEQ ID NO: 7 encode a signal peptide. In one aspect, the mature polypeptide coding sequence is nucleotides 79 to 1134 of SEQ ID NO: 9 and nucleotides 1 to 78 of SEQ ID NO: 9 encode a signal peptide. In one aspect, the mature polypeptide coding sequence is nucleotides 67 to 1143 of SEQ ID NO: 11 and nucleotides 1 to 66 of SEQ ID NO: 11 encode a signal peptide. In one aspect, the mature polypeptide coding sequence is nucleotides 67 to 1143 of SEQ ID NO: 13 and nucleotides 1 to 66 of SEQ ID NO: 13 encode a signal peptide. In one aspect, the mature polypeptide coding sequence is nucleotides 79 to 1131 of SEQ ID NO: 15 and nucleotides 1 to 78 of SEQ ID NO: 15 encode a signal peptide.

Nucleic acid construct: The term “nucleic acid construct” means a nucleic acid molecule, either single- or double-stranded, which is isolated from a naturally occurring gene or is modified to contain segments of nucleic acids in a manner that would not otherwise exist in nature or which is synthetic, which comprises one or more control sequences.

Operably linked: The term “operably linked” means a configuration in which a control sequence is placed at an appropriate position relative to the coding sequence of a polynucleotide such that the control sequence directs expression of the coding sequence.

Sequence identity: The relatedness between two amino acid sequences or between two nucleotide sequences is described by the parameter “sequence identity”.

For purposes herein, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), such as version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the-nobrief option) is used as the percent identity and is calculated as follows:

(Identical Residues×100)/(Length of Alignment−Total Number of Gaps in Alignment)

Stringency conditions: The term “very low stringency conditions” means for probes of at least 100 nucleotides in length, pre-hybridization and hybridization at 42° C. in 5×SSPE, 0.3% SDS, 200 micrograms/ml sheared and denatured salmon sperm DNA, and 25% formamide, following standard Southern blotting procedures for 12 to 24 hours. The carrier material is finally washed three times each for 15 minutes using 2×SSC, 0.2% SDS at 45° C.

The term “low stringency conditions” means for probes of at least 100 nucleotides in length, pre-hybridization and hybridization at 42° C. in 5×SSPE, 0.3% SDS, 200 micrograms/ml sheared and denatured salmon sperm DNA, and 25% formamide, following standard Southern blotting procedures for 12 to 24 hours. The carrier material is finally washed three times each for 15 minutes using 2×SSC, 0.2% SDS at 50° C.

The term “medium stringency conditions” means for probes of at least 100 nucleotides in length, pre-hybridization and hybridization at 42° C. in 5×SSPE, 0.3% SDS, 200 micrograms/ml sheared and denatured salmon sperm DNA, and 35% formamide, following standard Southern blotting procedures for 12 to 24 hours. The carrier material is finally washed three times each for 15 minutes using 2×SSC, 0.2% SDS at 55° C.

The term “medium-high stringency conditions” means for probes of at least 100 nucleotides in length, pre-hybridization and hybridization at 42° C. in 5×SSPE, 0.3% SDS, 200 micrograms/ml sheared and denatured salmon sperm DNA, and 35% formamide, following standard Southern blotting procedures for 12 to 24 hours. The carrier material is finally washed three times each for 15 minutes using 2×SSC, 0.2% SDS at 60° C.

The term “high stringency conditions” means for probes of at least 100 nucleotides in length, pre-hybridization and hybridization at 42° C. in 5×SSPE, 0.3% SDS, 200 micrograms/ml sheared and denatured salmon sperm DNA, and 50% formamide, following standard Southern blotting procedures for 12 to 24 hours. The carrier material is finally washed three times each for 15 minutes using 2×SSC, 0.2% SDS at 65° C.

The term “very high stringency conditions” means for probes of at least 100 nucleotides in length, pre-hybridization and hybridization at 42° C. in 5×SSPE, 0.3% SDS, 200 micrograms/ml sheared and denatured salmon sperm DNA, and 50% formamide, following standard Southern blotting procedures for 12 to 24 hours. The carrier material is finally washed three times each for 15 minutes using 2×SSC, 0.2% SDS at 70° C.]

Variant: The term “variant” means a polypeptide having hexosaminidase activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position.

In one aspect, a hexosaminidase variant may comprise from 1 to 5; from 1 to 10; from 1 to 15; from 1 to 20; from 1 to 25; from 1 to 30; from 1 to 35; from 1 to 40; from 1 to 45; or from 1-50, i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 alterations and have at least 20%, e.g., at least 40%, at least 50%, at least 60%, at least 70%, at least 80%, at least 90%, at least 95%, or at least 100% of the hexosaminidase activity of the parent hexosaminidase, such as SEQ ID NO: 17.

In one aspect, a hexosaminidase variant may comprise from 1 to 5; from 1 to 10; from 1 to 15; from 1 to 20; from 1 to 25; from 1 to 30; from 1 to 35; from 1 to 40; from 1 to 45; or from 1-50, i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 alterations and have at least 20%, e.g., at least 40%, at least 50%, at least 60%, at least 70%, at least 80%, at least 90%, at least 95%, or at least 100% of the hexosaminidase activity of the parent hexosaminidase, such as SEQ ID NO: 18.

In one aspect, a hexosaminidase variant may comprise from 1 to 5; from 1 to 10; from 1 to 15; from 1 to 20; from 1 to 25; from 1 to 30; from 1 to 35; from 1 to 40; from 1 to 45; or from 1-50, i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 alterations and have at least 20%, e.g., at least 40%, at least 50%, at least 60%, at least 70%, at least 80%, at least 90%, at least 95%, or at least 100% of the hexosaminidase activity of the parent hexosaminidase, such as SEQ ID NO: 19.

In one aspect, a hexosaminidase variant may comprise from 1 to 5; from 1 to 10; from 1 to 15; from 1 to 20; from 1 to 25; from 1 to 30; from 1 to 35; from 1 to 40; from 1 to 45; or from 1-50, i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 alterations and have at least 20%, e.g., at least 40%, at least 50%, at least 60%, at least 70%, at least 80%, at least 90%, at least 95%, or at least 100% of the hexosaminidase activity of the parent hexosaminidase, such as SEQ ID NO: 20.

In one aspect, a hexosaminidase variant may comprise from 1 to 5; from 1 to 10; from 1 to 15; from 1 to 20; from 1 to 25; from 1 to 30; from 1 to 35; from 1 to 40; from 1 to 45; or from 1-50, i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 alterations and have at least 20%, e.g., at least 40%, at least 50%, at least 60%, at least 70%, at least 80%, at least 90%, at least 95%, or at least 100% of the hexosaminidase activity of the parent hexosaminidase, such as SEQ ID NO: 21.

In one aspect, a hexosaminidase variant may comprise from 1 to 5; from 1 to 10; from 1 to 15; from 1 to 20; from 1 to 25; from 1 to 30; from 1 to 35; from 1 to 40; from 1 to 45; or from 1-50, i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 alterations and have at least 20%, e.g., at least 40%, at least 50%, at least 60%, at least 70%, at least 80%, at least 90%, at least 95%, or at least 100% of the hexosaminidase activity of the parent hexosaminidase, such as SEQ ID NO: 22.

In one aspect, a hexosaminidase variant may comprise from 1 to 5; from 1 to 10; from 1 to 15; from 1 to 20; from 1 to 25; from 1 to 30; from 1 to 35; from 1 to 40; from 1 to 45; or from 1-50, i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 alterations and have at least 20%, e.g., at least 40%, at least 50%, at least 60%, at least 70%, at least 80%, at least 90%, at least 95%, or at least 100% of the hexosaminidase activity of the parent hexosaminidase, such as SEQ ID NO: 23.

In one aspect, a hexosaminidase variant may comprise from 1 to 5; from 1 to 10; from 1 to 15; from 1 to 20; from 1 to 25; from 1 to 30; from 1 to 35; from 1 to 40; from 1 to 45; or from 1-50, i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 alterations and have at least 20%, e.g., at least 40%, at least 50%, at least 60%, at least 70%, at least 80%, at least 90%, at least 95%, or at least 100% of the hexosaminidase activity of the parent hexosaminidase, such as SEQ ID NO: 24.

### DETAILED DESCRIPTION

The present composition relates to compositions as defined herein comprising polypeptides having hexosaminidase activity such as PNAG (poly-N-acetylglucosamine) activity. Organic matter such as biofilm produces EPS (extra polymeric substances), which often comprises polysaccharides such as PNAG. The polypeptides described herein are therefore effective in preventing, reducing and removing organic components such as PNAG. Organic matter such as biofilm associated with cleaning processes e.g. in textiles such as laundry is an important challenge since it may be associated with consumer relevant problems such as e.g. malodor and re-deposition. WO2014/087011 describes the use of a deoxyribonuclease (DNase) and other enzymes for reducing malodor from laundry and/or textile, WO9909143 describes the use of one or more oxidoreductases in combination with a mediator for the reduction of malodor and WO2012/112718 describes a method for inhibiting production of laundry malodor caused by bacteria by using various strains of Bacillus. The present composition relates to cleaning compositions comprising polypeptides from the clade of DspB having hexosaminidase activity. Also claimed are cleaning/laundering methods and the use of the compositions comprising polypeptides with hexosaminidase activity. In particular, the polypeptides from the clade of DspB with hexosaminidase activity are useful in reducing and preventing staining of items being washed. The inventors have surprisingly found that the polypeptides of the clade of DspB having hexosaminidase activity are useful for laundry associated biofilm components, such as EPS and/or PNAG. In WO200406117 is described compositions comprising DspB, the composition may include a detergent which may be anionic, cationic, or non-ionic. However, there is no indication in the art of the use of DspB in cleaning processes such as laundry or in detergent compositions comprising e.g. builders and/or bleaches. To be useful in cleaning processes the enzymes need to perform its action in detergents under the conditions of cleaning processes such as laundry, which includes stability in the presence of detergent components such as surfactants, builders and bleach components. Components of a detergent may significantly effect on the performance of the enzymes such as DspB. The present application surprisingly shows that polypeptides belonging to the DspB clades and which have hexosaminidase activity are useful for deep cleaning e.g. of textiles or washing machines.

The polypeptide described herein may comprise several motifs one example is GXDE (SEQ ID NO 27) situated in positions corresponding to positions 166 to 169 in Haemophilus sputorum (SEQ ID NO 18). Residues D and E are the key catalytic residues of GH20 enzymes (position 160 to 161 in SEQ ID NO 9). The polypeptides described herein having hexosaminidase e.g. PNAG activity may comprise the structural domains of GH20. The polypeptides in GH20 can be separated into multiple distinct sub-clusters, or clades, where we denoted the clades listed below. The distinct motifs for each clade are described in details below.

A domain, shared by the polypeptides described herein, was identified. This domain has not been described previously. The domain is termed LES and polypeptides of this domain comprises a GH20 domain, are of bacterial origin and have hexosaminidase activity e.g. PNAG activity. The polypeptides of the LES domain comprises the motif example [EQ][NRSHA][YVFL][AGSTC][IVLF][EAQYN][SN] (SEQ ID NO: 28), corresponding to pos 46 to 52 of SEQ ID NO 18.

One embodiment relates to compositions, as defined herein, comprising polypeptides having hexosaminidase activity and which comprise the motif [EQ][NRSHA][YVFL][AGSTC][IVLF][EAQYN][SN](SEQ ID NO: 28), and/or the motif GXDE (SEQ ID NO 27).

The polypeptides comprising the LES domain are of bacterial origin, have hexosaminidase e.g. PNAG activity. The polypeptides of the LES domain HFH clade comprises the motif example HFHIGG (SEQ ID NO: 29), corresponding to pos 162 to 167 of SEQ ID NO 18, where H (corresponding to position 162 of SEQ ID NO 18) is fully conserved in HFH clade. Another motif which may be comprised by the polypeptides of the HFH clade is FLHLHF (SEQ ID NO: 30), 37 to 42 in SEQ ID NO 18. A further motif which may be comprised by the polypeptides of the HFH clade is DHENYA (SEQ ID NO: 31), corresponding to amino acids 44 to 49 of SEQ ID NO 18.

One embodiment relates to compositions as defined herein comprising polypeptides comprising one or more motif(s) GXDE (SEQ ID NO 27), [EQ][NRSHA][YVFL][AGSTC][IVLF][EAQYN][SN](SEQ ID NO: 28), HFHIGG (SEQ ID NO: 29), FLHLHF (SEQ ID NO: 30) or DHENYA (SEQ ID NO: 31), one or more of the motif(s) HFHIGG (SEQ ID NO: 29), FLHLHF (SEQ ID NO: 30) or DHENYA (SEQ ID NO: 31).

In one embodiment, the polypeptide belongs to the HFH clade and comprises one or more motif(s) HFHIGG (SEQ ID NO: 29), FLHLHF (SEQ ID NO: 30) or DHENYA (SEQ ID NO: 31).

The polypeptides of the DspB clades may also comprise the [EQ][NRSHA][YVFL][AGSTC][IVLF][EAQYN][SN] (SEQ ID NO: 28), and/or the motif GXDE (SEQ ID NO 27), the polypeptides of the comprises the HFH-subclade and comprises one or more motif(s) HFHIGG (SEQ ID NO: 29), FLHLHF (SEQ ID NO: 30) or DHENYA (SEQ ID NO: 31). An overview of the DspB clade is provided in FIG. 1. The DspB clade comprises homologous sequences close to DspB. The polypeptides with hexosaminidase activity having the mature amino acid sequences SEQ ID 17, 18, 19, 20, 21, 22, 23 and 24 can be pairwise aligned using the Needleman-Wunsch algorithm (Needleman and Wunsch, 1970, J. Mol. Biol. 48: 443-453). The percent identities resulting from such alignments are shown in Table 1 below.

TABLE 1

| 20 | 19 | 22 | 18 | 24 | 21 | 23 | 17 | SEQ ID NO |
|---|---|---|---|---|---|---|---|---|
| 100.0 | 95.7 | 58.6 | 57.0 | 74.4 | 92.9 | 58.9 | 58.3 | 20 |
| 95.7 | 100.0 | 58.3 | 57.6 | 76.1 | 96.3 | 58.6 | 58.0 | 19 |
| 58.6 | 58.3 | 100.0 | 53.5 | 58.2 | 58.9 | 98.9 | 98.6 | 22 |
| 57.0 | 57.6 | 53.5 | 100.0 | 58.6 | 57.6 | 53.8 | 53.2 | 18 |
| 74.4 | 76.1 | 58.2 | 58.6 | 100.0 | 76.9 | 58.5 | 57.9 | 24 |
| 92.9 | 96.3 | 58.9 | 57.6 | 76.9 | 100.0 | 59.1 | 58.6 | 21 |
| 58.9 | 58.6 | 98.9 | 53.8 | 58.5 | 59.1 | 100.0 | 98.6 | 23 |
| 58.3 | 58.0 | 98.6 | 53.2 | 57.9 | 58.6 | 98.6 | 100.0 | 17 |

Table 1 show that some of the polypeptides share closer sequence relatedness than others. For example, the polypeptides comprising the amino acids sequences of SEQ ID NOS 19, 20 and 21 belongs to a subclade of the DspB clade (FIG. 1). These polypeptides share more than 90% pairwise sequence identity and are closer related to each other compared to e.g. SEQ ID NOS 24 or 18 which lies further away in the tree.

The polypeptides disclosed herein all lie within the same clade, the DspB clade, and all have common functional features including deep cleaning properties in the presence of detergents.

In one aspect, the composition relates to a a cleaning composition, as defined herein, such as a laundry or dish wash composition, comprising at least 0.0001 ppm polypeptide having hexosaminidase activity, wherein the polypeptide comprises one or more of the motif(s) GXDE (SEQ ID NO 27), [EQ][NRSHA][YVFL][AGSTC][IVLF][EAQYN][SN] (SEQ ID NO: 28), HFHIGG (SEQ ID NO: 29), FLHLHF (SEQ ID NO: 30) or DHENYA (SEQ ID NO: 31) and at least one further ingredient as defined herein. In a non-limiting embodiment, the polypeptide comprises one or all the motif(s) HFHIGG (SEQ ID NO: 29), FLHLHF (SEQ ID NO: 30) or DHENYA (SEQ ID NO: 31). In one aspect, the polypeptide has at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the polypeptide shown in SEQ ID NO 17, SEQ ID NO 18, SEQ ID NO 19, SEQ ID NO 20, SEQ ID NO 21, SEQ ID NO 22, SEQ ID NO 23 or SEQ ID NO 24.

The amount of polypeptide may be in the range of 0.00004-100 ppm, such as in the range of 0.00008-50 ppm, in the range of 0.00001-20, in the range of 0.0002-20 ppm, in the range of 0.0001-50 ppm, in the range of 0.0002-50, in the range of 0.0004-50, in the range of 0.0008-50, in the range of 0.001-50 ppm, 0.01-50 ppm, 0.0001-50 ppm, alternatively from 0.0002-20 ppm, alternatively from 0.0002-10 ppm, alternatively from 0.001-10 ppm, or 0.002-10 ppm. The hexosaminidase may be in an amount corresponding to at least 0.00001 ppm, such as at least 0.00002 ppm, at least 0.0001 ppm, at least 0.0002 ppm, at least 0.0005 ppm, at least 0.001 ppm, at least 0.002 mg ppm, at least 0.005 ppm, at least 0.01 ppm or at least 0.02 ppm. The composition may comprise at least 0.00008%, such as at least 0.0000.1%, 0.00002%, 0.000.1%, 0.0002%, 0.001%, 0.002%, 0.003%, 0.004%, 0.005%, 0.006%, 0.008%, 0.01%, 0.02%, 0.03%, 0.05%, 0.1%, 0.2%, 0.3%, 0.4%, 0.6%, 0.7%, 0.8%, 0.9% or 1.0% hexosaminidase.

As described above, the DspB clade may be further divided into more narrow subclades or subgroups of sequences. In addition to the above described overall common properties of the DspB clade each subclade may also have specific common properties. The inventors have surprisingly found that the polypeptides of the subclade comprising the polypeptides with SEQ ID NO 19, 20 and 21, or polypeptides having at least 80% sequence identity hereto, which may be defined as a subclade of the DspB clade share specific properties, more precisely the polypeptides comprised by this subclade all have deep cleaning effect on a broad range of detergents and are useful e.g. in detergents with different surfactant composition such as in detergent comprising anionic, non-ionic, cationic and/or amphoteric surfactants and in different ratios of e.g. anionic and nonionic surfactants.

All compositions described herein may comprise surfactants; if not indicated otherwise, from about 5 wt % to about 50 wt %, from about 5 wt % to about 40 wt %, from about 5 wt % to about 30 wt %, from about 5 wt % to about 20 wt %, from about 5 wt % to about 10 wt % surfactants. “About”, as used herein in relation to a numerical value means said value ±10%, such as +5%. “About 5 wt %” thus means from 4.5 to 5.5 wt %, such as from 4.75 to 5.25 wt %. If not indicated otherwise, the surfactant may be generally selected among nonionic, anionic and/or amphoteric surfactants. In general, bleach-stable surfactants are useful. Non-limiting anionic surfactants are sulphate surfactants and in particular alkyl ether sulphates, especially C9-C15 alcohol ether sulfates, such as ethoxylates or mixed ethoxylates/propoxylates, such as those with 1 to 30 EO, C12-C15 primary alcohol ethoxylate, such as those with 1 to 30 EO, C8-C16 ester sulphates and C10-C14 ester sulphates, such as mono dodecyl ester sulphates. Non-limiting examples of anionic surfactants include sulfates and sulfonates, in particular, linear alkylbenzenesulfonates (LAS), in particular C12-C13 alkyl benzene sulfonates, isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ether sulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), and combinations thereof. The anionic surfactants are added to the detergent in the form of salts. Suitable cations in these salts are alkali metal ions, such as sodium, potassium and lithium and ammonium salts, for example (2-hydroxyethyl) ammonium, bis(2-hydroxyethyl) ammonium and tris(2-hydroxyethyl) ammonium salts. Non-limiting examples of nonionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof. Commercially available nonionic surfactants include Plurafac™, Lutensol™ and Pluronic™ range from BASF, Dehypon™ series from Cognis and Genapol™ series from Clariant.

In various embodiments, said surfactant comprises at least one alkyl ether sulfate. Non-limiting alkyl ether sulfates are those of formula (I)

R¹—O-(AO)ₙ—SO₃⁺X⁺ (I).

In formula (I) R¹ represents a linear or branched, substituted or unsubstituted alkyl group, such as a linear, unsubstituted alkyl group, e.g. a fatty alcohol moiety. Non-limiting R¹ moieties are selected from the group consisting of decyl, undecyl, dodecyl, tridecyl, tetradecyl, pentadecyl, hexadecyl, heptadecyl, octadecyl, nonadecyl, eicosyl moieties and mixtures thereof, wherein those groups with an even number of carbon atoms are useful herein. Non-limiting R¹ moieties are derived from C₁₀-C₁₈ fatty alcohols, such as those derived from coconut oil alcohols, tallow fatty alcohols, lauryl, myristyl, cetyl or stearyl alcohol or from C₁₀-C₂₀ oxoalcohols.

AO represents an ethyleneoxide (EO) or propyleneoxide (PO) group, such as an ethyleneoxide group. The index n represents an integer from 1 to 50, such as from 1 to 20 or from 1 to 10. In a non-limiting embodiment, n is 1, 2, 3, 4, 5, 6, 7 or 8. X represents a monovalent cation or the n-th part of an n-valent cation, such as alkali metal cations, specifically Na⁺ and K⁺, e.g. Na⁺. Further cations X⁺ may be selected from NH₄⁺, ½ Zn²⁺, ½ Mg²⁺, ½ Ca²⁺, ½ Mn²⁺, and combinations thereof.

In various embodiments, the detergent compositions comprise an alkyl ether sulfate selected from fatty alcohol ether sulfates of formula (II)

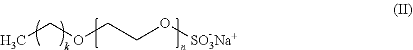

wherein k=9 to 19, and n=1, 2, 3, 4, 5, 6, 7 or 8. Non-limiting examples are C₁₀₋₁₆ fatty alcohol ether sulfates with 1-7 EO (k=9-15, n=1-7), such as the C₁₂₋₁₄ fatty alcohol ether sulfates with 1-3, particularly 2 EO (k=11-13, n=1-3 or 2), more particularly the sodium salts thereof. One specific embodiment thereof is lauryl ether sulfate sodium salt with 2 EO. The level of ethoxylation is an average value and can, for a specific compound, be an integer or fractional number.

In various embodiments, the surfactant comprises at least one alkyl benzene sulfonate. Said alkyl benzene sulfonate may be present alternatively to the above alkyl ether sulfate or in addition to it.

Exemplary alkyl benzene sulfonates include, but are not limited to linear and branched alkyl benzene sulfonates, such as linear alkyl benzene sulfonates. Exemplary compounds are those of formula (III)

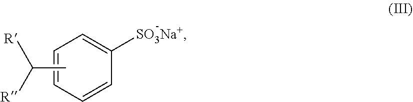

wherein R′ and R″ are independently H or alkyl and combined comprise 9 to 19, such as 9 to 15 or from 9 to 13 carbon atoms. Non-limiting examples are dodecyl and tridecyl benzene sulfonates, in particular the sodium salts thereof.

In addition or alternatively, the compositions may further comprise one or more nonionic surfactants.

Non-limiting nonionic surfactants are those of formula (IV)

R²—O-(AO)ₘ—H (IV),

wherein R² represents a linear or branched substituted or unsubstituted alkyl moiety, AO represents an ethylene oxide (EO) or propylene oxide (PO) group and m is an integer from 1 to 50.

In formula (IV) R² represents a linear or branched, substituted or unsubstited alkyl group, such as a linear, unsubstituted alkyl group, such as a fatty alcohol group. Non-limiting groups are R² are selected from decyl, undecyl, dodecyl, tridecyl, tetradecyl, pentadecyl, hexadecyl, heptadecyl, octadecyl, nonadecyl, eicosyl groups and combinations thereof, wherein those groups with an even number of carbon atoms are useful herein. Non-limiting examples are R² groups derived from C₁₂-C₁₈ fatty alcohols, such as coconut oil alcohol, tallow oil alcohol, lauryl, myristyl, cetyl or stearyl alcohol or from C₁₀-C₂₀ oxoalcohols.

AO represents an ethyleneoxide (EO) or propyleneoxide (PO) group, such as an ethyleneoxide group. The index m represents an integer from 1 to 50, such as from 1 to 20 or from 1 to 6. In a non-limiting embodiment, m is 1, 2, 3, 4 or 5, or 3-5, as higher degrees of ethoxylation may negatively influence viscosity and stability.

In various embodiments, the detergent compositions comprise an alkyl ether selected from fatty alcohol ethers of formula (V)

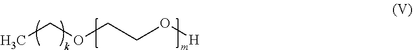

wherein k=11 to 19, m=1, 2, 3, 4, 5, 6, 7 or 8. Non-limiting examples are C₁₂₋₁₈ fatty alcohols with 1-6 EO (k=11-17, m=1-5 in formula (V)). C₁₂₋₁₄ alcohols may have 1-5 EO, such as are C₁₂₋₁₄ alkyl ethers with 3-5 EO, in particular lauryl ether with 5 EO.

The detergent compositions may further include other nonionic surfactants, such as alkyl glucosides of the general formula RO(G)ₓ, where R is a primary linear or 2-methyl-branched aliphatic radical containing 8 to 22 or from 12 to 18 carbon atoms and G stands for a glucose unit. The degree of oligomerization x, which indicates the distribution of monoglucosides and oligoglucosides, is a number of 1 to 10 or a number of 1.2 to 1.4.

In various embodiments, the composition comprises at least two anionic surfactants, e.g. at least one alkyl ether sulfate and optionally at least one alkyl benzene sulfonate, and optionally an alkyl ether.

Suitable amphoteric surfactants comprise betains. Non-limiting betaines are the alkylbetaines, the alkylamidobetaines, the imidazolinium betaines, the sulfobetaines (INCI Sultaines) and the phosphobetaines. Examples of suitable betaines and sulfobetaines are the following compounds designated as INCI: almondamidopropyl betaines, apricotam idopropyl betaines, avocadamidopropyl betaines, babassuamidopropyl betaines, behenamide idopropyl betaines, behenyl betaines, betaines, canola idopropyl betaines, caprylic/capram idopropyl betaines, carnitines, cetyl betaines, Cocamidoethyl betaines, cocamidopropyl betaines, cocam idopropyl hydroxysultaines, cocobetaines, coco-hydroxysultaines, coco/oleam idopropyl betaines, coco-sultaines, decyl betaines, dihydroxyethyl oleyl glycinates, dihydroxyethyl soy glycinates, dihydroxyethyl stearyl glycinates, dihydroxyethyl tallow glycinates, dimethicones propyl PG Betaines, erucam idopropyl hydroxysultaines, hydrogenated tallow betaines, isostearam idopropyl betaines, lauram idopropyl betaines, lauryl betaines, lauryl hydroxysultaine, lauryl sultaines, milkamidopropyl betaines, minkam idopropyl betaines, myristamine idopropyl betaines, myristyl betaines, oleam idopropyl betaines, oleam idropy Hydroxysultain, Oleyl Betaine, Olivamidopropyl Betaine, Palmam Idopropyl Betaine, Palm Itam Idopropyl Betaine, Palmitoyl Carnitine, Palm Kernelamidopropyl Betaine, Polytetrafluoroethylene Acetoxypropyl Betaine, Ricinoleam Idopropyl Betaine, Sesamidopropyl Betaine, Soyamidopropyl Betaine, Stearam Idopropyl Betaine, Stearyl Betaine, Tallowam Idopropyl Betaine, Tallowamidopropyl Hydroxysultaine, Tallow Betaine, Tallow Dihydroxyethyl Betaine, Undecylenamidopropyl Betaine and Wheat Germamidopropyl Betaine. A non-limiting betaine is, for example, cocamidopropyl betaine (cocoamidopropylbetaine). The betaines are useful for dishwashing compositions, such as hand dishwashing detergent compositions.

Further suitable surfactants include the amine oxides. The amine oxides suitable include alkylamine oxides, in particular alkyldimethylamine oxides, alkylamidoamine oxides and alkoxyalkylamine oxides. Examples of suitable amine oxides are the following compounds designated as INCI: Almond amidopropylamine oxides, Babassu amidopropylamine oxides, Behenamine oxides, Cocamidopropyl Amine oxides, Cocamidopropylamine oxides, Cocamine oxides, Coco-Morpholine oxides, Decylamine oxides, Decyltetradecylamine oxides, Diaminopyrimidine oxides, Dihydroxyethyl C8-10 alkoxypropylamines oxides, Dihydroxyethyl C9-11 alkoxypropylamines oxides, dihydroxyethyl C12-15 alkoxypropylamines oxides, dihydroxyethyl cocamine oxides, dihydroxyethyl lauramine oxides, dihydroxyethyl stearamines oxides, dihydroxyethyl tallowamine oxides, hydrogenated palm kernel amine oxides, hydrogenated tallowamine oxides, hydroxyethyl hydroxypropyl C12-15 alkoxypropylamines oxides, isostearamidopropylamines Oxides, isostearamidopropyl morpholine oxides, lauram idopropylamine oxides, lauramine oxides, methyl morpholine oxides, milkamidopropyl amine oxides, mincamidopropylamine oxides, myristamine idopropylamine oxides, myristamine oxides, myristyl/cetyl amines Oxides, Oleam idopropylamine oxides, Oleamine oxides, Ol ivam idopropylam ine oxides, Palmitamidopropylamine oxides, Palmitamine oxides, PEG-3 Lauramine oxides, Potassium dihydroxyethyl Cocamine oxides phosphates, Potassium Trisphosphonomethylamine oxides, Sesamidopropylamine oxides, Soyamidopropylamine oxides, Stearam idopropylam ine oxides, stearamines Oxides, Tallowam idopropylam ine oxides, Tallowamine oxides, Undecylenamidopropylamine oxides and Wheat Germam idopropylam ine oxides. A non-limiting amine oxide is, for example, cocamidopropylamine oxides (cocoamidopropylamine oxide).

For automatic dishwashing applications, low-foaming nonionic surfactants are used, in particular alkoxylated, especially ethoxylated, low-foaming nonionic surfactants. In a non-limiting embodiment, the automatic dishwashing detergents contain nonionic surfactants from the group of the alkoxylated alcohols. Nonionic surfactants may have a melting point above room temperature. Nonionic surfactants having a melting point above 20° C., or above 25° C., or between 25 and 60° C. and especially between 26.6 and 43.3° C., are useful herein. In a non-limiting embodiment, used surfactants are those from the groups of alkoxylated nonionic surfactants, in particular the ethoxylated primary alcohols and mixtures of these surfactants with structurally more complex surfactants such as polyoxypropylene/polyoxyethylene/polyoxypropylene ((PO/EO/PO) surfactants). Such (PO/EO/PO) nonionic surfactants are also characterized by good foam control. Non-limiting nonionic surfactants are those containing alternating ethylene oxide and different alkylene oxide units. Among these, in turn, surfactants with EO-AO-EO-AO blocks are useful, with one to ten EO or AO groups before one block from the other group follows. Exemplary nonionic surfactants are those having a C9-alkyl group with 1 to 4 ethylene oxide units followed by 1 to 4 propylene oxide units, followed by 1 to 4 ethylene oxide units followed by 1 to 4 propylene oxide units. A non-limiting example may include end-capped, poly (oxyalkylated) nonionic surfactants with the end-cap being a linear or branched, saturated or unsaturated, aliphatic or aromatic hydrocarbon radical R having 1 to 30 carbon atoms. The alkyl groups may also comprise hydroxyl groups. The group of these nonionic surfactants include, for example, the C4-22 fatty alcohol (EO)₁₀-5₀-2-hydroxyalkyl ethers, in particular also the C8-12 fatty alcohol (EO)₂₂-2-hydroxydecyl ethers and the C4-22 fatty alcohol (EO)₄₀₋₈₀-2-hydroxyalkyl ethers.

The composition as defined herein may comprise, if not indicated otherwise, 0-65% by weight, such as about 5% to about 50% by weight, such as about 40-65% by weight, such as about 50-65% by weight, particularly about 20-65% by weight or particularly from 10% to 50% by weight of at least one builder. Generally and if not indicated otherwise, the builder may be selected from citrate, carbonate, silicate, aluminosilicate (zeolite) and combinations thereof. Suitable builders also include phosphonates, polyphosphonates, bicarbonates, borates, and further polycarboxylates. Citrate builders, e.g., citric acid and soluble salts thereof (particularly sodium salt), are particularly suitable water-soluble organic builders. Citrates can be used in combination with zeolite, silicates like the BRITESIL types, and/or layered silicate builders. The builder and/or co-builder may be any chelating agent that forms water-soluble complexes with Ca and Mg. Any builder and/or co-builder known in the art for use in cleaning detergents may be utilized. Non-limiting examples of builders include zeolites, in particular zeolite A or P or X, carbonates such as sodium carbonate, soluble silicates such as sodium metasilicate, layered silicates (e.g., SKS-6 from Hoechst), and (carboxymethyl)inulin (CMI), and combinations thereof. Further non-limiting examples of builders include aminocarboxylates, aminopolycarboxylates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycine-N,N-diacetic acid (MGDA), glutamic acid-N,N-diacetic acid (GLDA), 1-hydroxyethane-1,1-diphosphonic acid, N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(sulfomethyl)aspartic acid (SMAS), N-(2-sulfoethyl)-aspartic acid (SEAS), N-(sulfomethylglutamic acid (SMGL), N-(2-sulfoethyl)-glutamic acid (SEGL), N-methyliminodiacetic acid (MIDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and N′-(2-hydroxyethyl)ethylenediamine-N,N,N′-triacetic acid (HEDTA), diethanolglycine (DEG), and combinations and salts thereof. Phosphonates suitable for use herein include 1-hydroxyethane-1,1-diphosphonic acid (HEDP), ethylenediaminetetrakis (methylenephosphonic acid) (EDTMPA), diethylenetriaminepentakis (methylenephosphonic acid) (DTMPA or DTPMPA or DTPMP), nitrilotris (methylenephosphonic acid) (ATMP or NTMP), 2-phosphonobutane-1,2,4-tricarboxylic acid (PBTC), hexamethylenediaminetetrakis (methylenephosphonic acid) (HDTMP). Non-limiting examples are HEDP and DTPMP.

Suitable silicates are crystalline, layered sodium silicates of the general formula NaMSiₓO₂₊₁*yH₂O, wherein M is sodium or H, x a number of from 1.9 to 4 and y a number of from 0 to 20 and x is 2, 3 or 4. Such silicates are for example disclosed in EP-A-0 164 514. Preferred are silicates in which M is sodium and is 2 or 3. Non-limiting examples are β- and δ-sodium disilicate Na₂Si₂O₅*yH₂O.

The compositions may also comprise phosphates, diphosphates (pyrophosphates) and/or triphosphates such as sodium triphosphate (STP or STPP). In a non-limiting embodiment, all compositions disclosed herein are phosphate-free, i.e. do not contain deliberately added phosphate, in particular the phosphate content is below 1 wt %, such as less than 0.5 wt %, or less than 0.1 wt %, relative to the total weight of the composition. In alternative embodiments, the composition also relates to phosphate-free cleaning compositions in general that contain the polypeptides. In one aspect, the composition thus features a phosphate-free cleaning composition comprising any one or more of the polypeptides having hexosaminidase activity disclosed herein.

If not indicated otherwise, the composition may also contain 0-50% by weight, such as about 5% to about 30%, of a detergent co-builder. The composition may include a co-builder alone, or in combination with a builder, for example a zeolite builder. Non-limiting examples of co-builders include homopolymers of polyacrylates or copolymers thereof, such as poly (acrylic acid) (PAA) or copoly (acrylic acid/maleic acid) (PAA/PMA) or polyaspartic acid. Further exemplary builders and/or co-builders are described in, e.g., WO 09/102854, U.S. Pat. No. 5,977,053.

Non-limiting co-builders are acrylate-containing water-soluble polymers, such as alkali metal salts of polyacrylic acid or polymethacrylic acid, for example those having a molecular weight M_{w} in the range of 600 to 750,000 g/mol, as determined by gel permeation chromatography (GPC) according to DIN 55672-1:2007-08 with THF as an eluent.

Non-limiting polymers are polyacrylates with a molecular weight M_{w} of 1,000 to 15,000 g/mol, alternatively, due to their solubility, are short-chain polyacrylates with a molecular weight M_{w} of 1,000 to 10,000 g/mol, such as from 1,000 to 5,000 g/mol.

Non-limiting acrylates for use in the present composition are alkali metal salts of polymers of acrylic acid, such as the sodium salts, in particular those with molecular weights in the range of 1,000 to 10,000 g/mol or 1,000 to 5,000 g/mol. Suitable acrylates are commercially available, for example under the tradename Acusol® from Dow Chemical. Suitable are also copolymers of acrylates, in particular those of acrylic acid and methacrylic acid, and acrylic acid or methacrylic acid and maleic acid.

In embodiments, the compositions comprise a sulfopolymer, such as a copolymer comprising an ethylenically unsaturated sulfonate/sulfonic acid as a co-monomer. Particularly suitable are monomers of allyl sulfonic acids, such as allyloxybenzene sulfonic acid and methallyl sulfonic acid. Non-limiting sulfonic acid group-containing monomers are 1-aciylamido propane sulfonic acid-1, 2-acrylarnido-2-propanesulfonic acid. 2-acrylamido-2-methy-1-propanesulfonic acid, 2-methacqylamido-2-methy-1I-propanesulfonic acid, 3-methacrylamido-2-hydroxy-propanesulfonic acid, allylsulfonic acid, methallylsulfonic acid, allyloxybenzenesulfonic acid, methallyloxybenzolsulfonsiure, 2-hydroxy-3-(2-propenyloxy) propanesulfonic acid, 2-methyl-2-propenl-sulfonic acid, styrenesulfonic acid, vinylsulfonlic acid. 3-sulfopropyl, 3-sulfo-propyl, sulfomethacrylamnide, sulfonethylmethacrylamide and mixtures of said acids or their water-soluble salts.

The sulfopolymers are copolymers of the afore-described monomers with unsaturated carboxylic acids. Non-limiting unsaturated carboxylic acids are acrylic acid, methacrylic acid, ethacrylic acid, chloroaciylic acid, alpha-cyanoaciylic acid, crotonic acid, alpha-phenyl-acrylic acid, maleic acid, maleic anhydride, fulmaric acid, itaconic acid, citraconic acid, nmethylenemalonic acid, sorbic acid, cinnamic acid or mixtures thereof. Usable are of course also the unsaturated dicarboxylic acids. Non-limiting examples are copolymers with acrylates, in particular with acrylic acid and methacrylic acid, and acrylic acid or methacrylic acid and maleic acid.

Such polymers are, for example, commercially available under the trade names Acusol® 590 or Acusol® 588 from Dow Chemical.

In one aspect, the cleaning compositions comprise a polypeptide as defined herein and at least one sulfopolymer, as defined above. Such compositions are dishwashing compositions.

In one embodiment, the builder is a non-phosphorus based builder such as citric acid and/or methylglycine-N,N-diacetic acid (MGDA) and/or glutamic-N,N-diacetic acid (GLDA) and/or salts thereof.

Another subclade which could be defined within the DspB clade is comprising the polypeptides with SEQ ID NOS 17, 22 and 23 or polypeptides having at least 60% sequence identity hereto, which are on the same branch and may be defined as a subgroup of the DspB clade share the some similar specific properties, more precisely the polypeptides comprised on this subgroup all have deep cleaning effect in detergent with high amount of nonionic surfactants and are particular useful e.g. in detergents with nonionic surfactants. Thus, some aspects relate to cleaning compositions, as defined herein, comprising a polypeptide selected from the subclade consisting of SEQ ID NOS 17, 22 and 23 or polypeptides having at least 80% sequence identity hereto, wherein the polypeptide has hexosaminidase activity in a cleaning process. Non-limiting examples of nonionic surfactants and builders that may be used in such compositions are those described above in relation to the compositions comprising polypeptides with the amino acid sequences of SEQ ID Nos. 19, 20 and 21.

The present composition relates to detergent compositions comprising the polypeptides, and the use thereof for deep cleaning of an item an item such as a textile.

Accordingly, some aspects relate to detergent compositions, as defined herein, comprisingat least 0.0001 ppm e.g. 0.01 ppm of active enzyme polypeptide, wherein the enzyme polypeptide is selected from the group consisting of SEQ ID NO 17, SEQ ID NO 18, SEQ ID NO 19, SEQ ID NO 20, SEQ ID NO 21, SEQ ID NO 22, SEQ ID NO 23 or SEQ ID NO 24 or polypeptides having at least 60%, such as at least 70%, such as at least 80% or such as at least 90% sequence identity hereto, wherein the polypeptide has hexosaminidase activity.
The detergent composition disclosed herein, if not indicated otherwise, may contain 0-30% by weight, such as about 1% to about 20%, such as about 1-40 wt %, such as from about 0.5-30 wt % of a bleaching system. Any bleaching system comprising components known in the art for use in cleaning detergents may be utilized. Suitable bleaching system components include sources of hydrogen peroxide; sources of peracids; and bleach catalysts or boosters.

Suitable sources of hydrogen peroxide are inorganic persalts, including alkali metal salts such as sodium percarbonate and sodium perborates (usually mono- or tetrahydrate), and hydrogen peroxide-urea (1/1).

Peracids may be (a) incorporated directly as preformed peracids or (b) formed in situ in the wash liquor from hydrogen peroxide and a bleach activator (perhydrolysis) or (c) formed in situ in the wash liquor from hydrogen peroxide and a perhydrolase and a suitable substrate for the latter, e.g., an ester, a) Suitable preformed peracids include, but are not limited to, peroxycarboxylic acids such as peroxybenzoic acid and its ring-substituted derivatives, peroxy-α-naphthoic acid, peroxyphthalic acid, peroxylauric acid, peroxystearic acid, ε-phthalimidoperoxycaproic acid [phthalimidoperoxyhexanoic acid (PAP)], and o-carboxybenzamidoperoxycaproic acid; aliphatic and aromatic diperoxydicarboxylic acids such as diperoxydodecanedioic acid, diperoxyazelaic acid, diperoxysebacic acid, diperoxybrassylic acid, 2-decyldiperoxybutanedioic acid, and diperoxyphthalic, -isophthalic and -terephthalic acids; perimidic acids; peroxymonosulfuric acid; peroxydisulfuric acid; peroxyphosphoric acid; peroxysilicic acid; and mixtures of said compounds. It is understood that the peracids mentioned may in some cases be best added as suitable salts, such as alkali metal salts (e.g., Oxone®) or alkaline earth-metal salts, b) Suitable bleach activators include those belonging to the class of esters, amides, imides, nitriles or anhydrides and, where applicable, salts thereof. Suitable examples are tetraacetylethylenediamine (TAED), sodium 4-[(3,5,5-trimethylhexanoyl) oxy]benzene-1-sulfonate (ISONOBS), sodium 4-(dodecanoyloxy) benzene-1-sulfonate (LOBS), sodium 4-(decanoyloxy) benzene-1-sulfonate, 4-(decanoyloxy) benzoic acid (DOBA), sodium 4-(nonanoyloxy) benzene-1-sulfonate (NOBS), and/or those disclosed in WO98/17767. A particular family of bleach activators of interest was disclosed in EP624154 and useful in that family is acetyl triethyl citrate (ATC). ATC or a short chain triglyceride like triacetin has the advantage that they are environmentally friendly. Furthermore, acetyl triethyl citrate and triacetin have good hydrolytically stability in the product upon storage and are efficient bleach activators. Finally, ATC is multifunctional, as the citrate released in the perhydrolysis reaction may function as a builder.

The bleaching system may also include a bleach catalyst or booster. Some non-limiting examples of bleach catalysts that may be used in the compositions include manganese oxalate, manganese acetate, manganese-collagen, cobalt-amine catalysts and manganese triazacyclononane (MnTACN) catalysts; non-limiting examples are complexes of manganese with 1,4,7-trimethyl-1,4,7-triazacyclononane (Me3-TACN) or 1,2,4,7-tetramethyl-1,4,7-triazacyclononane (Me4-TACN), in particular Me3-TACN, such as the dinuclear manganese complex [(Me3-TACN)Mn(O)3Mn(Me3-TACN)](PF6)2, and [2,2′,2″-nitrilotris(ethane-1,2-diylazanylylidene-KN-methanylylidene)triphenolato-κ3O]manganese(III). The bleach catalysts may also be other metal compounds, such as iron or cobalt complexes. In some embodiments, where a source of a peracid is included, an organic bleach catalyst or bleach booster may be used having one of the following formulae:

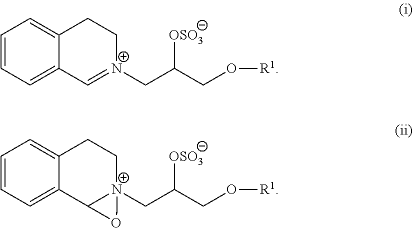

(iii) and mixtures thereof; wherein each R1 is independently a branched alkyl group containing from 9 to 24 carbons or linear alkyl group containing from 11 to 24 carbons, such as each R1 is independently a branched alkyl group containing from 9 to 18 carbons or linear alkyl group containing from 11 to 18 carbons, or each R1 is independently selected from the group consisting of 2-propylheptyl, 2-butyloctyl, 2-pentylnonyl, 2-hexyldecyl, dodecyl, tetradecyl, hexadecyl, octadecyl, isononyl, isodecyl, isotridecyl and isopentadecyl.

Other exemplary bleaching systems are described, e.g. in WO2007/087258, WO2007/087244, WO2007/087259, EP1867708 (Vitamin K) and WO2007/087242. Suitable photobleaches may for example be sulfonated zinc or aluminium phthalocyanines.

The compositions comprising polypeptides having hexosaminidase activity may be used for deep cleaning of items such as textiles and/or fabric. In some aspects the polypeptides e.g. the polypeptides having at least at least 60%, such as at least 70%, such as at least 80% or such as at least 90% sequence identity the mature polypeptides of SEQ ID NO 2, SEQ ID NO 4, SEQ ID NO 6, SEQ ID NO 8, SEQ ID NO 10, SEQ ID NO 12, SEQ ID NO 14 and SEQ ID NO 16 or to the mature polypeptide with SEQ ID NO 17, SEQ ID NO 18, SEQ ID NO 19, SEQ ID NO 20, SEQ ID NO 21, SEQ ID NO 22, SEQ ID NO 23 and SEQ ID NO 24 have f-N-acetylglucosamininidase activity and in some aspects the hexosaminidase activity is f-N-acetylglucosamininidase activity and the polypeptide are f-N-acetylglucosamininidases. Organic matter such as biofilm EPS can develop on textile when microorganisms are present on an item and stick together on the item. The organic matter may adhere soil due to the sticky nature of the organic matter.

One aspect relates to a method for cleaning, in particular laundering, an item, comprising the steps of: a) exposing an item to a wash liquor comprising a detergent composition; b) optionally completing at least one wash cycle; and c) optionally rinsing the item, wherein the item is a textile or a hard surface, such as a textile.

In a non-limiting embodiment, the polypeptide used in the compositions has at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the polypeptide shown in SEQ ID NO 17, SEQ ID NO 18, SEQ ID NO 19, SEQ ID NO 20, SEQ ID NO 21, SEQ ID NO 22, SEQ ID NO 23 or SEQ ID NO 24

In one aspect the compositions are used for preventing, reducing or removing the stickiness of an item. The polypeptide of the DspB clade having hexosaminidase activity can further be used for pre-treating stains on textiles.

Additionally, the composition concerns preventing, reducing or removing re-deposition of soil during a wash cycle. When the polypeptide described herein is used for example in the laundering of textile, the polypeptide hinders deposition of soil present in the wash liquor to deposit on the textile.

Further, the composition concerns preventing, reducing or removing the adherence of soil to an item. In one embodiment, the item is textile. When the soil does not adhere to the item, the item appears cleaner. Thus, the composition further concerns maintaining or improving the whiteness of the item.

When items like T-shirts or sportswear are used, they are exposed to bacteria from the body of the user and from the rest of the environment in which they are used. This may cause malodor on the item even after the item is washed. The present composition therefore also concerns removal or reduction of malodor on textile. The malodor may be caused by bacteria producing compounds with an unpleasant smell. One example of such unpleasant smelling compounds is E-2-nonenal. The malodor can be present on newly washed textile which is still wet. Or the malodor can be present on newly washed textile, which has subsequently been dried. The malodor may also be present on textile, which has been stored for some time after wash. The present composition relates to reduction or removal of malodor such as E-2-nonenal from wet or dry textile. One aspect relates to a method for cleaning/laundering an item comprising the steps of:
a. Exposing an item to a wash liquor comprising a a detergent composition;
b. Optionally completing at least one wash cycle; and
c. Optionally rinsing the item, wherein the item is a textile or hard surface, such as a textile.
   The compositions may comprise further components, such as detergent adjuncts; the detergent adjunct ingredient may be surfactants and builders and/or chelators such as those described above. The adjunct ingredients may also be any of the following flocculating aid, dye transfer inhibitors, enzymes, enzyme stabilizers, enzyme inhibitors, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, builders and co-builders, fabric hueing agents, anti-foaming agents, dispersants, processing aids, bittering agents, and/or pigments.

In various embodiments, the composition relates to cleaning compositions which comprise the polypeptides having hexosaminidase activity, as described herein, and any one or more of an adjunct ingredient selected from bittering agents and organic solvents, such as glycerol and 1,2-propane diol.

In one embodiment, the detergent adjunct ingredient is a builder or a clay soil removal/anti-redeposition agent.

In one embodiment, detergent adjunct ingredient is an enzyme. The one or more enzymes may be selected from the group consisting of proteases, lipases, cutinases, amylases, carbohydrases, cellulases, pectinases, mannanases, arabinases, galactanases, xylanases and oxidases.

In addition to the polypeptides having hexosaminidase activity comprising the polypeptide with SEQ ID NO 17, SEQ ID NO 18, SEQ ID NO 19, SEQ ID NO 20, SEQ ID NO 21, SEQ ID NO 22, SEQ ID NO 23, SEQ ID NO 24 or a polypeptide having hexosaminidase activity and having at least 60% sequence identity hereto the cleaning composition may further comprise cellulases. Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and WO 89/09259.

Especially suitable cellulases are the alkaline or neutral cellulases having color care benefits. Examples of such cellulases are cellulases described in EP 0 495 257, EP 0 531 372, WO 96/11262, WO 96/29397, WO 98/08940. Other examples are cellulase polypeptides such as those described in WO 94/07998, EP 0 531 315, U.S. Pat. Nos. 5,457,046, 5,686,593, 5,763,254, WO 95/24471, WO 98/12307 and PCT/DK98/00299.

Example of cellulases exhibiting endo-beta-1,4-glucanase activity (EC 3.2.1.4) are those having described in WO02/099091.

Other examples of cellulases include the family 45 cellulases described in WO96/29397, and especially polypeptides thereof having substitution, insertion and/or deletion at one or more of the positions corresponding to the following positions in SEQ ID NO: 8 of WO 02/099091: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 95d, 95h, 95j, 97, 100, 101, 102, 103, 113, 114, 117, 119, 121, 133, 136, 137, 138, 139, 140a, 141, 143a, 145, 146, 147, 150e, 150j, 151, 152, 153, 154, 155, 156, 157, 158, 159, 160c, 160e, 160k, 161, 162, 164, 165, 168, 170, 171, 172, 173, 175, 176, 178, 181, 183, 184, 185, 186, 188, 191, 192, 195, 196, 200, and/or 20, such as selected among P19A, G20K, Q44K, N48E, Q119H or Q146 R.

Commercially available cellulases include Celluzyme™, Celluclean and Carezyme™ (Novozymes A/S), Clazinase™, and Puradax HA™ (Genencor International Inc.), and KAC-500(B)™ (Kao Corporation).

In addition to the polypeptides having hexosaminidase activity comprising SEQ ID NO 2, SEQ ID NO 4, SEQ ID NO 6, SEQ ID NO 8, SEQ ID NO 10, SEQ ID NO 12, SEQ ID NO 14, SEQ ID NO 16 or a polypeptide having hexosaminidase activity and having at least 60% sequence identity hereto the cleaning composition may further comprise proteases. Suitable proteases include those of bacterial, fungal, plant, viral or animal origin e.g. vegetable or microbial origin. Chemically modified or protein engineered mutants are included. It may be an alkaline protease, such as a serine protease or a metalloprotease. A serine protease may for example be of the S1 family, such as trypsin, or the S8 family such as subtilisin. A metalloproteases protease may for example be a thermolysin from e.g. family M4 or other metalloprotease such as those from M5, M7 or M8 families.

The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Other useful proteases may be those described in WO92/175177, WO01/016285, WO02/026024 and WO02/016547. Examples of trypsin-like proteases are trypsin (e.g. of porcine or bovine origin) and the Fusarium protease described in WO89/06270, WO94/25583 and WO05/040372, and the chymotrypsin proteases derived from Cellumonas described in WO05/052161 and WO05/052146.

A further protease is the alkaline protease from Bacillus lentus DSM 5483, as described for example in WO95/23221, and variants thereof which are described in WO92/21760, WO95/23221, EP1921147 and EP1921148.

Examples of metalloproteases are the neutral metalloprotease as described in WO07/044993 (Genencor Int.) such as those derived from Bacillus amyloliquefaciens.

Examples of useful proteases are the variants described in: WO92/19729, WO96/034946, WO98/20115, WO98/20116, WO99/011768, WO01/44452, WO03/006602, WO04/03186, WO04/041979, WOO07/006305, WO11/036263, WO11/036264, especially the variants with substitutions in one or more of the following positions: 3, 4, 9, 15, 24, 27, 42, 55, 59, 60, 66, 74, 85, 96, 97, 98, 99, 100, 101, 102, 104, 116, 118, 121, 126, 127, 128, 154, 156, 157, 158, 161, 164, 176, 179, 182, 185, 188, 189, 193, 198, 199, 200, 203, 206, 211, 212, 216, 218, 226, 229, 230, 239, 246, 255, 256, 268 and 269, wherein the positions correspond to the positions of the Bacillus Lentus protease shown in SEQ ID NO 1 of WO 2016/001449 The subtilase variants may comprise the mutations: S3T, V41, S9R, S9E, A15T, S24G, S24R, K27R, N42R, S55P, G59E, G59D, N60D, N60E, V66A, N74D, N85S, N85R, G96S, G96A, S97G, S97D, S97A, S97SD, S99E, S99D, S99G, S99M, S99N, S99R, S99H, S101A, V1021, V102Y, V102N, S104A, G116V, G116R, H118D, H118N, N120S, S126L, P127Q, S128A, S154D, A156E, G157D, G157P, S158E, Y161A, R164S, Q176E, N179E, S182E, Q185N, A188P, G189E, V193M, N198D, V1991, Y203W, S206G, L211Q, L211D, N212D, N212S, M216S, A226V, K229L, Q230H, Q239R, N246K, N255W, N255D, N255E, L256E, L256D T268A, R269H. The protease variants are variants of the Bacillus Lentus protease (Savinase®) shown in SEQ ID NO 1 of WO 2016/001449, the Bacillus amylolichenifaciens protease (BPN′) shown in SEQ ID NO 2 of WO2016/001449. The protease variants have at least 80% sequence identity to SEQ ID NO 1 or SEQ ID NO 2 of WO 2016/001449.

A protease variant comprising a substitution at one or more positions corresponding to positions 171, 173, 175, 179, or 180 of SEQ ID NO: 1 of WO2004/067737, wherein said protease variant has a sequence identity of at least 75% but less than 100% to SEQ ID NO: 1 of WO2004/067737.

Suitable commercially available protease enzymes include those sold under the trade names Alcalase®, Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Blaze®, Blaze Evity® 100T, Blaze Evity® 125T, Blaze Evity® 150T, Neutrase®, Everlase® and Esperase® (Novozymes A/S), those sold under the tradename Maxatase®, Maxacal®, Maxapem®, Purafect Ox®, Purafect OxP®, Puramax®, FN2®, FN3®, FN4®, Excellase®, Excellenz P1000™, Excellenz P1250™, Eraser®, Preferenz P100™, Purafect Prime®, Preferenz P110™, Effectenz P1000^{T}, Purafect®™, Effectenz P1050™, Purafect Ox®™, Effectenz P2000™, Purafast®, Properase®, Opticlean® and Optimase® (Danisco/DuPont), Axapem™ (Gist-Brocases N.V.), BLAP (sequence shown in FIG. 29 of U.S. Pat. No. 5,352,604) and variants hereof (Henkel AG) and KAP (Bacillus alkalophilus subtilisin) from Kao.

In addition to the polypeptides having hexosaminidase activity comprising the mature polypeptide of SEQ ID NO 17, SEQ ID NO 18, SEQ ID NO 19, SEQ ID NO 20, SEQ ID NO 21, SEQ ID NO 22, SEQ ID NO 23, SEQ ID NO 24 or a polypeptide having hexosaminidase activity and having at least 60% sequence identity hereto the cleaning composition may further comprise lipases and cutinases which include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase polypeptides such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Non-limiting commercial lipase products include Lipolase™, Lipex™; Lipolex™ and Lipoclean™ (Novozymes A/S), Lumafast (originally from Genencor) and Lipomax (originally from Gist-Brocades).

Still other examples are lipases sometimes referred to as acyltransferases or perhydrolases, e.g. acyltransferases with homology to Candida antarctica lipase A (WO10/111143), acyltransferase from Mycobacterium smegmatis (WOO05/56782), perhydrolases from the CE 7 family (WOO09/67279), and polypeptides of the M. smegmatis perhydrolase in particular the S54V variant used in the commercial product Gentle Power Bleach from Huntsman Textile Effects Pte Ltd (WO10/100028).

In addition to the polypeptides having hexosaminidase activity comprising SEQ ID NO 17, SEQ ID NO 18, SEQ ID NO 19, SEQ ID NO 20, SEQ ID NO 21, SEQ ID NO 22, SEQ ID NO 23, SEQ ID NO 24 or a polypeptide having hexosaminidase activity and having at least 60% sequence identity hereto the cleaning composition may further comprise amylases which can be used together with a polypeptide. The amylase may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 3 in WO 95/10603 or polypeptides having 90% sequence identity to SEQ ID NO: 3 thereof. Non-limiting polypeptides are described in WO 94/02597, WO 94/18314, WO 97/43424 and SEQ ID NO: 4 of WO 99/019467, such as polypeptides with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or polypeptides thereof having 90% sequence identity to SEQ ID NO: 6. Non-limiting polypeptides of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or polypeptides having 90% sequence identity thereof. Non-limiting polypeptides of this hybrid alpha-amylase are those having a substitution, a deletion or an insertion in one of more of the following positions: G48, T49, G107, H156, A181, N190, M197, 1201, A209 and Q264. Non-limiting polypeptides of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:

M197T;

H156Y+A181T+N190F+A209V+Q264S; or

G48A+T49I+G107A+H156Y+A18 1T+N190F+I20 1F+A209V+Q264S.

Further amylases which are suitable are amylases having SEQ ID NO: 6 in WO 99/019467 or polypeptides thereof having 90% sequence identity to SEQ ID NO: 6. Non-limiting polypeptides of SEQ ID NO: 6 are those having a substitution, a deletion or an insertion in one or more of the following positions: R181, G182, H183, G184, N195, 1206, E212, E216 and K269. Non-limiting amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO 96/023873 or polypeptides thereof having 90% sequence identity to SEQ ID NO: 1, SEQ ID NO: 2, SEQ ID NO: 3 or SEQ ID NO: 7. Non-limiting polypeptides of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476. Non-limiting polypeptides are those having a deletion in positions 181 and 182 or positions 183 and 184. Non-limiting amylase polypeptides of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO 08/153815, SEQ ID NO: 10 in WO 01/66712 or polypeptides thereof having 90% sequence identity to SEQ ID NO: 2 of WO 08/153815 or 90% sequence identity to SEQ ID NO: 10 in WO 01/66712. Non-limiting polypeptides of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 09/061380 or polypeptides having 90% sequence identity to SEQ ID NO: 2 thereof. Non-limiting polypeptides of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475, non-limiting polypeptides of SEQ ID NO: 2 are those having the substitution in one of more of the following positions: Q87E,R, Q98R, S125A, N128C, T13 1I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Non-limiting amylase polypeptides of SEQ ID NO: 2 are those having the substitutions:

N128C+K178L+T182G+Y305R+G475K;

N128C+K178L+T182G+F202Y+Y305R+D319T+G475K;

S125A+N128C+K178L+T182G+Y305R+G475K; or

S125A+N128C+T131I+T165I+K178L+T182G+Y305R+G475K wherein the polypeptides are C-terminally truncated and optionally further comprises a substitution at position 243 and/or a deletion at position 180 and/or position 181.

Other suitable amylases are the alpha-amylase having SEQ ID NO: 12 in WO01/66712 or a variant having at least 90% sequence identity to SEQ ID NO: 12. Non-limiting amylase polypeptides are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Non-limiting amylases include polypeptides having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, such as a variant that additionally has substitutions in all these positions.

Other examples are amylase polypeptides such as those described in WO2011/098531, WO2013/001078 and WO2013/001087.
Commercially available amylases are Duramyl™, Termamyl™, Fungamyl™, Stainzyme™, Stainzyme Plus™, Natalase™, Liquozyme X and BAN™ (from Novozymes A/S), and Rapidase™, Purastar™/Effectenz™, Powerase and Preferenz S100 (from Genencor International Inc./DuPont).

In addition to the polypeptides having hexosaminidase activity comprising SEQ ID NO 2, SEQ ID NO 4, SEQ ID NO 6, SEQ ID NO 8, SEQ ID NO 10, SEQ ID NO 12, SEQ ID NO 14, SEQ ID NO 16 or a polypeptide having hexosaminidase activity and having at least 60% sequence identity hereto the cleaning composition may further comprise peroxidases/oxidases including those of plant, bacterial or fungal origin. Chemically modified or protein engineered mutants are included. Examples of useful peroxidases include peroxidases from Coprinus, e.g., from C. cinereus, and polypeptides thereof as those described in WO 93/24618, WO 95/10602, and WO 98/15257.

Commercially available peroxidases include Guardzyme™ (Novozymes A/S).

The detergent enzyme(s) may be included in a detergent composition by adding separate additives containing one or more enzymes, or by adding a combined additive comprising these enzymes. A detergent additive, i.e., a separate additive or a combined additive, can be formulated, for example, as a granulate, liquid, slurry, etc. Non-limiting detergent additive formulations are granulates, in particular non-dusting granulates, liquids, in particular stabilized liquids, or slurries.

Non-dusting granulates may be produced, e.g., as disclosed in U.S. Pat. Nos. 4,106,991 and 4,661,452 and may optionally be coated by methods known in the art. Examples of waxy coating materials are poly (ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

The cleaning compositions may, if not indicated otherwise, also contain 0-10% by weight, such as 0.5-5%, 2-5%, 0.5-2% or 0.2-1% of a polymer. Any polymer known in the art for use in detergents may be utilized.

The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), (carboxymethyl)inulin (CMI), and polycarboxylates such as PAA, PAA/PMA, polyaspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

The detergent compositions may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light. Fluorescent whitening agents emit at least some visible light if subjected to ultraviolet light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO2005/03274, WO2005/03275, WO2005/03276 and EP1876226 (hereby incorporated by reference). The detergent composition comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be useful when the composition is in the form of a unit dose pouch. Suitable hueing agents are also disclosed in, e.g. WO 2007/087257 and WO2007/087243.

The detergent may contain 0-10% by weight, for example 0-5% by weight, such as about 0.5 to about 5%, or about 3% to about 5%, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

The detergent compositions can also contain dispersants. In particular, powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

The detergent compositions may also include one or more dye transfer inhibiting agents. Suitable polymeric dye transfer inhibiting agents include, but are not limited to, polyvinylpyrrolidone polymers, polyamine-N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

The detergent compositions may also contain additional components that may tint articles being cleaned, such as fluorescent whitening agent or optical brighteners. Where present the brightener is at a level of about 0.01% to about 0.5%. Any fluorescent whitening agent suitable for use in a laundry detergent composition may be used in the laundry composition. The most commonly used fluorescent whitening agents are those belonging to the classes of diaminostilbene-sulfonic acid derivatives, diarylpyrazoline derivatives and biphenyl-distyryl derivatives. Examples of the diaminostilbene-sulfonic acid derivative type of fluorescent whitening agents include the sodium salts of: 4,4′-bis[(4-anilino-6-diethanolamino-s-triazin-2-yl)amino]stilbene-2,2′-disulfonate, 4,4′-bis[(4,6-dianilino-s-triazin-2-yl)amino]stilbene-2,2′-disulfonate, 4,4′-bis{4-anilino-6-[methyl(2-hydroxyethyl)amino]-s-triazin-2-ylamino}stilbene-2,2′-disulfonate, 4,4′-bis(4-phenyl-1,2,3-triazol-2-yl)stilbene-2,2′-disulfonate and sodium 5-(2H-naphtho[1,2-d][1,2,3]triazol-2-yl)-2-[(E)-2-phenylvinyl]benzenesulfonate. Non-limiting fluorescent whitening agents are Tinopal DMS and Tinopal CBS available from BASF. Tinopal DMS is the disodium salt of 4,4′-bis[(4-anilino-6-morpholino-s-triazin-2-yl) amino]stilbene-2,2′-disulfonate. Tinopal CBS is the disodium salt of 2,2′-[biphenyl-4,4′-di(2,1-ethenediyl)]dibenzene-1-sulfonate. Also useful is the commercially available Parawhite KX, supplied by Paramount Minerals and Chemicals, Mumbai, India. Other fluorescers suitable for use include the 1-3-diarylpyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

The detergent compositions may also include one or more soil-release polymers which aid the removal of soils from fabrics such as cotton and polyester-based fabrics, in particular the removal of hydrophobic soils from polyester-based fabrics. The soil release polymers may for example be nonionic or anionic terephthalate-based polymers, polyvinylcaprolactam and related copolymers, vinyl graft copolymers or polyester polyamides; see for example Chapter 7 in Powdered Detergents, Surfactant science series volume 71, Marcel Dekker, Inc. Another type of soil release polymers is amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore, random graft co-polymers are suitable soil-release polymers. Suitable graft co-polymers are described in more detail in WO 2007/138054, WO 2006/108856 and WO 2006/113314 (hereby incorporated by reference). Other soil-release polymers are substituted polysaccharide structures especially substituted cellulosic structures such as modified cellulose derivatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof.

The detergent compositions may also include one or more anti-redeposition agents such as (carboxymethyl) cellulose (CMC), poly (vinyl alcohol) (PVA), homopolymers of acrylic acid, copolymers of acrylic acid and maleic acid, and ethoxylated polyethyleneimines. The cellulose based polymers described under soil-release polymers above may also function as anti-redeposition agents.

The cleaning composition may also contain one are more adjunct material. Suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sud suppressors, solvents, and structurants for liquid detergents and/or structure elasticizing agents.

The cleaning composition may be in any convenient form, e.g., abar, a homogenous tablet, a tablet having two or more layers, a pouch having one or more compartments, such as 2 or more compartments, such as 2, 3, 4 or 5 compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Non-limiting films are polymeric materials polymers which are formed into a film or sheet. Non-limiting polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, or polyvinyl alcohol copolymers and, hydroxypropyl methyl cellulose (HPMC). In a non-limiting embodiment, the level of polymer in the film for example PVA is at least about 60%. Non-limiting average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent.

Methods for using the compositions are disclosed herein in laundering of textile and fabrics, such as house hold laundry washing and industrial laundry washing.

Methods for using the compositions are disclosed herein in cleaning hard surfaces such as floors, tables, walls, roofs etc. as well as surfaces of hard objects such as cars (car wash) and dishes (dish wash).

The cleaning process or the textile care process may for example be a laundry process, a dishwashing process or cleaning of hard surfaces such as bathroom tiles, floors, table tops, drains, sinks and washbasins. Laundry processes can for example be household laundering, but it may also be industrial laundering. Furthermore, a process for laundering of fabrics and/or garments where the process comprises treating fabrics with a washing solution containing a detergent composition is also disclosed. The cleaning process or a textile care process can for example be carried out in a machine washing process or in a manual washing process. The washing solution can for example be an aqueous washing solution containing a detergent composition.

The polypeptides comprised in the DspB clade are thus particularly useful in composition comprising surfactants such as detergent compositions and the polypeptides may be used in cleaning processes such as laundry and dish wash.

In some aspects, the present may include polypeptides of the clade of DspB having a sequence identity to the mature polypeptide of SEQ ID NO: 2 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%, which have hexosaminidase activity. In one aspect, the polypeptides differ by up to 10 amino acids, e.g., 1, 2, 3, 4, 5, 6, 7, 8, 9, or 10, from the mature polypeptide of SEQ ID NO: 17.

In some aspects, the present may include polypeptides of the clade of DspB having a sequence identity to the mature polypeptide of SEQ ID NO: 4 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%, which have hexosaminidase activity. In one aspect, the polypeptides differ by up to 10 amino acids, e.g., 1, 2, 3, 4, 5, 6, 7, 8, 9, or 10, from the mature polypeptide of SEQ ID NO: 18.

In some aspects, the present may include polypeptides of the clade of DspB having a sequence identity to the mature polypeptide of SEQ ID NO: 6 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%, which have hexosaminidase activity. In one aspect, the polypeptides differby up to 10 amino acids, e.g., 1, 2, 3, 4, 5, 6, 7, 8, 9, or 10, from the mature polypeptide of SEQ ID NO: 19.

In some aspects, the present may include polypeptides of the clade of DspB having a sequence identity to the mature polypeptide of SEQ ID NO: 8 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%, which have hexosaminidase activity. In one aspect, the polypeptides differ by up to 10 amino acids, e.g., 1, 2, 3, 4, 5, 6, 7, 8, 9, or 10, from the mature polypeptide of SEQ ID NO: 20.

In some aspects, the present may include polypeptides of the clade of DspB having a sequence identity to the mature polypeptide of SEQ ID NO: 10 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%, which have hexosaminidase activity. In one aspect, the polypeptides differ by up to 10 amino acids, e.g., 1, 2, 3, 4, 5, 6, 7, 8, 9, or 10, from the mature polypeptide of SEQ ID NO: 21.

In some aspects, the present may include polypeptides of the clade of DspB having a sequence identity to the mature polypeptide of SEQ ID NO: 12 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%, which have hexosaminidase activity. In one aspect, the polypeptides differ by up to 10 amino acids, e.g., 1, 2, 3, 4, 5, 6, 7, 8, 9, or 10, from the mature polypeptide of SEQ ID NO: 22.

In some aspects, the present may include polypeptides of the clade of DspB having a sequence identity to the mature polypeptide of SEQ ID NO: 14 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%, which have hexosaminidase activity. In one aspect, the polypeptides differ by up to 10 amino acids, e.g., 1, 2, 3, 4, 5, 6, 7, 8, 9, or 10, from the mature polypeptide of SEQ ID NO: 23.

In some aspects, the present may include polypeptides of the clade of DspB having a sequence identity to the mature polypeptide of SEQ ID NO: 16 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%, which have hexosaminidase activity. In one aspect, the polypeptides differ by up to 10 amino acids, e.g., 1, 2, 3, 4, 5, 6, 7, 8, 9, or 10, from the mature polypeptide of SEQ ID NO: 24.

In an embodiment, the polypeptide has been isolated. A polypeptide as used comprises or consists of the amino acid sequence of SEQ ID NO: 2 or an allelic variant thereof; or is a fragment thereof having hexosaminidase activity. In another aspect, the polypeptide comprises or consists of the mature polypeptide of SEQ ID NO: 2. In another aspect, the polypeptide comprises or consists of amino acids 1 to 359 of SEQ ID NO: 2.

In an embodiment, the polypeptide has been isolated. A polypeptide as used comprises or consists of the amino acid sequence of SEQ ID NO: 4 or an allelic variant thereof; or is a fragment thereof having hexosaminidase activity. In another aspect, the polypeptide comprises or consists of the mature polypeptide of SEQ ID NO: 4. In another aspect, the polypeptide comprises or consists of amino acids 1 to 346 of SEQ ID NO: 4.

In an embodiment, the polypeptide has been isolated. A polypeptide as used comprises or consists of the amino acid sequence of SEQ ID NO: 6 or an allelic variant thereof; or is a fragment thereof having hexosaminidase activity. In another aspect, the polypeptide comprises or consists of the mature polypeptide of SEQ ID NO: 6. In another aspect, the polypeptide comprises or consists of amino acids 1 to 352 of SEQ ID NO: 6.

In an embodiment, the polypeptide has been isolated. A polypeptide as used comprises or consists of the amino acid sequence of SEQ ID NO: 8 or an allelic variant thereof; or is a fragment thereof having hexosaminidase activity. In another aspect, the polypeptide comprises or consists of the mature polypeptide of SEQ ID NO: 8. In another aspect, the polypeptide comprises or consists of amino acids 1 to 352 of SEQ ID NO: 8.

In an embodiment, the polypeptide has been isolated. A polypeptide as used comprises or consists of the amino acid sequence of SEQ ID NO: 10 or an allelic variant thereof; or is a fragment thereof having hexosaminidase activity. In another aspect, the polypeptide comprises or consists of the mature polypeptide of SEQ ID NO: 10. In another aspect, the polypeptide comprises or consists of amino acids 1 to 352 of SEQ ID NO: 10.

In an embodiment, the polypeptide has been isolated. A polypeptide as used comprises or consists of the amino acid sequence of SEQ ID NO: 12 or an allelic variant thereof; or is a fragment thereof having hexosaminidase activity. In another aspect, the polypeptide comprises or consists of the mature polypeptide of SEQ ID NO: 12. In another aspect, the polypeptide comprises or consists of amino acids 1 to 359 of SEQ ID NO: 12.

In an embodiment, the polypeptide has been isolated. A polypeptide as used comprises or consists of the amino acid sequence of SEQ ID NO: 14 or an allelic variant thereof; or is a fragment thereof having hexosaminidase activity. In another aspect, the polypeptide comprises or consists of the mature polypeptide of SEQ ID NO: 14. In another aspect, the polypeptide comprises or consists of amino acids 1 to 359 of SEQ ID NO: 14.

In an embodiment, the polypeptide has been isolated. A polypeptide as used comprises or consists of the amino acid sequence of SEQ ID NO: 16 or an allelic variant thereof; or is a fragment thereof having hexosaminidase activity. In another aspect, the polypeptide comprises or consists of the mature polypeptide of SEQ ID NO: 16. In another aspect, the polypeptide comprises or consists of amino acids 1 to 351 of SEQ ID NO: 16.

In another embodiment, compositions as described herein, may include a polypeptide having hexosaminidase activity encoded by a polynucleotide that hybridizes under very low stringency conditions, low stringency conditions, medium stringency conditions, medium-high stringency conditions, high stringency conditions, or very high stringency conditions with (i) the mature polypeptide coding sequence of SEQ ID NO: 1, 3, 5, 7, 9, 11, 13 or 15 or (ii) the full-length complement of (i) (Sambrook et al., 1989, Molecular Cloning, A Laboratory Manual, 2d edition, Cold Spring Harbor, New York). In an embodiment, the polypeptide has been isolated.

The polynucleotide of SEQ ID NO: 1, 3, 5, 7, 9, 11, 13 or 15 or a subsequence thereof, as well as the mature polypeptide of SEQ ID NO: 2, 4, 6, 8, 10, 12, 14 or 16 or a fragment thereof may be used to design nucleic acid probes to identify and clone DNA encoding polypeptides having hexosaminidase activity from strains of different genera or species according to methods well known in the art. In particular, such probes can be used for hybridization with the genomic DNA or cDNA of a cell of interest, following standard Southern blotting procedures, in order to identify and isolate the corresponding gene therein. Such probes can be considerably shorter than the entire sequence, but should be at least 15, e.g., at least 25, at least 35, or at least 70 nucleotides in length. In a non-limiting embodiment, the nucleic acid probe is at least 100 nucleotides in length, e.g., at least 200 nucleotides, at least 300 nucleotides, at least 400 nucleotides, at least 500 nucleotides, at least 600 nucleotides, at least 700 nucleotides, at least 800 nucleotides, or at least 900 nucleotides in length. Both DNA and RNA probes can be used. The probes are typically labeled for detecting the corresponding gene (for example, with ³²P, ³H, ³⁵S, biotin, or avidin).

A genomic DNA or cDNA library prepared from such other strains may be screened for DNA that hybridizes with the probes described above and encodes a polypeptide having hexosaminidase activity. Genomic or other DNA from such other strains may be separated by agarose or polyacrylamide gel electrophoresis, or other separation techniques. DNA from the libraries or the separated DNA may be transferred to and immobilized on nitrocellulose or other suitable carrier material. In order to identify a clone or DNA that hybridizes with SEQ ID NO: 1 or a subsequence thereof, the carrier material is used in a Southern blot.

Hybridization indicates that the polynucleotide hybridizes to a labeled nucleic acid probe corresponding to (i) SEQ ID NO: 1, 3, 5, 7, 9, 11, 13 or 15; (ii) the mature polypeptide coding sequence of SEQ ID NO: 1, 3, 5, 7, 9, 11, 13 or 15; (iii) the full-length complement thereof; or (iv) a subsequence thereof; under very low to very high stringency conditions. Molecules to which the nucleic acid probe hybridizes under these conditions can be detected using, for example, X-ray film or any other detection means known in the art.

In another embodiment, compositions as described herein may include a polypeptide having hexosaminidase activity encoded by a polynucleotide having a sequence identity to the mature polypeptide coding sequence of SEQ ID NO: 1 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%. In a further embodiment, the polypeptide has been isolated.

In another embodiment, compositions as described herein may include a polypeptide having hexosaminidase activity encoded by a polynucleotide having a sequence identity to the mature polypeptide coding sequence of SEQ ID NO: 3 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%. In a further embodiment, the polypeptide has been isolated.

In another embodiment, compositions as described herein may include a polypeptide having hexosaminidase activity encoded by a polynucleotide having a sequence identity to the mature polypeptide coding sequence of SEQ ID NO: 5 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%. In a further embodiment, the polypeptide has been isolated.

In another embodiment, compositions as described herein may include a polypeptide having hexosaminidase activity encoded by a polynucleotide having a sequence identity to the mature polypeptide coding sequence of SEQ ID NO: 7 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%. In a further embodiment, the polypeptide has been isolated.

In another embodiment, compositions as described herein may include a polypeptide having hexosaminidase activity encoded by a polynucleotide having a sequence identity to the mature polypeptide coding sequence of SEQ ID NO: 9 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%. In a further embodiment, the polypeptide has been isolated.

In another embodiment, compositions as described herein may include a polypeptide having hexosaminidase activity encoded by a polynucleotide having a sequence identity to the mature polypeptide coding sequence of SEQ ID NO: 11 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%. In a further embodiment, the polypeptide has been isolated.

In another embodiment, compositions as described herein may include a polypeptide having hexosaminidase activity encoded by a polynucleotide having a sequence identity to the mature polypeptide coding sequence of SEQ ID NO: 13 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%. In a further embodiment, the polypeptide has been isolated.

In another embodiment, compositions as described herein may include a polypeptide having hexosaminidase activity encoded by a polynucleotide having a sequence identity to the mature polypeptide coding sequence of SEQ ID NO: 15 of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100%. In a further embodiment, the polypeptide has been isolated.

In another embodiment, compositions as described herein may include variants of the mature polypeptide of SEQ ID NO: 2, 4, 6, 8, 10, 12, 14 or 16 comprising a substitution, deletion, and/or insertion at one or more (e.g., several) positions. In an embodiment, the number of amino acid substitutions, deletions and/or insertions introduced into the mature polypeptide of SEQ ID NO: 2, 4, 6, 8, 10, 12, 14 or 16 is up to 10, e.g., 1, 2, 3, 4, 5, 6, 7, 8, 9, or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding domain.

Examples of conservative substitutions are within the groups of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. Common substitutions are Ala/Ser, Val/Ile, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/Ile, Leu/Val, Ala/Glu, and Asp/Gly.

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

Essential amino acids in a polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant molecules are tested for hexosaminidase activity to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labeling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. The identity of essential amino acids can also be inferred from an alignment with a related polypeptide. The polypeptides belong to the Dispersin B clade. The Dispersin B is a β-hexosaminidase that specifically hydrolyzes β-1,6-glycosidic linkages of acetylglucosamine polymers found in e.g. biofilm. Dispersin B contains three highly conserved acidic residues: an aspartic acid at residue 183 (D183), a glutamic acid at residue 184 (E184), and a glutamic acid at residue 332 (E332).

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage Dsplay (e.g., Lowman et al., 1991, Biochemistry 30: 10832-10837; U.S. Pat. No. 5,223,409; WO 92/06204), and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide.

The polypeptide may be a hybrid polypeptide in which a region of one polypeptide is fused at the N-terminus or the C-terminus of a region of another polypeptide.

The polypeptide may be a fusion polypeptide or cleavable fusion polypeptide in which another polypeptide is fused at the N-terminus or the C-terminus of the polypeptide. A fusion polypeptide is produced by fusing a polynucleotide encoding another polypeptide to a polynucleotide. Techniques for producing fusion polypeptides are known in the art, and include ligating the coding sequences encoding the polypeptides so that they are in frame and that expression of the fusion polypeptide is under control of the same promoter(s) and terminator. Fusion polypeptides may also be constructed using intein technology in which fusion polypeptides are created post-translationally (Cooper et al., 1993, EMBO J. 12: 2575-2583; Dawson et al., 1994, Science 266: 776-779).

A fusion polypeptide can further comprise a cleavage site between the two polypeptides. Upon secretion of the fusion protein, the site is cleaved releasing the two polypeptides. Examples of cleavage sites include, but are not limited to, the sites disclosed in Martin et al., 2003, J. Ind. Microbiol. Biotechnol. 3: 568-576; Svetina et al., 2000, J. Biotechnol. 76: 245-251; Rasmussen-Wilson et al., 1997, Appl. Environ. Microbiol. 63: 3488-3493; Ward et al., 1995, Biotechnology 13: 498-503; and Contreras et al., 1991, Biotechnology 9: 378-381; Eaton et al., 1986, Biochemistry 25: 505-512; Collins-Racie et al., 1995, Biotechnology 13: 982-987; Carter et al., 1989, Proteins: Structure, Function, and Genetics 6: 240-248; and Stevens, 2003, Drug Discovery World 4: 35-48.

### Sources of Polypeptides Having Hexosaminidase Activity

A polypeptide having hexosaminidase activity may be obtained from microorganisms of any genus. The term “obtained from” as used herein in connection with a given source shall mean that the polypeptide encoded by a polynucleotide is produced by the source or by a strain in which the polynucleotide from the source has been inserted. In one aspect, the polypeptide obtained from a given source is secreted extracellularly.

In another aspect, the polypeptide is an Aggregatibacter polypeptide, e.g., a polypeptide obtained from Aggregatibacter actinomycetemcomitans. In a non-limiting aspect, the polypeptide is a polypeptide having at least 60% sequence identity to SEQ ID NO: 17 and is obtained from Aggregatibacter such as Aggregatibacter actinomycetemcomitans.

In another aspect, the polypeptide is a Haemophilus polypeptide, e.g., a polypeptide obtained from Haemophilus sputorum. In a non-limiting aspect, the polypeptide is a polypeptide having at least 60% sequence identity to SEQ ID NO: 18 and is obtained from Haemophilus such as Haemophilus sputorum.

In another aspect, the polypeptide is an Actinobacillus polypeptide, e.g., a polypeptide obtained from Actinobacillus suis. In a preferred aspect, the polypeptide is a polypeptide having at least 60% sequence identity to SEQ ID NO: 19 and is obtained from Actinobacillus such as Actinobacillus suis.

In another aspect, the polypeptide is an Actinobacillus polypeptide, e.g., a polypeptide obtained from Actinobacillus capsulatus DSM 19761. In a non-limiting aspect, the polypeptide is a polypeptide having at least 60% sequence identity to SEQ ID NO: 20 and is obtained from Actinobacillus such as Actinobacillus capsulatus DSM 19761

In another aspect, the polypeptide is an Actinobacillus polypeptide, e.g., a polypeptide obtained from Actinobacillus equuli. In a non-limiting aspect, the polypeptide is a polypeptide having at least 60% sequence identity to SEQ ID NO: 21 and is obtained from Actinobacillus such as Actinobacillus equuli.

In another aspect, the polypeptide is an Aggregatibacter polypeptide, e.g., a polypeptide obtained from Aggregatibacter actinomycetemcomitans. In a non-limiting aspect, the polypeptide is a polypeptide having at least 60% sequence identity to SEQ ID NO: 22 and is obtained from Aggregatibacter such as Aggregatibacter actinomycetemcomitans.

In another aspect, the polypeptide is an Aggregatibacter polypeptide, e.g., a polypeptide obtained from Aggregatibacter actinomycetemcomitans. In a non-limiting aspect, the polypeptide is a polypeptide having at least 60% sequence identity to SEQ ID NO: 23 and is obtained from Aggregatibacter such as Aggregatibacter actinomycetemcomitans.

In another aspect, the polypeptide is an Actinobacillus polypeptide, e.g., a polypeptide obtained from Actinobacillus pleuropneumoniae. In a non-limiting aspect, the polypeptide is a polypeptide having at least 60% sequence identity to SEQ ID NO: 24 and is obtained from Actinobacillus such as Actinobacillus pleuropneumoniae.

It will be understood that for the aforementioned species, both the perfect and imperfect states are possible, and other taxonomic equivalents, e.g., anamorphs, regardless of the species name by which they are known. Those skilled in the art will readily recognize the identity of appropriate equivalents.

Strains of these species are readily accessible to the public in a number of culture collections, such as the American Type Culture Collection (ATCC), Deutsche Sammlung von Mikroorganismen und Zellkulturen GmbH (DSMZ), Centraalbureau Voor Schimmelcultures (CBS), and Agricultural Research Service Patent Culture Collection, Northern Regional Research Center (NRRL). The polypeptide may be identified and obtained from other sources including microorganisms isolated from nature (e.g., soil, composts, water, etc.) or DNA samples obtained directly from natural materials (e.g., soil, composts, water, etc.) using the above-mentioned probes. Techniques for isolating microorganisms and DNA directly from natural habitats are well known in the art. A polynucleotide encoding the polypeptide may then be obtained by similarly screening a genomic DNA or cDNA library of another microorganism or mixed DNA sample. Once a polynucleotide encoding a polypeptide has been detected with the probe(s), the polynucleotide can be isolated or cloned by utilizing techniques that are known to those of ordinary skill in the art (see, e.g., Sambrook et al., 1989, supra).

### Nucleic Acid Constructs

The present disclosure also relates to nucleic acid constructs comprising a polynucleotide operably linked to one or more control sequences that direct the expression of the coding sequence in a suitable host cell under conditions compatible with the control sequences.

The polynucleotide may be manipulated in a variety of ways to provide for expression of the polypeptide. Manipulation of the polynucleotide prior to its insertion into a vector may be desirable or necessary depending on the expression vector. The techniques for modifying polynucleotides utilizing recombinant DNA methods are well known in the art.

The control sequence may be a promoter, a polynucleotide that is recognized by a host cell for expression of a polynucleotide encoding a polypeptide. The promoter contains transcriptional control sequences that mediate the expression of the polypeptide. The promoter may be any polynucleotide that shows transcriptional activity in the host cell including variant, truncated, and hybrid promoters, and may be obtained from genes encoding extracellular or intracellular polypeptides either homologous or heterologous to the host cell. Examples of suitable promoters for directing transcription of the nucleic acid constructs in a bacterial host cell are the promoters obtained from the Bacillus amyloliquefaciens alpha-amylase gene (amyQ), Bacillus licheniformis alpha-amylase gene (amyL), Bacillus licheniformis penicillinase gene (penP), Bacillus stearothermophilus maltogenic amylase gene (amyM), Bacillus subtilis levansucrase gene (sacB), Bacillus subtilis xylA and xylB genes, Bacillus thuringiensis cryllA gene (Agaisse and Lereclus, 1994, Molecular Microbiology 13: 97-107), E. coli lac operon, E. coli trc promoter (Egon et al., 1988, Gene 69: 301-315), Streptomyces coelicolor agarase gene (dagA), and prokaryotic beta-lactamase gene (Villa-Kamaroff et al., 1978, Proc. Natl. Acad. Sci. USA 75: 3727-3731), as well as the tac promoter (DeBoer et al., 1983, Proc. Natl. Acad. Sci. USA 80: 21-25). Further promoters are described in “Useful proteins from recombinant bacteria” in Gilbert et al., 1980, Scientific American 242: 74-94; and in Sambrook et al., 1989, supra. Examples of tandem promoters are disclosed in WO 99/43835. Examples of suitable promoters for directing transcription of the nucleic acid constructs in a filamentous fungal host cell are promoters obtained from the genes for Aspergillus nidulans acetamidase, Aspergillus niger neutral alpha-amylase, Aspergillus niger acid stable alpha-amylase, Aspergillus niger or Aspergillus awamori glucoamylase (glaA), Aspergillus oryzae TAKA amylase, Aspergillus oryzae alkaline protease, Aspergillus oryzae triose phosphate isomerase, Fusarium oxysporum trypsin-like protease (WO 96/00787), Fusarium venenatum amyloglucosidase (WO 00/56900), Fusarium venenatum Daria (WO 00/56900), Fusarium venenatum Quinn (WO 00/56900), Rhizomucor miehei lipase, Rhizomucor miehei aspartic proteinase, Trichoderma reesei beta-glucosidase, Trichoderma reesei cellobiohydrolase I, Trichoderma reesei cellobiohydrolase II, Trichoderma reesei endoglucanase I, Trichoderma reesei endoglucanase II, Trichoderma reesei endoglucanase III, Trichoderma reesei endoglucanase V, Trichoderma reesei xylanase I, Trichoderma reesei xylanase II, Trichoderma reesei xylanase III, Trichoderma reesei beta-xylosidase, and Trichoderma reesei translation elongation factor, as well as the NA2-tpi promoter (a modified promoter from anAspergillus neutral alpha-amylase gene in which the untranslated leader has been replaced by an untranslated leader from an Aspergillus triose phosphate isomerase gene; non-limiting examples include modified promoters from an Aspergillus niger neutral alpha-amylase gene in which the untranslated leader has been replaced by an untranslated leader from anAspergillus nidulans orAspergillus oryzae triose phosphate isomerase gene); and variant, truncated, and hybrid promoters thereof. Other promoters are described in U.S. Pat. No. 6,011,147.

In a yeast host, useful promoters are obtained from the genes for Saccharomyces cerevisiae enolase (ENO-1), Saccharomyces cerevisiae galactokinase (GAL1), Saccharomyces cerevisiae alcohol dehydrogenase/glyceraldehyde-3-phosphate dehydrogenase (ADH1, ADH2/GAP), Saccharomyces cerevisiae triose phosphate isomerase (TPI), Saccharomyces cerevisiae metallothionein (CUP1), and Saccharomyces cerevisiae 3-phosphoglycerate kinase. Other useful promoters for yeast host cells are described by Romanos et al., 1992, Yeast 8: 423-488.

The control sequence may also be a transcription terminator, which is recognized by a host cell to terminate transcription. The terminator is operably linked to the 3′-terminus of the polynucleotide encoding the polypeptide. Any terminator that is functional in the host cell may be used.

Non-limiting terminators for bacterial host cells are obtained from the genes for Bacillus clausii alkaline protease (aprH), Bacillus licheniformis alpha-amylase (amyL), and Escherichia coli ribosomal RNA (rrnB).

Non-limiting terminators for filamentous fungal host cells are obtained from the genes for Aspergillus nidulans acetamidase, Aspergillus nidulans anthranilate synthase, Aspergillus niger glucoamylase, Aspergillus niger alpha-glucosidase, Aspergillus oryzae TAKA amylase, Fusarium oxysporum trypsin-like protease, Trichoderma reesei beta-glucosidase, Trichoderma reesei cellobiohydrolase I, Trichoderma reesei cellobiohydrolase II, Trichoderma reesei endoglucanase I, Trichoderma reesei endoglucanase II, Trichoderma reesei endoglucanase III, Trichoderma reesei endoglucanase V, Trichoderma reesei xylanase I, Trichoderma reesei xylanase II, Trichoderma reesei xylanase III, Trichoderma reesei beta-xylosidase, and Trichoderma reesei translation elongation factor.

Non-limiting terminators for yeast host cells are obtained from the genes for Saccharomyces cerevisiae enolase, Saccharomyces cerevisiae cytochrome C (CYC1), and Saccharomyces cerevisiae glyceraldehyde-3-phosphate dehydrogenase. Other useful terminators for yeast host cells are described by Romanos et al., 1992, supra.

The control sequence may also be an mRNA stabilizer region downstream of a promoter and upstream of the coding sequence of a gene which increases expression of the gene.

Examples of suitable mRNA stabilizer regions are obtained from a Bacillus thuringiensis cryIIIA gene (WO 94/25612) and a Bacillus subtilis SP82 gene (Hue et al., 1995, Journal of Bacteriology 177: 3465-3471).

The control sequence may also be a leader, a nontranslated region of an mRNA that is important for translation by the host cell. The leader is operably linked to the 5′-terminus of the polynucleotide encoding the polypeptide. Any leader that is functional in the host cell may be used.

Non-limiting leaders for filamentous fungal host cells are obtained from the genes for Aspergillus oryzae TAKA amylase and Aspergillus nidulans triose phosphate isomerase.

Suitable leaders for yeast host cells are obtained from the genes for Saccharomyces cerevisiae enolase (ENO-1), Saccharomyces cerevisiae 3-phosphoglycerate kinase, Saccharomyces cerevisiae alpha-factor, and Saccharomyces cerevisiae alcohol dehydrogenase/glyceraldehyde-3-phosphate dehydrogenase (ADH2/GAP).

The control sequence may also be a polyadenylation sequence, a sequence operably linked to the 3′-terminus of the polynucleotide and, when transcribed, is recognized by the host cell as a signal to add polyadenosine residues to transcribed mRNA. Any polyadenylation sequence that is functional in the host cell may be used.

Non-limiting polyadenylation sequences for filamentous fungal host cells are obtained from the genes for Aspergillus nidulans anthranilate synthase, Aspergillus niger glucoamylase, Aspergillus niger alpha-glucosidase Aspergillus oryzae TAKA amylase, and Fusarium oxysporum trypsin-like protease.

Useful polyadenylation sequences for yeast host cells are described by Guo and Sherman, 1995, Mol. Cellular Biol. 15: 5983-5990.

The control sequence may also be a signal peptide coding region that encodes a signal peptide linked to the N-terminus of a polypeptide and directs the polypeptide into the cell's secretory pathway. The 5′-end of the coding sequence of the polynucleotide may inherently contain a signal peptide coding sequence naturally linked in translation reading frame with the segment of the coding sequence that encodes the polypeptide. Alternatively, the 5′-end of the coding sequence may contain a signal peptide coding sequence that is foreign to the coding sequence. A foreign signal peptide coding sequence may be required where the coding sequence does not naturally contain a signal peptide coding sequence. Alternatively, a foreign signal peptide coding sequence may simply replace the natural signal peptide coding sequence in order to enhance secretion of the polypeptide. However, any signal peptide coding sequence that directs the expressed polypeptide into the secretory pathway of a host cell may be used.

Effective signal peptide coding sequences for bacterial host cells are the signal peptide coding sequences obtained from the genes for Bacillus NCIB 11837 maltogenic amylase, Bacillus licheniformis subtilisin, Bacillus licheniformis beta-lactamase, Bacillus stearothermophilus alpha-amylase, Bacillus stearothermophilus neutral proteases (nprT, nprS, nprM), and Bacillus subtilis prsA. Further signal peptides are described by Simonen and Palva, 1993, Microbiological Reviews 57: 109-137.

Effective signal peptide coding sequences for filamentous fungal host cells are the signal peptide coding sequences obtained from the genes for Aspergillus niger neutral amylase, Aspergillus niger glucoamylase, Aspergillus oryzae TAKA amylase, Humicola insolens cellulase, Humicola insolens endoglucanase V, Humicola lanuginosa lipase, and Rhizomucor miehei aspartic proteinase.

Useful signal peptides for yeast host cells are obtained from the genes for Saccharomyces cerevisiae alpha-factor and Saccharomyces cerevisiae invertase. Other useful signal peptide coding sequences are described by Romanos et al., 1992, supra.

The control sequence may also be a propeptide coding sequence that encodes a propeptide positioned at the N-terminus of a polypeptide. The resultant polypeptide is known as a proenzyme or propolypeptide (or a zymogen in some cases). A propolypeptide is generally inactive and can be converted to an active polypeptide by catalytic or autocatalytic cleavage of the propeptide from the propolypeptide. The propeptide coding sequence may be obtained from the genes for Bacillus subtilis alkaline protease (aprE), Bacillus subtilis neutral protease (nprT), Myceliophthora thermophila laccase (WO 95/33836), Rhizomucor miehei aspartic proteinase, and Saccharomyces cerevisiae alpha-factor.

Where both signal peptide and propeptide sequences are present, the propeptide sequence is positioned next to the N-terminus of a polypeptide and the signal peptide sequence is positioned next to the N-terminus of the propeptide sequence.

It may also be desirable to add regulatory sequences that regulate expression of the polypeptide relative to the growth of the host cell. Examples of regulatory sequences are those that cause expression of the gene to be turned on or off in response to a chemical or physical stimulus, including the presence of a regulatory compound. Regulatory sequences in prokaryotic systems include the lac, tac, and trp operator systems. In yeast, the ADH2 system or GAL1 system may be used. In filamentous fungi, the Aspergillus niger glucoamylase promoter, Aspergillus oryzae TAKA alpha-amylase promoter, and Aspergillus oryzae glucoamylase promoter, Trichoderma reesei cellobiohydrolase I promoter, and Trichoderma reesei cellobiohydrolase II promoter may be used. Other examples of regulatory sequences are those that allow for gene amplification. In eukaryotic systems, these regulatory sequences include the dihydrofolate reductase gene that is amplified in the presence of methotrexate, and the metallothionein genes that are amplified with heavy metals. In these cases, the polynucleotide encoding the polypeptide would be operably linked to the regulatory sequence.

### Expression Vectors

The present disclosure also relates to recombinant expression vectors comprising a polynucleotide, a promoter, and transcriptional and translational stop signals. The various nucleotide and control sequences may be joined together to produce a recombinant expression vector that may include one or more convenient restriction sites to allow for insertion or substitution of the polynucleotide encoding the polypeptide at such sites. Alternatively, the polynucleotide may be expressed by inserting the polynucleotide or a nucleic acid construct comprising the polynucleotide into an appropriate vector for expression. In creating the expression vector, the coding sequence is located in the vector so that the coding sequence is operably linked with the appropriate control sequences for expression. The recombinant expression vector may be any vector (e.g., a plasmid or virus) that can be conveniently subjected to recombinant DNA procedures and can bring about expression of the polynucleotide. The choice of the vector will typically depend on the compatibility of the vector with the host cell into which the vector is to be introduced. The vector may be a linear or closed circular plasmid. The vector may be an autonomously replicating vector, i.e., a vector that exists as an extrachromosomal entity, the replication of which is independent of chromosomal replication, e.g., a plasmid, an extrachromosomal element, a minichromosome, or an artificial chromosome. The vector may contain any means for assuring self-replication. Alternatively, the vector may be one that, when introduced into the host cell, is integrated into the genome and replicated together with the chromosome(s) into which it has been integrated. Furthermore, a single vector or plasmid or two or more vectors or plasmids that together contain the total DNA to be introduced into the genome of the host cell, or a transposon, may be used.

The vector contains one or more selectable markers that permit easy selection of transformed, transfected, transduced, or the like cells. A selectable marker is a gene the product of which provides for biocide or viral resistance, resistance to heavy metals, prototrophy to auxotrophs, and the like.

Examples of bacterial selectable markers are Bacillus licheniformis or Bacillus subtilis dal genes, or markers that confer antibiotic resistance such as ampicillin, chloramphenicol, kanamycin, neomycin, spectinomycin, or tetracycline resistance. Suitable markers for yeast host cells include, but are not limited to, ADE2, HIS3, LEU2, LYS2, MET3, TRP 1, and URA3. Selectable markers for use in a filamentous fungal host cell include, but are not limited to, adeA (phosphoribosylaminoimidazole-succinocarboxamide synthase), adeB (phosphoribosyl-aminoimidazole synthase), amdS (acetamidase), argB (ornithine carbamoyltransferase), bar (phosphinothricin acetyltransferase), hph (hygromycin phosphotransferase), niaD (nitrate reductase), pyrG (orotidine-5′-phosphate decarboxylase), sC (sulfate adenyltransferase), and trpC (anthranilate synthase), as well as equivalents thereof. Useful in anAspergillus cell are Aspergillus nidulans orAspergillus oryzae amdS and pyrG genes and a Streptomyces hygroscopicus bar gene. Useful in a Trichoderma cell are adeA, adeB, amdS, hph, and pyrG genes.

The selectable marker may be a dual selectable marker system as described in WO 2010/039889. In one aspect, the dual selectable marker is an hph-tk dual selectable marker system.

The vector contains an element(s) that permits integration of the vector into the host cell's genome or autonomous replication of the vector in the cell independent of the genome.

For integration into the host cell genome, the vector may rely on the polynucleotide's sequence encoding the polypeptide or any other element of the vector for integration into the genome by homologous or non-homologous recombination. Alternatively, the vector may contain additional polynucleotides for directing integration by homologous recombination into the genome of the host cell at a precise location(s) in the chromosome(s). To increase the likelihood of integration at a precise location, the integrational elements should contain a sufficient number of nucleic acids, such as 100 to 10,000 base pairs, 400 to 10,000 base pairs, and 800 to 10,000 base pairs, which have a high degree of sequence identity to the corresponding target sequence to enhance the probability of homologous recombination. The integrational elements may be any sequence that is homologous with the target sequence in the genome of the host cell. Furthermore, the integrational elements may be non-encoding or encoding polynucleotides. On the other hand, the vector may be integrated into the genome of the host cell by non-homologous recombination.

For autonomous replication, the vector may further comprise an origin of replication enabling the vector to replicate autonomously in the host cell in question. The origin of replication may be any plasmid replicator mediating autonomous replication that functions in a cell. The term “origin of replication” or “plasmid replicator” means a polynucleotide that enables a plasmid or vector to replicate in vivo.

Examples of bacterial origins of replication are the origins of replication of plasmids pBR322, pUC19, pACYC177, and pACYC184 permitting replication in E. coli, and pUB110, pE194, pTA1060, and pAMβ1 permitting replication in Bacillus.

Examples of origins of replication for use in a yeast host cell are the 2 micron origin of replication, ARS1, ARS4, the combination of ARS1 and CEN3, and the combination of ARS4 and CEN6.

Examples of origins of replication useful in a filamentous fungal cell are AMA1 and ANS 1 (Gems et al., 1991, Gene 98: 61-67; Cullen et al., 1987, Nucleic Acids Res. 15: 9163-9175; WO 00/24883). Isolation of the AMA1 gene and construction of plasmids or vectors comprising the gene can be accomplished according to the methods disclosed in WO 00/24883.

More than one copy of a polynucleotide may be inserted into a host cell to increase production of a polypeptide. An increase in the copy number of the polynucleotide can be obtained by integrating at least one additional copy of the sequence into the host cell genome or by including an amplifiable selectable marker gene with the polynucleotide where cells containing amplified copies of the selectable marker gene, and thereby additional copies of the polynucleotide, can be selected for by cultivating the cells in the presence of the appropriate selectable agent.

The procedures used to ligate the elements described above to construct the recombinant expression vectors are well known to one skilled in the art (see, e.g., Sambrook et al., 1989, supra).

### Host Cells

The present disclosure also relates to recombinant host cells, comprising a polynucleotide as described herein operably linked to one or more control sequences that direct the production of a polypeptide. A construct or vector comprising a polynucleotide is introduced into a host cell so that the construct or vector is maintained as a chromosomal integrant or as a self-replicating extra-chromosomal vector as described earlier. The term “host cell” encompasses any progeny of a parent cell that is not identical to the parent cell due to mutations that occur during replication. The choice of a host cell will to a large extent depend upon the gene encoding the polypeptide and its source.

The host cell may be any cell useful in the recombinant production of a polypeptide, e.g., a prokaryote or a eukaryote.

The prokaryotic host cell may be any Gram-positive or Gram-negative bacterium. Gram-positive bacteria include, but are not limited to, Bacillus, Clostridium, Enterococcus, Geobacillus, Lactobacillus, Lactococcus, Oceanobacillus, Staphylococcus, Streptococcus, and Streptomyces. Gram-negative bacteria include, but are not limited to, Campylobacter, E. coli, Flavobacterium, Fusobacterium, Helicobacter, Ilyobacter, Neisseria, Pseudomonas, Salmonella, and Ureaplasma.

The bacterial host cell may be any Bacillus cell including, but not limited to, Bacillus alkalophilus, Bacillus altitudinis, Bacillus amyloliquefaciens, B. amyloliquefaciens subsp. plantarum, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus methylotrophicus, Bacillus pumilus, Bacillus safensis, Bacillus stearothermophilus, Bacillus subtilis, and Bacillus thuringiensis cells.

The bacterial host cell may also be any Streptococcus cell including, but not limited to, Streptococcus equisimilis, Streptococcus pyogenes, Streptococcus uberis, and Streptococcus equi subsp. Zooepidemicus cells.

The bacterial host cell may also be any Streptomyces cell including, but not limited to, Streptomyces achromogenes, Streptomyces avermitilis, Streptomyces coelicolor, Streptomyces griseus, and Streptomyces lividans cells.

The introduction of DNA into a Bacillus cell may be effected by protoplast transformation (see, e.g., Chang and Cohen, 1979, Mol. Gen. Genet. 168: 111-115), competent cell transformation (see, e.g., Young and Spizizen, 1961, J. Bacteriol. 81: 823-829, or Dubnau and Davidoff-Abelson, 1971, J. Mol. Biol. 56: 209-221), electroporation (see, e.g., Shigekawa and Dower, 1988, Biotechniques 6: 742-751), or conjugation (see, e.g., Koehler and Thorne, 1987, J. Bacteriol. 169: 5271-5278). The introduction of DNA into an E. coli cell may be effected by protoplast transformation (see, e.g., Hanahan, 1983, J. Mol. Biol. 166: 557-580) or electroporation (see, e.g., Dower et al., 1988, Nucleic Acids Res. 16: 6127-6145). The introduction of DNA into a Streptomyces cell may be effected by protoplast transformation, electroporation (see, e.g., Gong et al., 2004, Folia Microbiol. (Praha) 49: 399-405), conjugation (see, e.g., Mazodier et al., 1989, J. Bacteriol. 171: 3583-3585), or transduction (see, e.g., Burke et al., 2001, Proc. Natl. Acad. Sci. USA 98: 6289-6294). The introduction of DNA into a Pseudomonas cell may be effected by electroporation (see, e.g., Choi et al., 2006, J. Microbiol. Methods 64: 391-397) or conjugation (see, e.g., Pinedo and Smets, 2005, Appl. Environ. Microbiol. 71: 51-57). The introduction of DNA into a Streptococcus cell may be effected by natural competence (see, e.g., Perry and Kuramitsu, 1981, Infect. Immun. 32: 1295-1297), protoplast transformation (see, e.g., Catt and Jollick, 1991, Microbios 68: 189-207), electroporation (see, e.g., Buckley et al., 1999, Appl. Environ. Microbiol. 65: 3800-3804), or conjugation (see, e.g., Clewell, 1981, Microbiol. Rev. 45: 409-436). However, any method known in the art for introducing DNA into a host cell can be used.

The host cell may also be a eukaryote, such as a mammalian, insect, plant, or fungal cell.

The host cell may be a fungal cell. “Fungi” as used herein includes the phyla Ascomycota, Basidiomycota, Chytridiomycota, and Zygomycota as well as the Oomycota and all mitosporic fungi (as defined by Hawksworth et al., In, Ainsworth and Bisby's Dictionary of The Fungi, 8th edition, 1995, CAB International, University Press, Cambridge, UK).

The fungal host cell may be a yeast cell. “Yeast” as used herein includes ascosporogenous yeast (Endomycetales), basidiosporogenous yeast, and yeast belonging to the Fungi Imperfecti (Blastomycetes). Since the classification of yeast may change in the future, yeast shall be defined as described in Biology and Activities of Yeast (Skinner, Passmore, and Davenport, editors, Soc. App. Bacteriol. Symposium Series No. 9, 1980).

The yeast host cell may be a Candida, Hansenula, Kluyveromyces, Pichia, Saccharomyces, Schizosaccharomyces, or Yarrowia cell, such as a Kluyveromyces lactis, Saccharomyces carlsbergensis, Saccharomyces cerevisiae, Saccharomyces diastaticus, Saccharomyces douglasii, Saccharomyces kluyveri, Saccharomyces norbensis, Saccharomyces oviformis, or Yarrowia lipolytica cell.

The fungal host cell may be a filamentous fungal cell. “Filamentous fungi” include all filamentous forms of the subdivision Eumycota and Oomycota (as defined by Hawksworth et al., 1995, supra). The filamentous fungi are generally characterized by a mycelial wall composed of chitin, cellulose, glucan, chitosan, mannan, and other complex polysaccharides. Vegetative growth is by hyphal elongation and carbon catabolism is obligately aerobic. In contrast, vegetative growth by yeasts such as Saccharomyces cerevisiae is by budding of a unicellular thallus and carbon catabolism may be fermentative.

The filamentous fungal host cell may be an Acremonium, Aspergillus, Aureobasidium, Bjerkandera, Ceriporiopsis, Chrysosporium, Coprinus, Coriolus, Cryptococcus, Filibasidium, Fusarium, Humicola, Magnaporthe, Mucor, Myceliophthora, Neocallimastix, Neurospora, Paecilomyces, Penicillium, Phanerochaete, Phlebia, Piromyces, Pleurotus, Schizophyllum, Talaromyces, Thermoascus, Thielavia, Tolypocladium, Trametes, or Trichoderma cell.

For example, the filamentous fungal host cell may be an Aspergillus awamori, Aspergillus foetidus, Aspergillus fumigatus, Aspergillus japonicus, Aspergillus nidulans, Aspergillus niger, Aspergillus oryzae, Bjerkandera adusta, Ceriporiopsis aneirina, Ceriporiopsis caregiea, Ceriporiopsis gilvescens, Ceriporiopsis pannocinta, Ceriporiopsis rivulosa, Ceriporiopsis subrufa, Ceriporiopsis subvermispora, Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonatum, Coprinus cinereus, Coriolus hirsutus, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola insolens, Humicola lanuginosa, Mucor miehei, Myceliophthora thermophila, Neurospora crassa, Penicillium purpurogenum, Phanerochaete chrysosporium, Phlebia radiata, Pleurotus eryngii, Thielavia terrestris, Trametes villosa, Trametes versicolor, Trichoderma harzianum, Trichoderma koningii, Trichoderma longibrachiatum, Trichoderma reesei, or Trichoderma viride cell.

Fungal cells may be transformed by a process involving protoplast formation, transformation of the protoplasts, and regeneration of the cell wall in a manner known per se. Suitable procedures for transformation of Aspergillus and Trichoderma host cells are described in EP 238023, Yelton et al., 1984, Proc. Natl. Acad. Sci. USA 81: 1470-1474, and Christensen et al., 1988, Bio/Technology 6: 1419-1422. Suitable methods for transforming Fusarium species are described by Malardier et al., 1989, Gene 78: 147-156, and WO 96/00787. Yeast may be transformed using the procedures described by Becker and Guarente, In Abelson, J. N. and Simon, M.I., editors, Guide to Yeast Genetics and Molecular Biology, Methods in Enzymology, Volume 194, pp 182-187, Academic Press, Inc., New York; Ito et al., 1983, J. Bacteriol. 153: 163; and Hinnen et al., 1978, Proc. Natl. Acad. Sci. USA 75: 1920.

### Methods of Production

The present disclosure also relates to methods of producing a polypeptide as disclosed herein, comprising (a) cultivating a cell, which in its wild-type form produces the polypeptide, under conditions conducive for production of the polypeptide; and optionally, (b) recovering the polypeptide. In one aspect, the cell is an Aggregatibacter cell. In another aspect, the cell is an Aggregatibacter actinomycetemcomitans cell.

In one aspect, the cell is a Haemophilus cell. In another aspect, the cell is a Haemophilus sputorum cell.

In one aspect, the cell is an Actinobacillus cell. In another aspect, the cell is an Actinobacillus suis cell.

In one aspect, the cell is an Actinobacillus cell. In another aspect, the cell is an Actinobacillus capsulatus cell. In one aspect, the cell is an Actinobacillus capsulatus DSM 19761 cell.

In one aspect, the cell is an Actinobacillus cell. In another aspect, the cell is an Actinobacillus equuli cell.

In one aspect, the cell is an Actinobacillus cell. In another aspect, the cell is an Actinobacillus pleuropneumoniae cell.

The present disclosure also relates to methods of producing a polypeptide as disclosed herein, comprising (a) cultivating a recombinant host cell under conditions conducive for production of the polypeptide; and optionally, (b) recovering the polypeptide.

The host cells are cultivated in a nutrient medium suitable for production of the polypeptide using methods known in the art. For example, the cells may be cultivated by shake flask cultivation, or small-scale or large-scale fermentation (including continuous, batch, fed-batch, or solid state fermentations) in laboratory or industrial fermenters in a suitable medium and under conditions allowing the polypeptide to be expressed and/or isolated. The cultivation takes place in a suitable nutrient medium comprising carbon and nitrogen sources and inorganic salts, using procedures known in the art. Suitable media are available from commercial suppliers or may be prepared according to published compositions (e.g., in catalogues of the American Type Culture Collection). If the polypeptide is secreted into the nutrient medium, the polypeptide can be recovered directly from the medium. If the polypeptide is not secreted, it can be recovered from cell lysates.

The polypeptide may be detected using methods known in the art that are specific for the polypeptides having hexosaminidase activity. These detection methods include, but are not limited to, use of specific antibodies, formation of an enzyme product, or disappearance of an enzyme substrate. For example, an enzyme assay may be used to determine the activity of the polypeptide.

The polypeptide may be recovered using methods known in the art. For example, the polypeptide may be recovered from the nutrient medium by conventional procedures including, but not limited to, collection, centrifugation, filtration, extraction, spray-drying, evaporation, or precipitation. In one aspect, a fermentation broth comprising the polypeptide is recovered.

The polypeptide may be purified by a variety of procedures known in the art including, but not limited to, chromatography (e.g., ion exchange, affinity, hydrophobic, chromatofocusing, and size exclusion), electrophoretic procedures (e.g., preparative isoelectric focusing), differential solubility (e.g., ammonium sulfate precipitation), SDS-PAGE, or extraction (see, e.g., Protein Purification, Janson and Ryden, editors, VCH Publishers, New York, 1989) to obtain substantially pure polypeptides.

In an alternative aspect, the polypeptide is not recovered, but rather a host cell expressing the polypeptide is used as a source of the polypeptide.

### Formulation of Detergent Products

The cleaning composition may be in any convenient form, e.g., a bar, a homogenous tablet, a tablet having two or more layers, a pouch having one or more compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Non-limiting films are polymeric materials such as polymers which are formed into a film or sheet. Non-limiting polymers, copolymers or derivates thereof are selected polyaciylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, or polyvinyl alcohol copolymers and, hydroxypropyl methyl cellulose (HPMC). In a non-limiting embodiment, the level of polymer in the film for example PVA is at least about 60%. Non-limiting average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by Mono Sol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent.

A liquid or gel detergent may be non-aqueous.

### Laundry Soap Bars

The polypeptides disclosed herein may be added to laundry soap bars and used for hand washing laundry, fabrics and/or textiles. The term laundry soap bar includes laundry bars, soap bars, combo bars, syndet bars and detergent bars, with the term “cleaning composition” or “detergent composition”, as used herein, also including such soap bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval.

The laundry soap bar may contain one or more additional enzymes, protease inhibitors such as peptide aldehydes (or hydrosulfite adduct or hemiacetal adduct), boric acid, borate, borax and/or phenylboronic acid derivatives such as 4-formylphenylboronic acid, one or more soaps or synthetic surfactants, polyols such as glycerine, pH controlling compounds such as fatty acids, citric acid, acetic acid and/or formic acid, and/or a salt of a monovalent cation and an organic anion wherein the monovalent cation may be for example Na⁺, K⁺ or NH₄⁺ and the organic anion may be for example formate, acetate, citrate or lactate such that the salt of a monovalent cation and an organic anion may be, for example, sodium formate.

The laundry soap bar may also contain complexing agents like EDTA and HEDP, perfumes and/or different type of fillers, surfactants e.g. anionic synthetic surfactants, builders, polymeric soil release agents, detergent chelators, stabilizing agents, fillers, dyes, colorants, dye transfer inhibitors, alkoxylated polycarbonates, suds suppressers, structurants, binders, leaching agents, bleaching activators, clay soil removal agents, anti-redeposition agents, polymeric dispersing agents, brighteners, fabric softeners, perfumes and/or other compounds known in the art.

The laundry soap bar may be processed in conventional laundry soap bar making equipment such as but not limited to: mixers, plodders, e.g a two stage vacuum plodder, extruders, cutters, logo-stampers, cooling tunnels and wrappers. The composition is not limited to preparing the laundry soap bars by any single method. The premix may be added to the soap at different stages of the process. For example, the premix containing a soap, hexosaminidase, optionally one or more additional enzymes, a protease inhibitor, and a salt of a monovalent cation and an organic anion may be prepared and the mixture is then plodded. The hexosaminidase and optional additional enzymes may be added at the same time as the protease inhibitor for example in liquid form. Besides the mixing step and the plodding step, the process may further comprise the steps of milling, extruding, cutting, stamping, cooling and/or wrapping.

### Formulation of Enzyme in Co-Granule

The polypeptides disclosed herein may be formulated as a granule for example as a co-granule that combines one or more enzymes. Each enzyme will then be present in more granules securing a more uniform distribution of enzymes in the detergent. This also reduces the physical segregation of different enzymes due to different particle sizes. Methods for producing multi-enzyme co-granulate for the detergent industry are disclosed in the IP.com disclosure 1PCOM000200739D.

Another example of formulation of enzymes using co-granulates are disclosed in WO 2013/188331, which relates to a detergent composition comprising (a) a multi-enzyme co-granule; (b) less than 10 wt zeolite (anhydrous basis); and (c) less than 10 wt phosphate salt (anhydrous basis), wherein said enzyme co-granule comprises from 10 to 98 wt % moisture sink components and the composition additionally comprises from 20 to 80 wt % detergent moisture sink components. WO 2013/188331 also relates to a method of treating and/or cleaning a surface, such as a fabric surface comprising the steps of (i) contacting said surface with the detergent composition as claimed and described herein in aqueous wash liquor, (ii) rinsing and/or drying the surface.

The multi-enzyme co-granule may comprise a hexosaminidase and (a) one or more enzymes selected from the group consisting of first-wash lipases, cleaning cellulases, xyloglucanases, perhydrolases, peroxidases, lipoxygenases, laccases and mixtures thereof; and (b) one or more enzymes selected from the group consisting of hemicellulases, proteases, care cellulases, cellobiose dehydrogenases, xylanases, phospho lipases, esterases, cutinases, pectinases, mannanases, pectate lyases, keratinases, reductases, oxidases, phenoloxidases, ligninases, pullulanases, tannases, pentosanases, lichenases glucanases, arabinosidases, hyaluronidase, chondroitinase, amylases, and mixtures thereof.

The disclosure is further summarized in the following paragraphs:
1. Use of a cleaning composition, as defined herein, comprising a polypeptide having hexosaminidase activity comprising one or more domain selected from the group consisting of GXDE (SEQ ID NO 27), [EQ][NRSHA][YVFL][AGSTC][IVLF][EAQYN][SN] (SEQ ID NO: 28), HFHIGG (SEQ ID NO: 29), FLHLHF (SEQ ID NO: 30) or DHENYA (SEQ ID NO: 31) for deep cleaning of an item, wherein the item is a textile.
2. Use according to paragraph 1 for preventing, reducing or removing stickiness of the item.
3. Use according to any of paragraphs 1 or 2 for pre-treating stains on the item.
4. Use according to any of paragraphs 1-3 for preventing, reducing or removing re-deposition of soil during a wash cycle.
5. Use according to any of paragraphs 1-4 for preventing, reducing or removing adherence of soil to the item.
6. Use according to any of the preceding paragraphs for maintaining or improving the whiteness of the item.
7. Use according to any of the preceding paragraphs, wherein a malodor is reduced or removed from the item.
8. Use according to any of the preceding composition paragraphs, wherein the surface is a textile surface.
9. Use according to any of the preceding composition paragraphs, wherein the textile is made of cotton, Cotton/Polyester, Polyester, Polyamide, Polyacryl and/or silk.
10. Use according to any of the preceding paragraphs, wherein the polypeptide is a polypeptide of paragraphs 47-61.
11. A composition comprising a polypeptide having hexosaminidase activity and an adjunct ingredient.
12. Composition according to paragraph 11, wherein the polypeptide is the polypeptide of paragraphs 47-61.
13. Composition according to any of the preceding composition paragraphs, wherein the detergent adjunct ingredient is selected from the group consisting of surfactants, builders, flocculating aid, chelating agents, dye transfer inhibitors, enzymes, enzyme stabilizers, enzyme inhibitors, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, builders and co-builders, fabric huing agents, anti-foaming agents, dispersants, processing aids, bittering agents, and/or pigments.
14. Composition according to any of the preceding composition paragraphs wherein the composition comprises from about 5 wt % to about 50 wt %, from about 5 wt % to about 40 wt %, from about 5 wt % to about 30 wt %, from about 5 wt % to about 20 wt %, from about 5 wt % to about 10 wt % anionic surfactant, such as selected from linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), and combinations thereof.
15. Composition according to any of the preceding composition paragraphs wherein the composition comprises from about 10 wt % to about 50 wt % of at least one builder, such as selected from citric acid, methylglycine-N, N-diacetic acid (MGDA) and/or glutamic acid-N, N-diacetic acid (GLDA) and mixtures thereof.
16. Composition according to any of the preceding composition paragraphs wherein the polypeptide having hexosaminidase activity is selected from the group consisting of polypeptides having the amino acid sequence of SEQ ID NO 19, 20 and 20 or polypeptides having at least 60% sequence identity hereto.
17. Composition according to any of the preceding composition paragraphs wherein the polypeptide having hexosaminidase activity is the amino acid sequence of SEQ ID NO 19 or polypeptides having at least 60% sequence identity hereto.
18. Composition according to any of the paragraphs 11 to 16, wherein the polypeptide having hexosaminidase activity is the amino acid sequence of SEQ ID NO 20 or polypeptides having at least 60% sequence identity hereto.
19. Composition according to any of the paragraphs 11 to 16, wherein the polypeptide having hexosaminidase activity is the amino acid sequence of SEQ ID NO 21 or polypeptides having at least 60% sequence identity hereto.
20. Composition according to any of the preceding paragraphs comprising from about 5 wt % to about 40 wt % nonionic surfactants, and from about 0 wt % to about 5 wt % anionic surfactants.
21. Composition according to paragraph 20, wherein the nonionic surfactant is selected from alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA) and combinations thereof.
22. Composition according to any of the preceding composition paragraphs wherein the polypeptide having hexosaminidase activity is selected from the group consisting of polypeptides having the amino acid sequence of SEQ ID NO 17, 22 and 23 or polypeptides having at least 60% sequence identity hereto.
23. Composition according to paragraphs 20 to 22, wherein the polypeptide having hexosaminidase activity is the amino acid sequence of SEQ ID NO 17 or polypeptides having at least 60% sequence identity hereto.
24. Composition according to paragraphs 20 to 22, wherein the polypeptide having hexosaminidase activity is the amino acid sequence of SEQ ID NO 22 or polypeptides having at least 60% sequence identity hereto.
25. Composition according to paragraphs 20 to 22, wherein the polypeptide having hexosaminidase activity is the amino acid sequence of SEQ ID NO 23 or polypeptides having at least 60% sequence identity hereto.
26. Composition according to any of the preceding composition paragraphs, wherein the composition further comprises one or more enzymes selected from the group consisting of proteases, lipases, cutinases, amylases, carbohydrases, cellulases, pectinases, mannanases, arabinases, galactanases, xylanases and oxidases.
27. Composition according to any of the preceding composition paragraphs, wherein the enzyme is a protease, which is of animal, vegetable or microbial origin.
28. Composition according to any of the preceding composition paragraphs, wherein the protease is chemically modified or protein engineered.
29. Composition according to any of the preceding composition paragraphs, wherein the protease is a serine protease or a metalloprotease, such as an alkaline microbial protease or a trypsin-like protease.
30. Composition according to any of the preceding composition paragraphs, wherein the protease is selected from the group consisting of Bacillus, e.g., subtilisin Novo, subtilisin Carlsberg, subtilisin 309, subtilisin 147, subtilisin 168, trypsin of bovine origin, trypsin of porcine origin and Fusarium protease.
31. Composition according to any of the preceding composition paragraphs, wherein the composition is capable of reducing adhesion of bacteria selected from the group consisting of Acinetobacter sp., Aeromicrobium sp., Brevundimonas sp., Microbacterium sp., Micrococcus luteus, Pseudomonas sp., Staphylococcus epidermidis, Staphylococcus aureus and Stenotrophomonas sp. to a surface, or releasing the bacteria from a surface to which they adhere.
32. Composition according to any of the preceding composition paragraphs, wherein the composition is a bar, a homogenous tablet, a tablet having two or more layers, a pouch having one or more compartments, a regular or compact powder, a granule, a paste, a gel, or a regular, compact or concentrated liquid.
33. Composition according to any of the preceding composition paragraphs, wherein the composition is a cleaning composition selected from liquid detergent, powder detergent and granule detergent compositions.
34. A laundering method for laundering an item comprising the steps of:
   a. Exposing an item to a wash liquor comprising a polypeptide of paragraphs 47-61 or a composition according to any of paragraphs 11-33;
   b. Completing at least one wash cycle; and
   c. Optionally rinsing the item,

wherein the item is a textile.
35. Method according to paragraph 34, wherein the pH of the wash liquor is in the range of 1 to 11.
36. Method according to any of the preceding method paragraphs, wherein the pH of the wash liquor is in the range 5.5 to 11, such as in the range of 7 to 9, in the range of 7 to 8 or in the range of 7 to 8.5.
37. Method according to any of the preceding method paragraphs, wherein the temperature of the wash liquor is in the range of 5° C. to 95° C., or in the range of 10° C. to 80° C., in the range of 10° C. to 70° C., in the range of 10C to 60° C., in the range of 10° C. to 50° C., in the range of 15° C. to 40° C., in the range of 20° C. to 40° C., in the range of 15° C. to 30° C. or in the range of 20° C. to 30° C.
38. Method according to any of the preceding method paragraphs, wherein the temperature of the wash liquor is from about 20° C. to about 40° C.
39. Method according to any of the preceding method paragraphs, wherein the temperature of the wash liquor is from about 15° C. to about 30° C.
40. Method according to any of the preceding method paragraphs, wherein stains present on the item is pre-treated with a polypeptide of paragraphs 47-61 or a detergent composition according to any of paragraphs 11-33.
41. Method according to any of the preceding method paragraphs, wherein stickiness of the item is reduced.
42. Method according to any of the preceding method paragraphs, wherein redeposition of soil is reduced.
43. Method according to any of the preceding method paragraphs, wherein adherence of soil to the item is reduced or removed.
44. Method according to any of the preceding method paragraphs, wherein whiteness of the item is maintained or improved.
45. Method according to any of the preceding method paragraphs, wherein malodor is reduced or removed from the item.
46. Method according to any of the preceding method paragraphs, wherein the concentration of the polypeptide having hexosaminidase activity in the wash liquor is at least 0.001 mg of polypeptide, such as at least 0.05 mg of protein, or at least 1.0 mg of protein, or at least 1.5 mg of protein per liter of wash liquor, optionally the concentration of polypeptide in the wash liquor is in the range 0.0002 mg/L to 2 mg/L, such as 0.002 mg/L to 2 mg/L, such as 0.2 mg/L to 2 mg/L or in the range of 0.00001 mg/L to 10 mg/L or in the range of in the range of 0.0001 mg/L to 10 mg/L, or in the range of 0.001 mg/L to 10 mg/L, or in in the range of 0.01 mg/L to 10 mg/L per liter of wash liquor, optionally the concentration of the polypeptide is 0.00001% to 2 wt %, such as 0.0001 to 0.1 wt %, such as 0.0005 to 0.1 wt %, such as 0.001 to 0.1 wt %, such as 0.001 to 0.5 wt %, such as 0.002 to 0.5 wt % or 0.0002 to 0.09 wt % in the total detergent concentration.
47. A polypeptide having hexosaminidase activity, selected from the group consisting of:
   a. a polypeptide having at least 60% sequence identity to the mature polypeptide of SEQ ID NO: 2, 4, 6, 8, 10, 12, 14, 16 or a polypeptide having at least 60% sequence identity to the mature polypeptide of SEQ ID NO: 17, 18, 19, 20, 21, 22, 23 or 24;
   b. a polypeptide encoded by a polynucleotide that hybridizes under low stringency conditions with
      i. the mature polypeptide coding sequence of SEQ ID NO: 1, 3, 5, 7, 9, 11, 13 or 15,
      ii. the cDNA sequence thereof, or
      iii. the full-length complement of (i) or (ii);
   c. a polypeptide encoded by a polynucleotide having at least 60% sequence identity to the mature polypeptide coding sequence of SEQ ID NO: 1, 3, 5, 7, 9, 11, 13 or 15 or the cDNA sequence thereof;
   d. a variant of the mature polypeptide of SEQ ID NO: 2, 4, 6, 8, 10, 12, 14, 16 comprising a substitution, deletion, and/or insertion at one or more positions or a variant of the mature polypeptide of SEQ ID NO: 17, 18, 19, 20, 21, 22, 23 or 24 comprising a substitution, deletion, and/or insertion at one or more positions;
   e. a fragment of the polypeptide of (a), (b), (c), or (d) that has hexosaminidase activity; and
   f. a polypeptide comprising one or more motif selected from the group consisting of GXDE (SEQ ID NO 27), [EQ][NRSHA][YVFL][AGSTC][IVLF][EAQYN][SN] (SEQ ID NO: 28), HFHIGG (SEQ ID NO: 29), FLHLHF (SEQ ID NO: 30) and DHENYA (SEQ ID NO: 31).
48. The polypeptide of paragraph 47, having at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide of SEQ ID NO: 2, 4, 6, 8, 10, 12, 14, 16 or to the mature polypeptide of SEQ ID NO: 17, 18, 19, 20, 21, 22, 23 or 24.
49. The polypeptide of paragraph 47 or 48, having at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide of SEQ ID NO: 2 or to the mature polypeptide of SEQ ID NO: 17.
50. The polypeptide of paragraph 47 or 48, having at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide of SEQ ID NO: 4 or to the mature polypeptide of SEQ ID NO: 18.
51. The polypeptide of paragraph 47 or 48, having at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide of SEQ ID NO: 6 or to the mature polypeptide of SEQ ID NO: 19.
52. The polypeptide of paragraph 47 or 48, having at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide of SEQ ID NO: 8 or to the mature polypeptide of SEQ ID NO: 20.
53. The polypeptide of paragraph 47 or 48, having at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide of SEQ ID NO: 10 or to the mature polypeptide of SEQ ID NO: 21.
54. The polypeptide of paragraph 47 or 48, having at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide of SEQ ID NO: 12 or to the mature polypeptide of SEQ ID NO: 22.
55. The polypeptide of paragraph 47 or 48, having at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide of SEQ ID NO: 14 or to the mature polypeptide of SEQ ID NO: 23.
56. The polypeptide of paragraph 47 or 48, having at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide of SEQ ID NO: 16 or to the mature polypeptide of SEQ ID NO: 24.
57. The polypeptide according to paragraph 47 or 48, which is encoded by a polynucleotide that hybridizes under low stringency conditions, low-medium stringency conditions, medium stringency conditions, medium-high stringency conditions, high stringency conditions, or very high stringency conditions with
   i. the mature polypeptide coding sequence of SEQ ID NO: 1, 3, 5, 7, 9, 11, 13 or 15,
   ii. the cDNA sequence thereof, or
   iii. the full-length complement of (i) or (ii).
58. The polypeptide according to any of paragraphs 47-49, which is encoded by a polynucleotide having at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide coding sequence of SEQ ID NO: 1, 3, 5, 7, 9, 11, 13, 15 or the cDNA sequence thereof.
59. The polypeptide according to any of paragraphs 47 to 58, comprising or consisting of SEQ ID NO: 17, 18, 19, 20, 21, 22, 23 or 24 or the mature polypeptide of SEQ ID NO: 2, 4, 6, 8, 10, 12, 14 or 16.
60. The polypeptide according to any of paragraphs 47 to 58, comprising or consisting of SEQ ID NO: 17, 18, 19, 20, 21, 22, 23 or 24 or the mature polypeptide of SEQ ID NO: 2, 4, 6, 8, 10, 12, 14 or 16.
61. The polypeptide according to any of paragraphs 47 to 58, which is a variant of SEQ ID NO: 17, 18, 19, 20, 21, 22, 23 or 24 comprising a substitution, deletion, and/or insertion at one or more positions or a variant of the mature polypeptide of SEQ ID NO: 2, 4, 6, 8, 10, 12, 14 or 16 comprising a substitution, deletion, and/or insertion at one or more positions.
62. A polynucleotide encoding the polypeptide according to any of paragraphs 47-61.
63. A nucleic acid construct or expression vector comprising the polynucleotide of paragraph 62 operably linked to one or more control sequences that direct the production of the polypeptide in an expression host.
64. A recombinant host cell comprising the polynucleotide of paragraph 62 operably linked to one or more control sequences that direct the production of the polypeptide.
65. A method of producing the polypeptide of any of paragraphs 47-61, comprising cultivating a cell, which in its wild-type form produces the polypeptide, under conditions conducive for production of the polypeptide.
66. The method of paragraph 65, further comprising recovering the polypeptide.
67. A method of producing a polypeptide according to any of paragraphs 47-61, comprising cultivating the host cell of paragraph 64 under conditions conducive for production of the polypeptide.
68. The method of paragraph 67, further comprising recovering the polypeptide.
69. A nucleic acid construct or expression vector comprising a gene encoding a protein operably linked to the polynucleotide of paragraph 62, wherein the gene is foreign to the polynucleotide encoding the signal peptide.
70. A recombinant host cell comprising a gene encoding a protein operably linked to the polynucleotide of paragraph 62, wherein the gene is foreign to the polynucleotide encoding the signal peptide.
71. A method of producing a protein, comprising cultivating a recombinant host cell comprising a gene encoding a protein operably linked to the polynucleotide of paragraph 62, wherein the gene is foreign to the polynucleotide encoding the signal peptide, under conditions conducive for production of the protein.
72. The method of paragraph 71, further comprising recovering the protein.
73. The recombinant host cell of paragraph 70 further comprising a polynucleotide encoding a second polypeptide of interest; such as an enzyme of interest; or a secreted enzyme of interest; alternatively a hydrolase, isomerase, ligase, lyase, oxidoreductase, or a transferase; or the secreted enzyme is an alpha-galactosidase, alpha-glucosidase, aminopeptidase, amylase, asparaginase, beta-galactosidase, beta-glucosidase, beta-xylosidase, carbohydrase, carboxypeptidase, catalase, cellobiohydrolase, cellulase, chitinase, cutinase, cyclodextrin glycosyltransferase, deoxyribonuclease, endoglucanase, esterase, green fluorescent protein, glucano-transferase, glucoamylase, invertase, laccase, lipase, mannosidase, mutanase, oxidase, pectinolytic enzyme, peroxidase, phytase, polyphenoloxidase, proteolytic enzyme, ribonuclease, transglutaminase, or a xylanase.
74. The recombinant host cell of paragraph 70, wherein the second polypeptide of interest is heterologous or homologous to the host cell.
75. The recombinant host cell of paragraph 70 or 72, which is a fungal host cell; such as a filamentous fungal host cell; e.g. an Acremonium, Aspergillus, Aureobasidium, Bjerkandera, Ceriporiopsis, Chrysosporium, Coprinus, Coriolus, Cryptococcus, Filibasidium, Fusarium, Humicola, Magnaporthe, Mucor, Myceliophthora, Neocallimastix, Neurospora, Paecilomyces, Penicillium, Phanerochaete, Phlebia, Piromyces, Pleurotus, Schizophyllum, Talaromyces, Thermoascus, Thielavia, Tolypocladium, Trametes, or Trichoderma cell; such as anAspergillus awamori, Aspergillusfoetidus, Aspergillusfumigatus, Aspergillus japonicus, Aspergillus nidulans, Aspergillus niger, Aspergillus oryzae, Bjerkandera adusta, Ceriporiopsis aneirina, Ceriporiopsis caregiea, Ceriporiopsis gilvescens, Ceriporiopsis pannocinta, Ceriporiopsis rivulosa, Ceriporiopsis subrufa, Ceriporiopsis subvermispora, Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonatum, Coprinus cinereus, Coriolus hirsutus, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola insolens, Humicola lanuginosa, Mucor miehei, Myceliophthora thermophila, Neurospora crassa, Penicillium purpurogenum, Phanerochaete chrysosporium, Phlebia radiata, Pleurotus eryngii, Thielavia terrestris, Trametes villosa, Trametes versicolor, Trichoderma harzianum, Trichoderma koningii, Trichoderma longibrachiatum, Trichoderma reesei, or Trichoderma viride cell.
76. The recombinant host cell of paragraph 70 or 72, which is a bacterial host cell; such as a prokaryotic host cell; e.g. a Gram-positive host cell; such as a Bacillus, Clostridium, Enterococcus, Geobacillus, Lactobacillus, Lactococcus, Oceanobacillus, Staphylococcus, Streptococcus, or Streptomyces host cell; or a Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, and Bacillus thuringiensis host cell.
77. A method of producing the second polypeptide of interest as defined in any of paragraphs 71 to 72 comprising cultivating the host cell of any of paragraphs 75 to 76 under conditions conducive for production of the second polypeptide of interest.
78. The method of paragraph 77, further comprising recovering the second polypeptide of interest. 79. Item laundered according to the method of any of paragraphs 34-46.
   Non-limiting aspects include:
1. A cleaning composition, as defined herein, comprising at least 0.01 mg of active enzyme per gram of composition, wherein the polypeptide having hexosaminidase activity is selected from the group consisting of a polypeptide having at least 60% sequence identity to the mature polypeptide of SEQ ID NO: 2, 4, 6, 8, 10, 12, 14, and 16.
2. The composition of paragraph 1, wherein the polypeptide has at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide of SEQ ID NO: 2, 4, 6, 8, 10, 12, 14, and 16.
3. The composition of any of paragraphs 1 or 2, comprising or consisting of SEQ ID NO: 17 or the mature polypeptide of SEQ ID NO: 2, SEQ ID NO: 18 or the mature polypeptide of SEQ ID NO: 4, SEQ ID NO: 19 or the mature polypeptide of SEQ ID NO: 6, SEQ ID NO: 20 or the mature polypeptide of SEQ ID NO: 8, SEQ ID NO: 21 or the mature polypeptide of SEQ ID NO: 10, SEQ ID NO: 22 or the mature polypeptide of SEQ ID NO: 12, SEQ ID NO: 23 or the mature polypeptide of SEQ ID NO: 14 or SEQ ID NO: 24 or the mature polypeptide of SEQ ID NO: 16.
4. The composition according to any of paragraphs 1 to 3 wherein the composition is a laundry or dish wash composition
5. Use of a composition of any of paragraphs 1 to 4 for deep-cleaning of an item, wherein the item is a textile.
6. A laundering method for laundering an item comprising the steps of:
   a. Exposing an item to a wash liquor comprising a polypeptide selected from the group consisting of a polypeptide having at least 60% sequence identity to the mature polypeptide of SEQ ID NO: 2, 4, 6, 8, 10, 12, 14, and 16 or a detergent composition according to any of paragraphs 1 to 4;
   b. Completing at least one wash cycle; and
   c. Optionally rinsing the item,
   wherein the item is a textile.
7. Use of a cleaning composition as defined herein comprising a polypeptide of a DspB clade, wherein the polypeptide has hexosaminidase activity in a cleaning process, such as laundry and/or dish wash.
8. Use of a cleaning composition as defined herein comprising a polypeptide of a DspB clade, wherein the polypeptide has hexosaminidase activity for deep cleaning of an item, wherein the item is a textile.
9. Use according to paragraph 18 for preventing, reducing or removing stickiness of the item.
10. Use according to any of paragraphs 18 or 19 for preventing, reducing or removing redeposition of soil during a wash cycle.
11. Use according to any of the preceding paragraphs, wherein the polypeptide is selected from the group consisting of a polypeptide having at least 60% sequence identity to the mature polypeptide of SEQ ID NO: 2, 4, 6, 8, 10, 12, 14, and 16 and at least one adjunct ingredient.
12. Use of paragraph 21, wherein the polypeptide has at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the mature polypeptide of SEQ ID NO: 2, 4, 6, 8, 10, 12, 14, and 16.

It should be understood that every maximum numerical limitation given throughout this specification includes every lower numerical limitation, as if such lower numerical limitations were expressly written herein.

Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Assays

### Wash Assays

### Mini Launder-O-Meter (MiniLOM) Model Wash System

MiniLOM is a mini wash system in which washes are performed in 50 ml test tubes placed in a Stuart rotator. Each tube simulates one small washing machine and during an experiment, each will contain a solution of a specific detergent/enzyme system to be tested along with the soiled and unsoiled fabrics it is tested on. Mechanical stress is achieved via rotation (typically 20 rpm), and the temperature is controlled by placement of the rotator in a heating cabinet/room.

### Terg-O-Timeter (TOM) Wash Assay

The Tergo-To-Meter (TOM) is a medium scale model wash system that can be applied to test 12 different wash conditions simultaneously. A TOM is basically a large temperature controlled water bath with up to 12 open metal beakers submerged into it. Each beaker constitutes one small top loader style washing machine and during an experiment, each of them will contain a solution of a specific detergent/enzyme system and the soiled and unsoiled fabrics its performance is tested on. Mechanical stress is achieved by a rotating stirring arm, which stirs the liquid within each beaker. Because the TOM beakers have no lid, it is possible to withdraw samples during a TOM experiment and assay for information on-line during wash. The TOM model wash system is mainly used in medium scale testing of detergents and enzymes at US or LA/AP wash conditions. In a TOM experiment, factors such as the ballast to soil ratio and the fabric to wash liquor ratio can be varied. Therefore, the TOM provides the link between small scale experiments, such as AMSA and mini-wash, and the more time consuming full scale experiments in top loader washing machines. Equipment: The water bath with 12 steel beakers and 1 rotating arm per beaker with capacity of 500 or 1200 mL of detergent solution. Temperature ranges from 5 to 80° C. The water bath must be filled up with deionised water. Rotational speed can be set up to 70 to 120 rpm/min. Set temperature in the Terg-O-Tometer and start the rotation in the water bath. Wait for the temperature to adjust (tolerance is +/−0.5° C.). All beakers shall be clean and without traces of prior test material. The wash solution with desired amount of detergent, temperature and water hardness is prepared in a bucket. The detergent is allowed to dissolve during magnet stirring for 10 min. Wash solution shall be used within 30 to 60 min after preparation. 800 ml wash solution is added into a TOM beaker. The wash solution is agitated at 120 rpm and optionally one or more enzymes are added to the beaker. The swatches are sprinkled into the beaker and then the ballast load. Time measurement starts when the swatches and ballast are added to the beaker. The swatches are washed for 20 minutes after which agitation is terminated. The wash load is subsequently transferred from the TOM beaker to a sieve and rinse with cold tap water. The soiled swatches are separated from the ballast load. The soil swatches are transferred to a 5 L beaker with cold tap water under running water for 5 minutes. The ballast load is kept separately for the coming inactivation. The water is gently pressed out of the swatches by hand and placed on a tray covered with a paper. Another paper is placed on top of the swatches. The swatches are allowed to dry overnight before subjecting the swatches to analysis, such as measuring the color intensity using a Color Eye.

The following examples that should not be construed as limiting the scope of the composition.

### Assay I: Testing of Hexosaminidase Activity

The hexosaminidase activity of the polypeptides listed in the table below was determined using 4-nitrophenyl N-acetyl-β-D-glucosaminide (Sigma-Aldrich) as substrate. The enzymatic reaction was performed in triplicates in a 96 well flat bottom polystyrene microtiter plate (Thermo Scientific) with the following conditions: 50 mM 2-(N-morpholino) ethanesulfonic acid pH 6 buffer, 1.5 mg/ml 4-nitrophenyl N-acetyl-β-D-glucosaminide and 20 μg/ml purified enzyme sample in a total reaction volume of 100 μl. Blank samples without polypeptide were run in parallel. The reactions were carried out at 37° C. in a Thermomixer comfort (Eppendorf). After 10 minutes of incubation, 5 μl 1 M NaOH was added to each reaction mixture to stop the enzymatic reaction. The absorbance was read at 405 nm using a POLARstar Omega plate reader (BMG LABTECH) to estimate the formation of 4-nitrophenolate ion released because of enzymatic hydrolysis of the 4-nitrophenyl N-acetyl-β-D-glucosaminide substrate.

The results are summarized in table 2 below. The table shows the average absorbance measured at 405 nm for each reaction performed in triplicates. It is seen that the absorbance is higher for the reaction carried out with all the polypeptides listed in the table below compared to blank without polypeptide which demonstrates that all the tested polypeptides exhibit hexosaminidase activity.

TABLE 2
Hexosaminidase activity of the polypeptides.

| | | | | Δ405 nm |
|---|---|---|---|---|
| | Enzyme | | | (A405 nmₛₐₘₚₗₑ − |
| Enzyme | concentration | | A405 nm | A405 nm_{blank}) |
| Blank | 0 | μg/ml | 0.158 | — |
| SEQ ID NO 24 | 10 | μg/ml | 1.352 | 1.194 |
| SEQ ID NO 17 | 10 | μg/ml | 1.161 | 1.003 |
| SEQ ID NO 18 | 10 | μg/ml | 0.332 | 0.174 |
| SEQ ID NO 19 | 10 | μg/ml | 0.321 | 0.163 |
| SEQ ID NO 20 | 10 | μg/ml | 2.903 | 2.745 |
| SEQ ID NO 21 | 10 | μg/ml | 0.582 | 0.424 |
| SEQ ID NO 22 | 10 | μg/ml | 0.938 | 0.780 |
| SEQ ID NO 23 | 10 | μg/ml | 1.152 | 0.994 |

### EXAMPLES

### Example 1

The DNA encoding the polypeptides having hexosaminidase activity comprising the polypeptide having SEQ ID NO 24 from Actinobacillus pleuropneumoniae, the polypeptide having SEQ ID NO 17 from Aggregatibacter actinomycetemcomitans, the polypeptide having SEQ ID NO 18 from Haemophilus sputorum, the polypeptide having SEQ ID NO 19 from Actinobacillus suis, the polypeptide having SEQ ID NO 21 from Actinobacillus equuli subsp. Equuli, the polypeptide having SEQ ID NO 22 from Aggregatibacter actinomycetemcomitans, the polypeptide having SEQ ID NO 23 Aggregatibacter actinomycetemcomitans respectively, were obtained from public databases (see public database entry in Table 3 below) or from the genome of Actinobacillus capsulatus DSM 19761 corresponding to NCBI taxonomy ID 1120931 for the polypeptide having SEQ ID NO 20. The codon optimized synthetic DNA encoding the mature peptide sequences of the polypeptides having hexosaminidase activity were ordered from the company Geneart.

TABLE 3

| Polypeptide | Donor | Database entry |
|---|---|---|
| SEQ ID NO 24 | Actinobacillus | SWISSPROT: |
| | pleuropneumoniae | E0EKU9 |
| SEQ ID NO 17 | Aggregatibacter | SWISSPROT: |
| | actinomycetemcomitans | G4ADF2 |
| SEQ ID NO 18 | Haemophilus | SWISSPROT: |
| | sputorum | J4TU99 |
| SEQ ID NO 19 | Actinobacillus | SWISSPROT: |
| | suis | A0A076NK29 |
| SEQ ID NO 20 | Actinobacillus | NCBI taxonomy |
| | capsulatus | ID 1120931 |
| SEQ ID NO 21 | Actinobacillus | SWISSPROT: |
| | equuli subsp.equuli | A0A0A7MHS5 |
| SEQ ID NO 22 | Aggregatibacter | SWISSPROT: |
| | actinomycetemcomitans | G3ZHN9 |
| SEQ ID NO 23 | Aggregatibacter | SWISSPROT: |
| | actinomycetemcomitans | G4AQA6 |

### Example 2: Cloning and Expression of Polypeptides Having Hexosaminidase Activity

The codon optimized synthetic genes encoding the polypeptides with SEQ ID NOS 17, 18, 19, 20, 21, 22, 23 and 24 having hexosaminidase activity were inserted into a Bacillus expression vector as described in WO 12/025577. Briefly, the DNA encoding the polypeptides with SEQ ID NOS 17, 18, 19, 20, 21, 22, 23 and 24 genes were cloned in frame to a Bacillus clausii secretion signal (BcSP; with the following amino acid sequence: MKKPLGKIVASTALLISVAFSSSIASA (SEQ ID NO:25)). BcSP replaced the native secretion signal inthe gene. Downstream of the BcSP sequence, an affinity tag sequence was introduced to ease the purification process (His-tag; with the following amino acid sequence: HHHHHHPR (SEQ ID NO: 26). The gene that was expressed therefore comprised the BcSP sequence followed by the His-tag sequence followed by the polypeptide sequence (as shown in the polypeptide with SEQ ID NOS 17, 18, 19, 20, 21, 22, 23 and 24, abbreviated GH2O in the following. The final expression plasmid (BcSP-His-tag-GH20) was transformed into a Bacillus subtilis expression host. The GH20 BcSP-fusion gene was integrated by homologous recombination into the Bacillus subtilis host cell genome upon transformation. The gene construct was expressed under the control of a triple promoter system (as described in WO 99/43835). The gene coding for chloramphenicol acetyltransferase was used as maker (as described in (Diderichsen et al., 1993, Plasmid 30: 312-315)). Transformants were selected on LB media agar supplemented with 6 micrograms of chloramphenicol per ml. One recombinant Bacillus subtilis clone containing the GH20 expression construct was selected and was cultivated on a rotary shaking table in 500 ml baffled Erlenmeyer flasks each containing 100 ml yeast extract-based media. After 3-5 days' cultivation time at 30° C. to 37° C., enzyme containing supernatants were harvested by centrifugation and the polypeptides were purified by His-tag purification.

### Example 3: His Tag Purification Method

The His-tagged polypeptides were purified by immobilized metal chromatography (IMAC) using Ni²⁺ as the metal ion on 5 mL HisTrap Excel columns (GE Healthcare Life Sciences). The purification took place at pH 7 and the bound proteins were eluted with imidazole. The purity of the purified enzymes was checked by SDS-PAGE and the concentration of each enzyme determined by Absorbance 280 nm after a buffer exchange in 50 mM HEPES, 100 mM NaCl pH7.0

### Example 4: Biofilm Assay

Staphylococcus aureus was kindly provided by Iñigo Lasa (Valle et al., Mol Microbiol. 2003 May; 48 (4):1075-87). The strain was grown on trypticase soy agar (TSA) at 37° C. overnight. Next day, a single colony was transferred to 15 ml tripticase soy broth (TSB) and incubated 5 hours at 37° C. under shaking. The culture was diluted 1:100 in TSB+1% glucose and 100 μL of the bacterial suspension was transferred to each well of a 96-well microtiter plates (Thermo Scientific, Nunclon Delta Surface, cat #167008) and incubated 24 hours at 37° C. without shaking. Supernatant was aspirated and wells were washed with 100 μL of 0.9% sodium chloride and filled with 100 μL of either hard water or 3.3 gr/L Model detergent A containing 0 (control) or 20, 10, 5, 2.5, 1.25, 0.62, 0.31, 0.16, 0.08, 0.04, 0.02 and 0.01 fig/mL of enzyme (the polypeptides with SEQ ID NO 24 SEQ ID NO 18, SEQ ID NO 19, SEQ ID NO 20 and SEQ ID NO 21). After incubation at 37° C. for 1 hour, wells were washed with water and stained for 15 min with 100 μL of 0.095% crystal violet solution (SIGMA V5265). Wells were then rinsed twice with 100 μL water, dried and the plates were scanned. The lowest concentration of each enzyme that could reduce the visible formation of biofilm of the S. aureus organism after 1 hour incubation, in the presence and absence of detergent was determined (see Table 4). All enzymes were assayed per duplicate with similar results.

TABLE 4
Minimal concentration of enzyme that can reduce the
visible formation of S. aureus after 1 hour incubation
in either hard water or Model detergent A.

| | Minimal concentration | Minimal concentration |
|---|---|---|
| | for biofilm reduction | for biofilm reduction |
| | in Model A | in Hard water |
| enzyme | μg/mL | μg/mL |
| SEQ ID NO 24 | 2.5 | 0.02 |
| SEQ ID NO 18 | 2.5 | 0.08 |
| SEQ ID NO 19 | 1.25 | 0.04 |
| SEQ ID NO 20 | 1.25 | 0.04 |
| SEQ ID NO 21 | 1.25 | 0.04 |

### Example 5 Deep-Cleaning of Hexosaminidases in Liquid Model Detergent

Staphylococcus aureus (kind gift from Iñigo Lasa (Valle et al., Mol Microbiol. 2003 May; 48 (4):1075-87) was used as model microorganism in the present example. S. aureus was restreaked on Tryptone Soya Agar (TSA) (pH 7.3) (CM0131; Oxoid Ltd, Basingstoke, UK) and incubated for 1 day at 37° C. A single colony was inoculated into 10 mL of TSB and the culture was incubated for 16 hours at 37° C. with shaking (200 rpm). After propagation, the S. aureus culture was diluted (1:100) in fresh TSB+1% glucose (24563; Roquette Freres) and 2 mL aliquots were added to the wells of 12-well polystyrene flat-bottom microplates (3512; Costar, Corning Incorporated, Corning, N.Y., USA), in which round swatches (diameter 2 cm) of sterile polyester (WFK30A) had been placed. Sterile TSB+1% glucose was added to control wells. After 48 h at 37° C. (static incubation), the swatches were rinsed twice with 15°dH water. Five rinsed swatches (sterile or with S. aureus) were placed in 50 mL test tubes and 10 mL of wash liquor (15° dH water with 0.2 g/L iron(III) oxide nanopowder (544884; Sigma-Aldrich) with 3.33 g/L liquid model A detergent) and 2 ppm enzyme (mature polypeptide of SEQ ID NO 2, 4, 6, 8, 10, 12, 14 or 16) were added to each tube. Washes without enzyme were included as controls. The test tubes were placed in a Stuart rotator and incubated for 1 hour at 37° C. at 20 rpm. The wash liquor was then removed, and the swatches were rinsed twice with 15° dH water and dried on filter paper over night.

The color difference (L) values were measured using a Handheld Minolta CR-300, and are displayed in table 5.

Delta values (L_{(swatch washed with enzyme)}−L_{(swatch washed without enzyme)}) are also indicated. The results show that the hexosaminidases display deep-cleaning properties in model detergent A.

TABLE 5
Deep-cleaning effects of dispersins in model detergent A

| | | Enzyme | | ΔL |
|---|---|---|---|---|
| | | concentration | | (Lwith enzyme − |
| Swatch | Enzyme | (ppm) | L values | Lwithout enzyme) |
| Biofilm | — | 0 | 85.5 | 0 |
| Biofilm | SEQ ID NO 24 | 2 | 90.9 | 5.4 |
| Biofilm | SEQ ID NO 17 | 2 | 92.3 | 6.8 |
| Biofilm | SEQ ID NO 18 | 2 | 91.4 | 5.9 |
| Biofilm | SEQ ID NO 19 | 2 | 90.5 | 5.0 |
| Biofilm | SEQ ID NO 20 | 2 | 93.1 | 7.7 |
| Biofilm | SEQ ID NO 21 | 2 | 90.9 | 5.4 |
| Biofilm | SEQ ID NO 22 | 2 | 90.8 | 5.4 |
| Biofilm | SEQ ID NO 23 | 2 | 90.1 | 4.7 |

The results show that all the polypeptides have deep cleaning properties, when compared to samples comprising no enzyme.

### Example 6 Deep-Cleaning of Hexosaminidases in Nonionic Liquid Model Detergent

Staphylococcus aureus biofilms were grown on textile swatches (wfk30A) as described in example 5. Five rinsed swatches (sterile or with S. aureus) were placed in 50 mL conical centrifuge tubes (339652; Thermo Scientific) and 10 mL of wash liquor (15° dH water with 0.2 g/L iron(III) oxide nanopowder (544884; Sigma-Aldrich) with 3.33 g/L liquid nonionic model detergent) and 2 ppm enzyme was added to each tube. Washes without enzyme were included as controls. The tubes were placed on a Stuart rotator and incubated for 1 hour at 37° C. at 20 rpm. The wash liquor was then removed, and the swatches were rinsed twice with 15°dH water and dried on filter paper over night.

The color difference (L) values were measured using a Handheld Minolta CR-300, and are displayed in table 5. Delta values (L_{(swatch washed with enzyme)}−L_{(swatch washed without enzyme)}) are also indicated. The results show that the dispersins also show deep-cleaning properties in nonionic liquid model detergent.

TABLE 6
Deep-cleaning effects of dispersins in nonionic model detergent

| | | Enzyme | | ΔL |
|---|---|---|---|---|
| | | concentration | | (Lwith enzyme − |
| Swatch | Enzyme | (ppm) | L values | Lwithout enzyme) |
| Textile, | No enzyme | 0 | 94.5 | |
| no | | | | |
| biofilm | | | | |
| Biofilm | No enzyme | 0 | 88.1 | |
| Biofilm | SEQ ID NO 24 | 2 | 92.7 | 4.7 |
| Biofilm | SEQ ID NO 15 | 2 | 93.0 | 4.9 |
| Biofilm | SEQ ID NO 18 | 2 | 93.1 | 5.1 |
| Biofilm | SEQ ID NO 19 | 2 | 93.2 | 5.1 |
| Biofilm | SEQ ID NO 20 | 2 | 93.2 | 5.2 |
| Biofilm | SEQ ID NO 21 | 2 | 92.7 | 4.6 |
| Biofilm | SEQ ID NO 22 | 2 | 92.5 | 4.4 |
| Biofilm | SEQ ID NO 23 | 2 | 92.6 | 4.5 |

### Example 7: Construction of Clades and Phylogenetic Trees

The Glyco_hydro_20 domain includes the polypeptides having hexosaminidase e.g. PNAG activity and comprises clusters such as the clades. A phylogenetic tree was constructed, of polypeptide sequences containing a Glyco_hydro_20 domain, as defined in PFAM (PF00728, Pfam version 31.0 Finn (2016). Nucleic Acids Research, Database Issue 44:D279-D285). The phylogenetic tree was constructed from a multiple alignment of mature polypeptide sequences containing at least one Glyco_hydro_20 domain. The sequences were aligned using the MUSCLE algorithm version 3.8.31 (Edgar, 2004. Nucleic Acids Research 32(5): 1792-1797), and the trees were constructed using FastTree version 2.1.8 (Price et al., 2010, PloS one 5(3)) and visualized using iTOL (Letunic & Bork, 2007. Bioinformatics 23(1): 127-128). The polypeptide comprises of the Glyco_hydro_20 domain comprises several motifs one example is GXDE (SEQ ID NO 27) situated in positions corresponding to positions 166 to 169 in Haemophilus sputorum HK 2154 (SEQ ID NO 18). Residues D and E are the key catalytic residues of Glyco_hydro_20 enzymes (position 168 to 169 in SEQ ID NO 18). As already described the polypeptides having hexosaminidase e.g. PNAG activity may comprise the structural domains of Glyco_hydro_20. The polypeptides in Glyco_hydro_20 can be separated into multiple distinct sub-clusters, or clades, where we denoted the clades listed below. The distinct motifs for each clade are described in details below.

### Generation of LES Domain

A domain, such as shared by the polypeptides, was identified. This domain has not been described previously. The domain is termed LES and polypeptides of this domain comprises Glyco_hydro_20 domain polypeptides of bacterial origin and are in addition to having PNAG activity, characterized by comprising certain motifs. The polypeptides of the domain comprise the motif example [EQ][NRSHA][YVFL][AGSTC][IVLF][EAQYN][SN](SEQ ID NO: 28), corresponding to pos 46 to 52 of SEQ ID NO 18.

### Generation of HFH Clade

The HFH clade comprises LES domain polypeptides of bacterial origin, having hexosaminidase e.g. PNAG activity. The polypeptides of the clade comprise the motif example HFHIGG (SEQ ID NO: 29), corresponding to pos 162 to 167 of SEQ ID NO 18, where H (corresponding to position 162 of SEQ ID NO 18) is fully conserved in HFH clade. Another motif which may be comprised by the polypeptides of the HFH clade is FLHLHF (SEQ ID NO: 30), corresponding to amino acids 37 to 42 in SEQ ID NO 18, where H at position 41 is part of the active site. A further motif which may be comprised by the polypeptides of the HFH clade is DHENYA (SEQ ID NO: 31), 44 to 49 in SEQ ID NO 18, where E at position 46 is part of the active site.

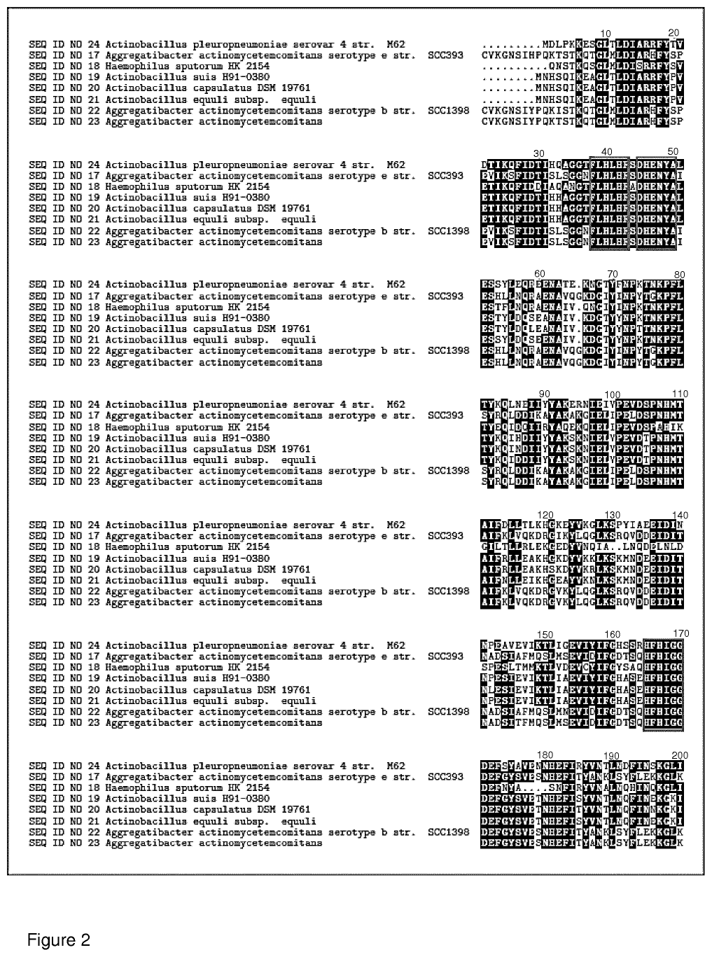

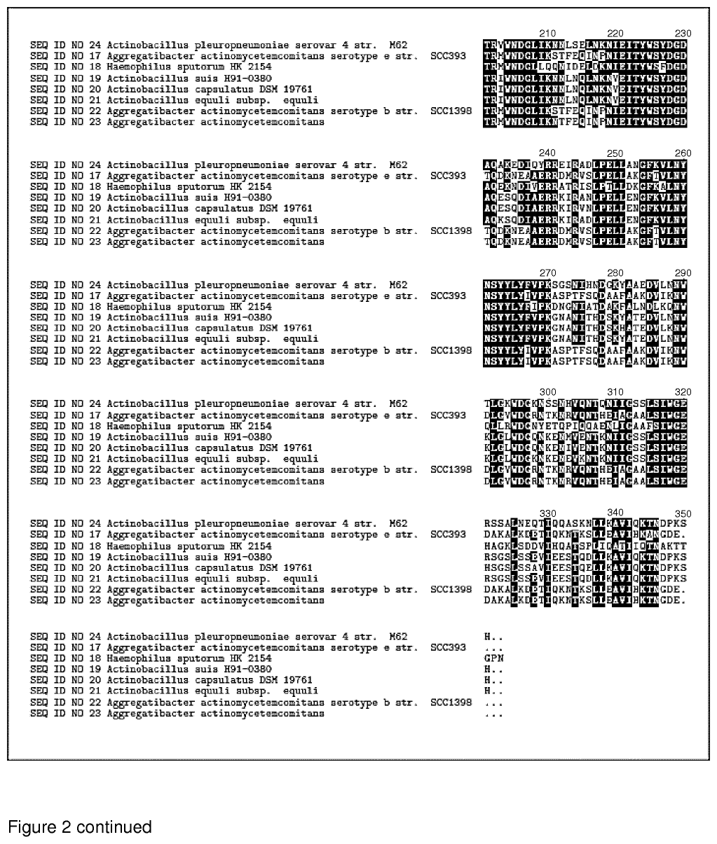

An alignment of the polypeptides comprised in the clade is shown in FIG. 2.

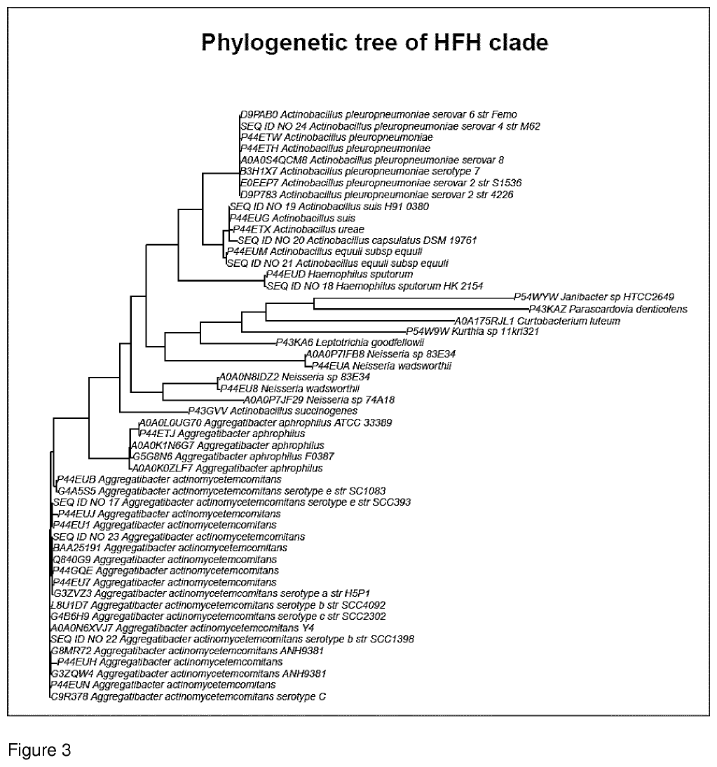

A phylogenetic tree of the HFH clade is shown in FIG. 3.

1. A cleaning composition comprising at least 0.0001 ppm polypeptide having hexosaminidase activity, wherein the polypeptide comprises one or more of the motif(s) GXDE (SEQ ID NO 27), [EQ][NRSHA][YVFL][AGSTC][IVLF][EAQYN][SN] (SEQ ID NO: 28), HFHIGG (SEQ ID NO: 29), FLHLHF (SEQ ID NO: 30) or DHENYA (SEQ ID NO: 31), or combinations thereof; wherein:
(a) the composition is a solid laundry detergent composition and further comprises:
(a1) at least one zeolite builder;
(a2) at least one phosphonate builder;
(a3) at least one further enzyme; and
(a4) at least one polymer; or
(b) the composition is a solid laundry detergent composition and further comprises:
(b1) at least one silicate builder;
(b2) optionally carboxymethylcellulos;
(b3) at least one further enzyme;
(b4) optionally at least one soil release polymer in an amount of 0.1 to 3 wt.-%; and
(b5) at least one bleaching system comprising a bleaching agent, a bleach activator, and a bleach catalyst; or
(c) wherein the composition is liquid laundry detergent composition and further comprises:
(c1) at least one surfactant;
(c2) optionally at least one phosphonate builder;
(c3) optionally at least at least one further enzyme; and
(c4) optionally at least one organic solvent; or
(d) wherein the composition is a liquid laundry detergent in unit dose form and further comprises:
(d1) water in an amount up to 20 wt.-%;
(d2) optionally at least one bittering agent;
(d3) optionally at least one optical brightener; and
(d4) optionally at least one polymer; or
(e) wherein the composition is a fabric finisher and further comprises:
(e1) at least one softening silicone;
(e2) at least one perfume;
(e3) optionally polyquaternium 10 in an mount of 0.01 to 20 wt;
(e3) optionally polyquaternium 10 in an amount of 0.1 to 20 wt.-%;
(e4) optionally polyquaternium 37 in an amount of 0.1 to 20 wt.-%;
(e5) optionally a plant-based esterquat; and
(e6) optionally adipic acid in an amount of 0.1 to 20 wt.; or
(f) wherein the composition is an acidic cleaning agent and further comprises:
(f1) a plant-based or bio-based surfactants;
(f2) at least one acidic biocide; and
(f3) at least one soil release, water repellant or water spreading polymer; or
(g) wherein the composition is a neutral cleaning agent and further comprises:
(g1) a plant-based or bio-based surfactants;
(g2) at least one biocide; and
(g3) at least one soil release, water repellant or water spreading polymer; or
(h) wherein the composition is an alkaline cleaning agent and further comprises:
(h1) a plant-based or bio-based surfactants; or
(i) wherein the composition is a hand dishwashing agent and further comprises:
(i1) at least one anionic surfactant;
(i2) at least one amphoteric surfactant;
(i3) at least one nonionic surfactant;
(i4) at least one further enzyme; or
(j) wherein the composition is an automatic dishwashing composition and further comprises
(j1) at least one builder selected from citrate, aminocarboxylates, and combinations thereof;
(j2) at least one phosphonate builder;
(j3) at least one nonionic surfactant;
(j4) at least one bleaching system comprising a bleaching agent, a bleach activator, and a bleach catalyst;
(j5) at least one polymer selected from sulfopolymers, cationic polymers, polyacrylates, and combinations thereof; or
(k) wherein the composition further comprises:
(k1) at least one sulfopolymer; or
(l) wherein the composition further comprises at least one adjunct ingredient selected from probiotics spores, or combinations thereof; or
(m) wherein the composition is in unit dose form; or
(n) wherein the composition is a phosphate-free composition.

2. The composition of claim 1, wherein the polypeptide has at least 60% sequence identity to the polypeptide shown in SEQ ID NO 17, SEQ ID NO 18, SEQ ID NO 19, SEQ ID NO 20, SEQ ID NO 21, SEQ ID NO 22, SEQ ID NO 23, or SEQ ID NO 24.

3. The composition of claim 1, comprising or consisting of SEQ ID NO: 17 or the mature polypeptide of SEQ ID NO: 2, comprising or consisting of SEQ ID NO: 18 or the mature polypeptide of SEQ ID NO: 4, comprising or consisting of SEQ ID NO: 19 or the mature polypeptide of SEQ ID NO: 6, comprising or consisting of SEQ ID NO: 20 or the mature polypeptide of SEQ ID NO: 8, comprising or consisting of SEQ ID NO: 21 or the mature polypeptide of SEQ ID NO: 10, comprising or consisting of SEQ ID NO: 22 or the mature polypeptide of SEQ ID NO: 12, SEQ ID NO: 23 or the mature polypeptide of SEQ ID NO: 14, or comprising or consisting of SEQ ID NO: 24 or the mature polypeptide of SEQ ID NO: 16.

4. The composition according to claim 1, wherein the composition is selected from compositions (a), (b), (d), (k), (l), (m) and (n) and further comprises up to 50 wt % of at least one surfactant, wherein the surfactant is anionic and/or nonionic.

5. (canceled)

6. (canceled)

7. A method for cleaning an item, wherein the method comprises:
exposing an item to the cleaning composition according to claim 1;
optionally completing at least one wash cycle; and
optionally rinsing the item, wherein the item is a textile or a hard surface.


SEQUENCE LISTING (31 sequences)

SEQ ID NO: 1 - DNA, 1143 bp, Aggregatibacter actinomycetemcomitans
  sig_peptide (1)..(66)
  CDS (1)..(1143)
  mat_peptide (67)..(1143)
atgaactacatcaagaagatcatcctttcacttttccttcttggccttttctcagttcttaactgctgcgttaagggcaactcaatccatccacaaaagacatcaacgaagcaaactggccttatgttagacattgctcgccacttctactcaccagaggttatcaagtcattcatcgacacaatctcactttcaggtggcaacttccttcatcttcacttctcagaccacgagaactacgctatcgagtcacatcttcttaaccaacgcgctgagaacgcggtacagggcaaggacggcatctacatcaacccatacactggcaagccattcctttcttaccgccaacttgacgacatcaaggcgtacgcgaaggcaaagggcatcgagcttatcccggagcttgactcaccaaaccatatgactgcaatcttcaagcttgttcagaaggatcgtggcatcaagtaccttcaaggccttaagtctcgccaagtagacgacgagatcgacatcactaacgcagacagcatcgcgttcatgcaatcacttatgtcagaggttatcgacatcttcggcgacacttctcaacatttccacattggtggcgacgagttcggctactcagttgagtcaaaccacgagttcatcacttacgcgaacaagctttcatacttccttgagaagaagggccttaagactcgcatgtggaacgacggccttatcaagtcaactttcgagcaaatcaacccaaacatcgagatcacatactggtcttacgacggcgacactcaagacaagaacgaagctgcggaacgtcgcgacatgcgcgtatcacttccggagcttcttgcgaagggcttcactgtacttaactacaactcatactacctttacatcgtacctaaggcgtcaccaacattctctcaagacgctgcgtttgctgcgaaggacgtaatcaagaactgggaccttggcgtatgggatggtcgcaacactaagaaccgcgtacaaaacacacacgagatcgctggcgctgcgctttcaatctggggtgaggacgcgaaggcacttaaggacgagactatccaaaagaacactaagtcacttcttgaggcggttatccataaggcaaacggcgacgag

SEQ ID NO: 2 - protein, 381 aa, Aggregatibacter actinomycetemcomitans
MNYIKKIILSLFLLGLFSVLNCCVKGNSIHPQKTSTKQTGLMLDIARHFYSPEVIKSFIDTISLSGGNFLHLHFSDHENYAIESHLLNQRAENAVQGKDGIYINPYTGKPFLSYRQLDDIKAYAKAKGIELIPELDSPNHMTAIFKLVQKDRGIKYLQGLKSRQVDDEIDITNADSIAFMQSLMSEVIDIFGDTSQHFHIGGDEFGYSVESNHEFITYANKLSYFLEKKGLKTRMWNDGLIKSTFEQINPNIEITYWSYDGDTQDKNEAAERRDMRVSLPELLAKGFTVLNYNSYYLYIVPKASPTFSQDAAFAAKDVIKNWDLGVWDGRNTKNRVQNTHEIAGAALSIWGEDAKALKDETIQKNTKSLLEAVIHKANGDE

SEQ ID NO: 3 - DNA, 1104 bp, Haemophilus sputorum
  sig_peptide (1)..(66)
  CDS (1)..(1104)
  mat_peptide (67)..(1104)
atgaagaagatcttccttttccttatcatgtcaatctctatgcttcttacacctatctcacttgctcagaactctactaagcaatctggccttatgttagacatctctcgtcgcttctactctgtagagacaatcaagcaattcatcgacgacatcgcacaagcaaacggcacattccttcaccttcacttcgcggaccacgagaactacgcgcttgagtctactttccttaaccaacgtgcggagaacgcaatcgtacaaaacggcatctacatcaaccctaagacaaacaagccgttccttacgtacgagcaaatcgaccaaatcatccgctacgcgcaagagaagcagatcgagcttatcccagaggttgactctcctgcgcacatcaagggcatccttacacttcttcgccttgagaagggcgaggactacgtaaaccaaatcgcgcttaaccaagacgagcttaaccttgactcaccggagtctcttactatgatgaagacacttgttgacgaggtttgctacatcttcggctactctgctcaacacttccacattggtggcgacgagttcaactatgcgtcaaacttcatccgctacgtaaacgcgcttaaccaacacatcaaccagaagggccttatcactcgcatgtggaacgacggccttcttcaacagaacatcgacgagttagacaagaacatcgagatcacatactggtctttcgacggcgacgcgcaagagaagaacgacatcgtagaacgtcgtgcgactcgcatctctcttccaacacttttagacaagggcttcaaggcgcttaactacaactcatactacctttacttcatcccaaaggacaacggcaacatcgcaacagacgcgaagttcgctcttaacgaccttaagcaaaactggcaacttcttcgctgggacggcaactacgagacacaacctatccaacaagctgagaaccttattggcgctgcattctcaatctggggtgagcacgctggcaagctttctgacgacgttatccaccaagcgacttctcctcttatccaggcaacaatcatccagacaaacgcgaagacaactggccctaac

SEQ ID NO: 4 - protein, 368 aa, Haemophilus sputorum
MKKIFLFLIMSISMLLTPISLAQNSTKQSGLMLDISRRFYSVETIKQFIDDIAQANGTFLHLHFADHENYALESTFLNQRAENAIVQNGIYINPKTNKPFLTYEQIDQIIRYAQEKQIELIPEVDSPAHIKGILTLLRLEKGEDYVNQIALNQDELNLDSPESLTMMKTLVDEVCYIFGYSAQHFHIGGDEFNYASNFIRYVNALNQHINQKGLITRMWNDGLLQQNIDELDKNIEITYWSFDGDAQEKNDIVERRATRISLPTLLDKGFKALNYNSYYLYFIPKDNGNIATDAKFALNDLKQNWQLLRWDGNYETQPIQQAENLIGAAFSIWGEHAGKLSDDVIHQATSPLIQATIIQTNAKTTGPN

SEQ ID NO: 5 - DNA, 1134 bp, Actinobacillus suis
  sig_peptide (1)..(78)
  CDS (1)..(1134)
  mat_peptide (79)..(1134)
atgaagaagatcatctctcttcttacgcttatcttcatcggccttctttcttcttgttcatcatctacagtaaacgcgatgaaccactctcaaatcaaggaagctggccttactttagacattgctcgtcgcttctacccagttgagacaatcaagcaattcatcgacactatccaccatgctggtggcacattccttcaccttcacttctcagaccacgagaactacgcgcttgagtctacgtaccttgaccaaagcgaggcgaacgcgatcgttaaggacggcacatactacaacccaaagacaaacaagcctttccttacttacaagcaaatccacgacatcatctactacgcgaagtctaagaacatcgagcttgtacctgaggtagacacaccgaaccacatgacagcgatcttccgccttcttgaggcgaagcacggcaaggactacgtaaagaagcttaagtcaaagatgaacgacgaggagatcgacatcactaacccggagtctatcgaggttatcaagactcttatcgctgaggttatctacatcttcggccacgcgagcgagcacttccacattggtggcgacgagttcggctactcagttgagacgaaccacgagttcatctcatacgttaacacgcttaaccagttcatcaacgagaagggcaagatcacgcgcatctggaacgacggccttatcaagaacaaccttaaccaacttaacaagaacgttgagatcacgtactggtcttacgacggcgacgcgcaagagtcacaagacatcgcggaacgtcgcaagattcgtgcgaaccttcctgagcttcttgagaacggcttcaaggttcttaactacaactcttactacctttacttcgtacctaagggcaacgcgaacatcacgcacgactctaagtacgcgactgaggacgttcttaacaactggaagcttggcctttgggacggccaaaacaaggagaacatggttgagaacacgaagaacatcatcggctcatctctttctatctggggtgagcgctctggctcactttcaagcgaggttatcgaggagtctacgcaagaccttcttaaggcggttatccaaaagacaaacgacccaaagtctcac

SEQ ID NO: 6 - protein, 378 aa, Actinobacillus suis
MKKIISLLTLIFIGLLSSCSSSTVNAMNHSQIKEAGLTLDIARRFYPVETIKQFIDTIHHAGGTFLHLHFSDHENYALESTYLDQSEANAIVKDGTYYNPKTNKPFLTYKQIHDIIYYAKSKNIELVPEVDTPNHMTAIFRLLEAKHGKDYVKKLKSKMNDEEIDITNPESIEVIKTLIAEVIYIFGHASEHFHIGGDEFGYSVETNHEFISYVNTLNQFINEKGKITRIWNDGLIKNNLNQLNKNVEITYWSYDGDAQESQDIAERRKIRANLPELLENGFKVLNYNSYYLYFVPKGNANITHDSKYATEDVLNNWKLGLWDGQNKENMVENTKNIIGSSLSIWGERSGSLSSEVIEESTQDLLKAVIQKTNDPKSH

SEQ ID NO: 7 - DNA, 1134 bp, Actinobacillus capsulatus DSM 19761
  sig_peptide (1)..(78)
  CDS (1)..(1134)
  mat_peptide (79)..(1134)
atgaagaagatcatctctcttcttacgcttatcttcatcggccttctttcttcttgctcatcatctacagtaaacgcgatgaaccactctcaaatcaaggaagctggccttactttagacattgctcgtcgcttctacccagttgagacaatcaagcaattcatcgacactatccaccatgctggtggcacattccttcaccttcacttctcagaccacgagaactacgcgcttgagtctacgtaccttgaccaacttgaggcgaacgcgatcgttaaggacggcacatactacaacccaacgacaaacaagcctttccttacttacaagcaaatcaacgacatcatctactacgcgaagtctaagaacatcgagcttgtacctgaggtagacacaccgaaccacatgacagcgatcttccgccttcttgaggcgaagcacagcaaggactacgtaaagcgccttaagtcaaagatgaacgacgaggagatcgacatcactaaccttgagtctatcgaggttatcaagactcttatcgctgaggttatctacatcttcggccacgcgagcgagcacttccacattggtggcgacgagttcggctactcagttgagacgaaccacgagttcatcacttacgttaacacgcttaaccagttcatcaacaacaagggcaagatcacgcgcatctggaacgacggccttatcaagaacaaccttaaccaacttaacaagaacgttgagatcacgtactggtcttacgacggcgacgcgcaagagtcacaagacatcgcggaacgtcgcaagatccgcgtaaaccttcctgagcttcttgagaacggcttcaaggttcttaactacaactcttactacctttacttcgtacctaagggcaacgcgaacatcacgcacgactctaagcacgcgactgaggacgttcttaagaactggaagcttggcctttgggacggccaaaacaaggagaacatcgttgagaacacgaagaacatcatcggctcatctctttctatctggggtgagcactctggctcactttcatctgcggttatcgaggagtctacgcaagagcttcttaaggcggttatccaaaagacaaacgacccaaagtctcac

SEQ ID NO: 8 - protein, 378 aa, Actinobacillus capsulatus DSM 19761
MKKIISLLTLIFIGLLSSCSSSTVNAMNHSQIKEAGLTLDIARRFYPVETIKQFIDTIHHAGGTFLHLHFSDHENYALESTYLDQLEANAIVKDGTYYNPTTNKPFLTYKQINDIIYYAKSKNIELVPEVDTPNHMTAIFRLLEAKHSKDYVKRLKSKMNDEEIDITNLESIEVIKTLIAEVIYIFGHASEHFHIGGDEFGYSVETNHEFITYVNTLNQFINNKGKITRIWNDGLIKNNLNQLNKNVEITYWSYDGDAQESQDIAERRKIRVNLPELLENGFKVLNYNSYYLYFVPKGNANITHDSKHATEDVLKNWKLGLWDGQNKENIVENTKNIIGSSLSIWGEHSGSLSSAVIEESTQELLKAVIQKTNDPKSH

SEQ ID NO: 9 - DNA, 1134 bp, Actinobacillus equuli subsp. equuli
  sig_peptide (1)..(78)
  CDS (1)..(1134)
  mat_peptide (79)..(1134)
atgaagaagatcgtatctcttttcacgcttatcgttatcggccttctttcttcttgctcatcacaaacagtaaacgcgatgaaccactctcaaatcaaggaagctggccttactttagacattgctcgtcgcttctacccagttgagacaatcaagcaattcatcgacactatccaccatgctggtggcacattccttcaccttcacttctcagaccacgagaactacgcgcttgagtcttcttaccttgaccaaagcgaggagaacgcgatcgttaaggacggcacatactacaacccaaagacaaacaagcctttccttacttacaagcaaatcgacgacatcatctactacgcgaagtctaagaacatcgagcttgtacctgaggtagacacaccgaaccacatgacagcgatcttcaaccttcttgagatcaagcacggcgaggcgtacgtaaagaaccttaagtcaaagatgaacgacgaggagatcgacatcactaacccggagtctatcgaggttatcaagactcttatcgctgaggttatctacatcttcggccacgcgagcgagcacttccacattggtggcgacgagttcggctactcagttgagacgaaccacgagttcatctcatacgttaacacgcttaaccagttcatcaacgagaagggcaagatcacgcgcatctggaacgacggccttatcaagaacaaccttaaccaacttaacaagaacgttgagatcacgtactggtcttacgacggcgacgcgcaaaagtcacaagacatcgcggaacgtcgcaagattcgtgcggaccttcctgagcttcttgagaacggcttcaaggttcttaactacaactcttactacctttacttcgtacctaagggcaacgcgaacatcacgcacgactctaagtacgcgactgaggacgttcttaacaactggaagcttggcctttgggacggcaagaacaaggagaacgaggttaagaacacgaagaacatcatcggctcatctctttctatctggggtgagcgctctggctcactttcaagcgaggttatcgaggagtctacgcaagaccttcttaaggcggttatccaaaagacaaacgacccaaagtctcac

SEQ ID NO: 10 - protein, 378 aa, Actinobacillus equuli subsp. equuli
MKKIVSLFTLIVIGLLSSCSSQTVNAMNHSQIKEAGLTLDIARRFYPVETIKQFIDTIHHAGGTFLHLHFSDHENYALESSYLDQSEENAIVKDGTYYNPKTNKPFLTYKQIDDIIYYAKSKNIELVPEVDTPNHMTAIFNLLEIKHGEAYVKNLKSKMNDEEIDITNPESIEVIKTLIAEVIYIFGHASEHFHIGGDEFGYSVETNHEFISYVNTLNQFINEKGKITRIWNDGLIKNNLNQLNKNVEITYWSYDGDAQKSQDIAERRKIRADLPELLENGFKVLNYNSYYLYFVPKGNANITHDSKYATEDVLNNWKLGLWDGKNKENEVKNTKNIIGSSLSIWGERSGSLSSEVIEESTQDLLKAVIQKTNDPKSH

SEQ ID NO: 11 - DNA, 1143 bp, Aggregatibacter actinomycetemcomitans
  sig_peptide (1)..(66)
  CDS (1)..(1143)
  mat_peptide (67)..(1143)
atgaactacatcaagaagatcatcctttctcttttccttcttggccttttctcagttcttaactgctgcgttaagggcaactctatctaccctcaaaagatctctacaaagcagacaggccttatgttagacattgctcgccatttctactcacctgaggttatcaagtctttcatcgacactatctctctttcaggtggcaacttccttcatcttcacttctcagaccatgagaactacgcgatcgagagccatcttcttaaccaacgtgcggagaacgcggttcaaggcaaggacggcatctacatcaacccttacacaggcaagccattcctttcataccgccaacttgacgacatcaaggcgtacgcgaaggcgaagggcatcgagcttatcccggagcttgactctcctaaccacatgactgcgatcttcaagcttgttcaaaaggatcgtggcgttaagtaccttcagggccttaagtctcgccaagttgacgacgagatcgacatcacaaacgcggactcaatcgctttcatgcagtcacttatgaacgaggttatcgacatcttcggcgacacgtcacagcatttccacattggtggcgacgagttcggctactcagttgagtctaaccacgagttcatcacttacgcgaacaagctttcatacttccttgagaagaagggccttaagacacgcatgtggaacgacggccttatcaagtctactttcgagcaaatcaaccctaacatcgagatcacttactggtcatacgacggcgacacgcaagacaagaacgaagctgcggaacgtcgcgacatgcgcgtttctcttccagagcttcttgcgaagggcttcacagttcttaactacaactcttactacctttacatcgttcctaaggcgtctcctacgttctcacaagatgctgcgttcgctgctaaggacgttatcaagaactgggaccttggcgtttgggatggtcgcaacacaaagaaccgcgtacaaaacacacatgagattgctggtgctgcgctttcaatctggggtgaggacgctaaggcgcttaaggacgagactatccaaaagaacactaagtcacttcttgaggcggtaatccacaagacaaacggcgacgag

SEQ ID NO: 12 - protein, 381 aa, Aggregatibacter actinomycetemcomitans
MNYIKKIILSLFLLGLFSVLNCCVKGNSIYPQKISTKQTGLMLDIARHFYSPEVIKSFIDTISLSGGNFLHLHFSDHENYAIESHLLNQRAENAVQGKDGIYINPYTGKPFLSYRQLDDIKAYAKAKGIELIPELDSPNHMTAIFKLVQKDRGVKYLQGLKSRQVDDEIDITNADSIAFMQSLMNEVIDIFGDTSQHFHIGGDEFGYSVESNHEFITYANKLSYFLEKKGLKTRMWNDGLIKSTFEQINPNIEITYWSYDGDTQDKNEAAERRDMRVSLPELLAKGFTVLNYNSYYLYIVPKASPTFSQDAAFAAKDVIKNWDLGVWDGRNTKNRVQNTHEIAGAALSIWGEDAKALKDETIQKNTKSLLEAVIHKTNGDE

SEQ ID NO: 13 - DNA, 1143 bp, Aggregatibacter actinomycetemcomitans
  sig_peptide (1)..(66)
  CDS (1)..(1143)
  mat_peptide (67)..(1143)
atgaactacatcaagaagatcatcctttcacttttccttcttggccttttctctgttcttaactgctgcgttaagggcaactctatctacccacaaaagacatcaacgaagcaaactggccttatgttagacattgctcgccacttctactctccagaggttatcaagtctttcatcgacacaatctcactttcaggtggcaacttccttcatcttcacttctcagaccacgagaactacgctatcgagtcacatcttcttaaccaacgcgctgagaacgcggtacagggcaaggacggcatctacatcaacccatacactggcaagccattcctttcttaccgccaacttgacgacatcaaggcgtacgcgaaggcaaagggcatcgagcttatcccggagcttgactcaccaaaccatatgactgcaatcttcaagcttgttcagaaggatcgtggcgttaagtaccttcaaggccttaagtcacgccaagtagacgacgagatcgacatcactaacgcagacagcatcactttcatgcaatcacttatgtctgaggttatcgacatcttcggcgacacttctcaacatttccacattggtggcgacgagttcggctactctgttgagtcaaaccacgagttcatcacttacgcgaacaagctttcatacttccttgagaagaagggccttaagactcgcatgtggaacgacggccttatcaagaacactttcgagcaaatcaacccaaacatcgagatcacatactggagctacgacggcgacactcaagacaagaacgaagctgcggaacgtcgcgacatgcgcgtatctcttccggagcttcttgcgaagggcttcactgtacttaactacaactcatactacctttacatcgtacctaaggcgtcaccaacattctctcaagacgctgcgtttgctgcgaaggacgtaatcaagaactgggaccttggcgtatgggatggtcgcaacactaagaaccgcgtacaaaacacacacgagatcgctggcgctgcgctttcaatctggggtgaggacgcgaaggcacttaaggacgagactatccaaaagaacactaagtctcttcttgaggcggttatccataagacgaacggcgacgag

SEQ ID NO: 14 - protein, 381 aa, Aggregatibacter actinomycetemcomitans
MNYIKKIILSLFLLGLFSVLNCCVKGNSIYPQKTSTKQTGLMLDIARHFYSPEVIKSFIDTISLSGGNFLHLHFSDHENYAIESHLLNQRAENAVQGKDGIYINPYTGKPFLSYRQLDDIKAYAKAKGIELIPELDSPNHMTAIFKLVQKDRGVKYLQGLKSRQVDDEIDITNADSITFMQSLMSEVIDIFGDTSQHFHIGGDEFGYSVESNHEFITYANKLSYFLEKKGLKTRMWNDGLIKNTFEQINPNIEITYWSYDGDTQDKNEAAERRDMRVSLPELLAKGFTVLNYNSYYLYIVPKASPTFSQDAAFAAKDVIKNWDLGVWDGRNTKNRVQNTHEIAGAALSIWGEDAKALKDETIQKNTKSLLEAVIHKTNGDE

SEQ ID NO: 15 - DNA, 1131 bp, Actinobacillus pleuropneumoniae
  sig_peptide (1)..(78)
  CDS (1)..(1131)
  mat_peptide (79)..(1131)
atgaagaaggcgatcactcttttcacacttctttgtgcggtacttctttctttcggcactgctacttacgctaacgcgatggaccttccaaagaaggagtctggccttactttagacattgctcgtcgcttctacactgtagacactatcaagcaattcatcgacactatccatcaagctggtggcactttccttcaccttcatttctctgaccacgagaactacgcgcttgagtcttcataccttgagcaacgcgaggagaacgctactgagaagaacggcacatacttcaacccaaagactaacaagcctttccttacttacaagcaacttaacgagatcatctactacgcgaaggagcgcaacatcgagatcgttcctgaggtagactcaccaaaccacatgactgcgatcttcgaccttcttactcttaagcatggcaaggagtacgtaaagggccttaagtctccttacatcgcggaggagatcgacatcaacaacccagaggcggtagaggttatcaagacacttatcggcgaggttatctacatcttcggccattcatcacgccatttccatattggtggcgacgagttctcttacgcggtagagaacaaccatgagttcatccgctacgtaaacacacttaacgacttcatcaactctaagggccttatcactcgcgtttggaacgacggccttatcaagaacaacctttcagagcttaacaagaacatcgagatcacttactggtcttacgacggcgacgcgcaagcgaaggaggacatccagtatcgtcgcgagattcgtgcggaccttccagagcttcttgcgaacggcttcaaggttcttaactacaactcttactacctttacttcgtacctaagtctggctctaacatccataacgacggcaagtacgctgcggaggacgtacttaacaactggacgcttggcaagtgggacggcaagaactcaagcaaccatgttcaaaacacacaaaacatcatcggctcatcactttctatctggggtgagcgctcttctgcgcttaacgagcaaacaatccaacaggcgagcaagaaccttcttaaggcggtaatccaaaagactaacgaccctaagtcacac

SEQ ID NO: 16 - protein, 377 aa, Actinobacillus pleuropneumoniae
MKKAITLFTLLCAVLLSFGTATYANAMDLPKKESGLTLDIARRFYTVDTIKQFIDTIHQAGGTFLHLHFSDHENYALESSYLEQREENATEKNGTYFNPKTNKPFLTYKQLNEIIYYAKERNIEIVPEVDSPNHMTAIFDLLTLKHGKEYVKGLKSPYIAEEIDINNPEAVEVIKTLIGEVIYIFGHSSRHFHIGGDEFSYAVENNHEFIRYVNTLNDFINSKGLITRVWNDGLIKNNLSELNKNIEITYWSYDGDAQAKEDIQYRREIRADLPELLANGFKVLNYNSYYLYFVPKSGSNIHNDGKYAAEDVLNNWTLGKWDGKNSSNHVQNTQNIIGSSLSIWGERSSALNEQTIQQASKNLLKAVIQKTNDPKSH

SEQ ID NO: 17 - protein, 359 aa, Aggregatibacter actinomycetemcomitans
CVKGNSIHPQKTSTKQTGLMLDIARHFYSPEVIKSFIDTISLSGGNFLHLHFSDHENYAIESHLLNQRAENAVQGKDGIYINPYTGKPFLSYRQLDDIKAYAKAKGIELIPELDSPNHMTAIFKLVQKDRGIKYLQGLKSRQVDDEIDITNADSIAFMQSLMSEVIDIFGDTSQHFHIGGDEFGYSVESNHEFITYANKLSYFLEKKGLKTRMWNDGLIKSTFEQINPNIEITYWSYDGDTQDKNEAAERRDMRVSLPELLAKGFTVLNYNSYYLYIVPKASPTFSQDAAFAAKDVIKNWDLGVWDGRNTKNRVQNTHEIAGAALSIWGEDAKALKDETIQKNTKSLLEAVIHKANGDE

SEQ ID NO: 18 - protein, 346 aa, Haemophilus sputorum
QNSTKQSGLMLDISRRFYSVETIKQFIDDIAQANGTFLHLHFADHENYALESTFLNQRAENAIVQNGIYINPKTNKPFLTYEQIDQIIRYAQEKQIELIPEVDSPAHIKGILTLLRLEKGEDYVNQIALNQDELNLDSPESLTMMKTLVDEVCYIFGYSAQHFHIGGDEFNYASNFIRYVNALNQHINQKGLITRMWNDGLLQQNIDELDKNIEITYWSFDGDAQEKNDIVERRATRISLPTLLDKGFKALNYNSYYLYFIPKDNGNIATDAKFALNDLKQNWQLLRWDGNYETQPIQQAENLIGAAFSIWGEHAGKLSDDVIHQATSPLIQATIIQTNAKTTGPN

SEQ ID NO: 19 - protein, 352 aa, Actinobacillus suis
MNHSQIKEAGLTLDIARRFYPVETIKQFIDTIHHAGGTFLHLHFSDHENYALESTYLDQSEANAIVKDGTYYNPKTNKPFLTYKQIHDIIYYAKSKNIELVPEVDTPNHMTAIFRLLEAKHGKDYVKKLKSKMNDEEIDITNPESIEVIKTLIAEVIYIFGHASEHFHIGGDEFGYSVETNHEFISYVNTLNQFINEKGKITRIWNDGLIKNNLNQLNKNVEITYWSYDGDAQESQDIAERRKIRANLPELLENGFKVLNYNSYYLYFVPKGNANITHDSKYATEDVLNNWKLGLWDGQNKENMVENTKNIIGSSLSIWGERSGSLSSEVIEESTQDLLKAVIQKTNDPKSH

SEQ ID NO: 20 - protein, 352 aa, Actinobacillus capsulatus DSM 19761
MNHSQIKEAGLTLDIARRFYPVETIKQFIDTIHHAGGTFLHLHFSDHENYALESTYLDQLEANAIVKDGTYYNPTTNKPFLTYKQINDIIYYAKSKNIELVPEVDTPNHMTAIFRLLEAKHSKDYVKRLKSKMNDEEIDITNLESIEVIKTLIAEVIYIFGHASEHFHIGGDEFGYSVETNHEFITYVNTLNQFINNKGKITRIWNDGLIKNNLNQLNKNVEITYWSYDGDAQESQDIAERRKIRVNLPELLENGFKVLNYNSYYLYFVPKGNANITHDSKHATEDVLKNWKLGLWDGQNKENIVENTKNIIGSSLSIWGEHSGSLSSAVIEESTQELLKAVIQKTNDPKSH

SEQ ID NO: 21 - protein, 352 aa, Actinobacillus equuli subsp. equuli
MNHSQIKEAGLTLDIARRFYPVETIKQFIDTIHHAGGTFLHLHFSDHENYALESSYLDQSEENAIVKDGTYYNPKTNKPFLTYKQIDDIIYYAKSKNIELVPEVDTPNHMTAIFNLLEIKHGEAYVKNLKSKMNDEEIDITNPESIEVIKTLIAEVIYIFGHASEHFHIGGDEFGYSVETNHEFISYVNTLNQFINEKGKITRIWNDGLIKNNLNQLNKNVEITYWSYDGDAQKSQDIAERRKIRADLPELLENGFKVLNYNSYYLYFVPKGNANITHDSKYATEDVLNNWKLGLWDGKNKENEVKNTKNIIGSSLSIWGERSGSLSSEVIEESTQDLLKAVIQKTNDPKSH

SEQ ID NO: 22 - protein, 359 aa, Aggregatibacter actinomycetemcomitans
CVKGNSIYPQKISTKQTGLMLDIARHFYSPEVIKSFIDTISLSGGNFLHLHFSDHENYAIESHLLNQRAENAVQGKDGIYINPYTGKPFLSYRQLDDIKAYAKAKGIELIPELDSPNHMTAIFKLVQKDRGVKYLQGLKSRQVDDEIDITNADSIAFMQSLMNEVIDIFGDTSQHFHIGGDEFGYSVESNHEFITYANKLSYFLEKKGLKTRMWNDGLIKSTFEQINPNIEITYWSYDGDTQDKNEAAERRDMRVSLPELLAKGFTVLNYNSYYLYIVPKASPTFSQDAAFAAKDVIKNWDLGVWDGRNTKNRVQNTHEIAGAALSIWGEDAKALKDETIQKNTKSLLEAVIHKTNGDE

SEQ ID NO: 23 - protein, 359 aa, Aggregatibacter actinomycetemcomitans
CVKGNSIYPQKTSTKQTGLMLDIARHFYSPEVIKSFIDTISLSGGNFLHLHFSDHENYAIESHLLNQRAENAVQGKDGIYINPYTGKPFLSYRQLDDIKAYAKAKGIELIPELDSPNHMTAIFKLVQKDRGVKYLQGLKSRQVDDEIDITNADSITFMQSLMSEVIDIFGDTSQHFHIGGDEFGYSVESNHEFITYANKLSYFLEKKGLKTRMWNDGLIKNTFEQINPNIEITYWSYDGDTQDKNEAAERRDMRVSLPELLAKGFTVLNYNSYYLYIVPKASPTFSQDAAFAAKDVIKNWDLGVWDGRNTKNRVQNTHEIAGAALSIWGEDAKALKDETIQKNTKSLLEAVIHKTNGDE

SEQ ID NO: 24 - protein, 351 aa, Actinobacillus pleuropneumoniae
MDLPKKESGLTLDIARRFYTVDTIKQFIDTIHQAGGTFLHLHFSDHENYALESSYLEQREENATEKNGTYFNPKTNKPFLTYKQLNEIIYYAKERNIEIVPEVDSPNHMTAIFDLLTLKHGKEYVKGLKSPYIAEEIDINNPEAVEVIKTLIGEVIYIFGHSSRHFHIGGDEFSYAVENNHEFIRYVNTLNDFINSKGLITRVWNDGLIKNNLSELNKNIEITYWSYDGDAQAKEDIQYRREIRADLPELLANGFKVLNYNSYYLYFVPKSGSNIHNDGKYAAEDVLNNWTLGKWDGKNSSNHVQNTQNIIGSSLSIWGERSSALNEQTIQQASKNLLKAVIQKTNDPKSH

SEQ ID NO: 25 - protein, 27 aa, Artificial
  bacillus clausii signal peptide
MKKPLGKIVASTALLISVAFSSSIASA

SEQ ID NO: 26 - protein, 8 aa, Artificial
  His-tag
HHHHHHPR

SEQ ID NO: 27 - protein, 4 aa, Artificial
  motif
  MISC_FEATURE (2)..(2): Xaa = any amino acids
GXDE

SEQ ID NO: 28 - protein, 7 aa, Artificial
  motif
  MISC_FEATURE (1)..(1): Xaa = E(Glu) or Q(Gln)
  MISC_FEATURE (2)..(2): Xaa = N (Asn) or R (Arg) or S (Ser) or H (His) or A (Ala)
  MISC_FEATURE (3)..(3): Xaa = Y(Tyr) or V (Val) or F (Phe) or L(Leu)
  MISC_FEATURE (4)..(4): Xaa = A (Ala) or G (Gly) or S (Ser) or T (Thr) or C (Cys)
  MISC_FEATURE (5)..(5): Xaa = I (Ile) or V (Val) or L (Leu) or F (Phe)
  MISC_FEATURE (6)..(6): Xaa = E(Glu) or A (Ala) or Q (Gln) or Y (Tyr) or N (Asn)
  MISC_FEATURE (7)..(7): Xaa = S(Ser) or N (Asn)
XXXXXXX

SEQ ID NO: 29 - protein, 6 aa, Artificial
  motif
HFHIGG

SEQ ID NO: 30 - protein, 6 aa, Artificial
  motif
FLHLHF

SEQ ID NO: 31 - protein, 6 aa, Artificial
  motif
DHENYA